(19) United States
(12) Patent Application Publication
(10) Pub. No.: US 2007/0200803 A1
(43) Pub. Date: Aug. 30, 2007

(54) Display device, and driving method and electronic device thereof

(75) Inventor: Hajime Kimura, Atsugi (JP)

Correspondence Address: COOK, ALEX, McFARRON, MANZO, CUMMINGS;& MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/493,180

(22) Filed: Jul. 26, 2006

(30) Foreign Application Priority Data
Jul. 27, 2005 (JP) 2005-217957

(51) Int. Cl. G09G 3/30

(52) U.S. Cl. 345/76

(57) ABSTRACT

By controlling gray scale of a display device in accordance with an average luminance of a display screen, sharp display is performed. In addition, it is an object to provide a display device with reduced deterioration of a light emitting element, by the control in accordance with the average luminance of a display screen so as to perform display appropriately. A display which includes a plurality of pixels each including a light emitting element, a switching TFT and a driving TFT, an average gray scale calculation circuit which calculates an average luminance of all pixels in a frame period, a sub-frame-number control circuit which controls the number of sub-frames in accordance with the calculated average luminance level, and a potential control circuit which controls a potential applied to both ends of a light emitting element in accordance with the calculated average luminance level are included.

### BACKGROUND OF THE INVENTION

1. Field of the Invention

The present invention relates to a display device on which an EL (electroluminescent) element, an organic EL element, or another self-emission type display element is mounted. In addition, the present invention relates to a driving method of the display device. Further, the present invention relates to an electronic device provided with the display device in a display portion.

2. Description of the Related Art

In recent years, a so-called self-emission type display device in which a pixel is formed by using a light emitting element such as a light emitting diode (LED), has been the focus of recent interest. As a light emitting element used in such a self-emission type display device, an organic light emitting diode (also referred to as an OLED (Organic Light Emitting Diode), an organic EL element, an electroluminescence (EL) element, or the like) attracts attention and is increasingly used in an EL display or the like. Since the light emitting element such as an OLED is self-emission type, it has advantages that visibility of a pixel is higher than a liquid crystal display, back light is not necessary, a response speed is high, and the like.

A self-emission type display device includes a pixel portion and a peripheral driver circuit which inputs a signal to the pixel portion. In the pixel portion, light emitting elements are arranged in respective pixels, and an image is displayed by controlling light emission of the light emitting elements.

In each pixel of the pixel portion, a thin film transistor (hereinafter, referred to as a TFT) is provided. Here, a pixel configuration in which two TFTs are provided in each pixel for controlling light emission of a light emitting element in each pixel is described (Reference 1: Japanese Patent Laid-Open No. 2001-343933).

In FIG. 39, a pixel configuration of a pixel portion is shown. In a pixel portion 10, data lines (also referred to as source signal lines) S1 to Sx, scanning lines (also referred to as gate signal lines) G1 to Gy, and power supply lines (also referred to as supply feeding lines) V1 to Vx are arranged, and pixels of x (x is a natural number) columns and y (y is a natural number) rows are provided. In each pixel, a switching TFT (also referred to as a selection transistor, a switch transistor, or a SWTFT) 11, a driving TFT (also referred to as a drive transistor) 12, a capacitor 13, and a light emitting element 14 are included.

A driving method of the pixel portion 10 is briefly described. In an address period, the switching TFT 11 turns on when a scanning line is selected, and a potential of a data line at that time is written to a gate electrode (also referred to as a gate terminal) of the driving TFT 12 through the switching TFT 11. From completion of one selection period to the next selection period, the capacitor 13 holds the potential of the gate electrode of the driving TFT 12.

Here, in the configuration of FIG. 39, when a relation between the absolute value of a gate-source voltage of a driving TFT (|V_{GS}|) and the absolute value of a threshold voltage of the driving TFT 12 (|Vₜₕ|) satisfies |V_{GS}|>|Vₜₕ|, the driving TFT 12 turns on, a current flows by a voltage between a power supply line and an opposite electrode of the light emitting element 14, and the light emitting element 14 is made into a light-emitting state. In addition, when the relation satisfies |V_{GS}|<|Vₜₕ|, the driving TFT 12 turns off, a voltage is not supplied to both ends of the light emitting element 14, and the light emitting element 14 is made into a non-light emitting state (non-lighting state).

In a pixel having the configuration of FIG. 39, in order to express gray scale, roughly either an analog gray scale method or a digital gray scale method is employed.

In the analog gray scale method, there are a method of analog-controlling an emission intensity of a display element and a method of analog-controlling a light emission time of a display element. The method of analog-controlling an emission intensity of a display element is often used as an analog gray scale method. On the other hand, in the digital gray scale method, whether a light emitting element emits light or not is controlled only by controlling on and off of a switching element by using a signal input in a pixel; accordingly, gray scale is expressed.

Compared with the analog gray scale method, the digital gray scale method has advantages in strength against the variation of a TFT, easiness of precisely expressing gray scale, and the like. However, in the digital gray scale method, since there are only two states of light emission and non-light emission, achieving multiple gray scale levels is required by combining with another method.

As an expressing method of multiple gray scales in a digital gray scale method, there is a time gray scale method, an area gray scale method, or the like. The area gray scale method is a method of displaying gray scale by controlling a light emitting area of each pixel. On the other hand, the time gray scale method is a method of expressing gray scale by controlling a light emission period of each pixel in a display device. In the case of the digital gray scale method, the time gray scale method which is suitable for high definition is often used. As disclosed in Reference 1, in a digital time gray scale method, multiple gray scale display with further high definition can be realized by using an erasing transistor (also referred to as an erasing TFT) in addition to a driving TFT and a switching TFT in each pixel.

### SUMMARY OF THE INVENTION

However, a luminance or a maximum luminance of a certain gray scale is not changed by an average luminance of an entire screen in such a digital time gray scale method. Therefore, sharp display with high contrast cannot be performed.

In consideration of the above-described problem, the present invention has an object to provide a display device by which sharp display with high contrast can be performed in a light emitting device. In addition, the present invention relates to an electronic device provided with the display device in a display portion.

According to the present invention, a duty ratio is changed depending on an average luminance of an entire screen. Accordingly, a TFT for erasing a signal input to a gate of a TFT which controls driving of a light emitting element (hereinafter referred to as an erasing TFT) is provided, and the timing of an erasing operation of the erasing TFT is controlled. Alternatively, a cathode voltage or anode voltage is changed depending on an average luminance of an entire screen. Alternatively, the number of sub-frames, which are obtained by dividing a frame period, is changed. Further alternatively, a time gray scale method is changed. Note that the erasing TFT will be described in detail in Embodiment Mode 2. In this specification, a duty ratio means a proportion of a displaying period for displaying gray scale in a frame period. A sub-frame means each of a plurality of periods which are obtained by dividing a frame period. The number of sub-frames means the number of a plurality of periods which are obtained by dividing a frame period.

One feature of a structure of the display device of the present invention is to include an analog-digital converter circuit which converts an analog signal into a digital signal, an average gray scale calculation circuit which is connected to the analog-digital converter circuit and calculates an average gray scale level of a frame period, a sub-frame-number control circuit which controls the number of sub-frames in accordance with the average gray scale level, and a potential control circuit which changes a voltage applied between a pair of electrodes of a light emitting element in accordance with the average gray scale level.

Another feature of the structure of the display device of the present invention is to include a display portion which includes a plurality of pixels each including a light emitting element, a driving TFT which controls supply of a current to the light emitting element, and a switching TFT; a signal line driver circuit which outputs a video signal to a pixel; a scanning line driver circuit which selects a pixel to which the video signal is written; a power supply line which supplies a current or a voltage to the light emitting element; an average gray scale calculation circuit which calculates an average gray scale level of a frame period; a sub-frame-number control circuit which controls the number of sub-frames in the frame period in accordance with the average gray scale level; and a potential control circuit which changes a voltage applied between a pair of electrodes of the light emitting element in accordance with the average gray scale level.

Still another feature of the structure of the display device of the present invention is to include an analog-digital converter circuit which converts an analog signal into a digital signal, an average gray scale calculation circuit which is connected to the analog-digital converter circuit and calculates an average gray scale level of a frame period, a gray scale method selector circuit which selects an overlapped time gray scale method or a binary code digital time gray scale method in accordance with the average gray scale level, and a potential control circuit which changes a voltage applied between a pair of electrodes of a light emitting element in accordance with the average gray scale level.

Yet still another feature of the structure of the display device of the present invention is to include a display portion which includes a plurality of pixels each including a light emitting element, a driving TFT which controls supply of a current to the light emitting element, and a switching TFT; a signal line driver circuit which outputs a video signal to a pixel; a scanning line driver circuit which selects a pixel to which the video signal is written; a power supply line which supplies a current or a voltage to the light emitting element; an average gray scale calculation circuit which calculates an average gray scale level of a frame period; a gray scale method selector circuit which selects an overlapped time gray scale method or a binary code digital time gray scale method in accordance with the average gray scale level; and a potential control circuit which changes a voltage applied between a pair of electrodes of the light emitting element in accordance with the average gray scale level.

One feature of the structure of the display device of the present invention is that the number of sub-frames is decreased when the average gray scale level becomes lower than a predetermined value.

One feature of the structure of the display device of the present invention is that a gray scale method is changed from the overlapped time gray scale method into the binary code digital time gray scale method when the average gray scale level becomes lower than a predetermined value.

One feature of the structure of the display device of the present invention is that the potential control circuit decreases the voltage applied between the pair of electrodes of the light emitting element when the average gray scale level becomes higher than a predetermined value.

One feature of the structure of the display device of the present invention is that the potential control circuit increases the voltage applied between the pair of electrodes of the light emitting element when the average gray scale level becomes lower than a predetermined value.

One feature of a driving method of the display device of the present invention is to convert an analog video signal input to the display device into a digital video signal, calculate an average gray scale level of a frame period, control the number of sub-frames in accordance with the average gray scale level, and change a voltage applied between a pair of electrodes of a light emitting element or a duty ratio in accordance with the average gray scale level.

One feature of a driving method of the display device of the present invention is to convert an analog video signal input to the display device into a digital video signal, calculate an average gray scale level of a frame period, select an overlapped time gray scale method or a binary code digital time gray scale method in accordance with the average gray scale level, and change a voltage applied between a pair of electrodes of a light emitting element or a duty ratio in accordance with the average gray scale level.

In the present invention, a connection includes an electrical connection, a functional connection and a direct connection. Accordingly, in the structure disclosed in the present invention, other connections than a predetermined connection may also be included. For example, at least one element which enables an electrical connection (e.g., a switch, a transistor, a capacitor, an inductor, a resistor, or a diode) may be interposed between an element and another element. In addition, at least one circuit which enables a functional connection (e.g., a logic circuit (such as an inverter, a NAND circuit or a NOR circuit); a signal converter circuit (such as a DA converter circuit, an AD converter circuit or a gamma correction circuit); an electric potential level converter circuit (such as a power supply circuit such as a voltage step-up circuit or a voltage step-down circuit, or a level shift circuit for changing a potential level of an H signal or L signal); a power source; a current source; a switching circuit; an amplifier circuit (such as an operational amplifier, a differential amplifier circuit, a source follower circuit, a buffer circuit, or a circuit which can increase a signal amplitude or a current amount); a signal generation circuit, a memory circuit; a control circuit) may be arranged between an element and another element. Alternatively, direct connection may be conducted without interposing other elements or other circuits. Note that only the case that connection is conducted directly without interposing other elements or other circuits is described as being “directly connected”. Meanwhile, description of “electrically connected” includes an electrical connection (i.e., a connection with another element interposed), a functional connection (i.e., a connection with another circuit interposed), and a direct connection (i.e., a connection without another element or another circuit interposed).

Various switches can be used as a switch used in the present invention. As an example, there is an electrical switch, a mechanical switch, or the like. That is, as long as current flow can be controlled, the invention is not limited to a particular switch and various switches can be used. For example, the switch may be a transistor, a diode (PN diode, PIN diode, Schottky diode, diode-connected transistor, or the like), or a logic circuit that is a combination thereof. Therefore, in a case where a transistor is used as a switch, since the transistor is operated just as a switch, a polarity (conductive type) of the transistor is not limited particularly. However, in a case where a lower off current is desired, a transistor which has a polarity with a lower off current is desirably used. As the transistor with a low off current, a transistor provided with an IDD region, a transistor having a multi-gate structure, or the like can be used. In addition, it is desirable to use an n-channel transistor when a transistor to be operated as a switch operates in a state where a potential of a source terminal thereof is close to a low potential side power source (Vss, GND, 0 V, or the like), whereas it is desirable to use a p-channel transistor when a transistor operates in a state where a potential of a source terminal thereof is close to a high potential side power source (Vdd or the like). This is because the absolute value of a gate-source voltage can be increased, so that the transistor easily operates as a switch. Note that the switch may be of a CMOS type using both an n-channel transistor and a p-channel transistor. In the case of a CMOS switch, even when a situation changes in such that a voltage which is output through the switch (that is, an input voltage to a switch) is high or low for a control signal voltage of the switch, the switch can be operated appropriately.

In the invention, a transistor may have various modes; therefore, the type of applicable transistor is not specifically limited. It is thus possible to apply a thin film transistor (TFT) or the like using a non-single crystalline semiconductor film typified by amorphous silicon or polycrystalline silicon. Due to this, manufacturing can be carried out even with a low manufacturing temperature, with low cost, and over a large-sized and/or transparent substrate, and light can be emitted through the transistor. In addition, a MOS transistor, a junction type transistor, a bipolar transistor, or the like which are formed using a semiconductor substrate or an SOI substrate can be applied. Due to this, a transistor with few variations, a transistor with high current supply capability, or a transistor with a small size can be manufactured, or a circuit with small power consumption can be manufactured. In addition, it is possible to apply a transistor using a compound semiconductor such as ZnO, a-InGaZnO, SiGe, or GaAs, a thin film transistor thereof, or the like. Due to this, manufacturing can be carried out with a temperature which is not so high, even at a room temperature, and a transistor can be directly formed over a low heat-resistant substrate such as a plastic substrate or a film substrate. In addition, a transistor or the like formed by an ink-jet method or a printing method can be applied. Due to this, manufacturing can be carried out at a room temperature, in a low-vacuum state, over a large-sized substrate. In addition, since manufacturing can be conducted without a mask (reticle), a layout of a transistor can be easily changed. In addition, a transistor using an organic semiconductor or a carbon nanotube, or other transistors can be applied. Due to this, a transistor can be formed over a flexible substrate. Note that the non-single crystalline semiconductor film may contain hydrogen or halogen. Further, the type of substrate on which a transistor is provided is not specifically limited and various types of substrates may be used. Thus, for example, a transistor can be formed on a single crystalline substrate, an SOI substrate, a glass substrate, a quartz substrate, a plastic substrate, a paper substrate, a cellophane substrate, a stone substrate, a stainless-steel substrate, a substrate containing stainless-steel foil, or the like. Alternatively, after a transistor is formed on a substrate, it may be transferred onto another substrate to be disposed. By using these substrates, a transistor with favorable characteristics or a transistor with small power consumption, a break-proof transistor, or a heat-resistant transistor can be formed. A transistor is an element having at least three terminals including a gate, a drain and a source, and has a channel formation region between the drain region and the source region. Here, since the source and the drain are changed depending on a structure, an operation condition, or the like of a transistor, it is difficult to identify which is a source or a drain. Therefore, in this specification, regions functioning as the source and the drain may not be referred to as a source and a drain, in some cases. As an example, they are sometimes referred to as a first terminal and a second terminal.

A gate means a part or all of a gate electrode and a gate wire (also called a gate line, a gate signal line, or the like). The gate electrode means a conductive film which overlaps a semiconductor for forming a channel region or an LDD (Lightly Doped Drain) region with a gate insulating film sandwiched therebetween. The gate wire means a wire for connecting gate electrodes of different pixels, or a wire for connecting a gate electrode with another wire.

Note that there exists a portion functioning as both a gate electrode and a gate wire. Such a region may be called either a gate electrode or a gate wire. That is, there is a region where a gate electrode and a gate wire cannot be clearly distinguished from each other. For example, in the case where a channel region overlaps a gate wire which is extended, the overlapped region functions as both a gate wire and a gate electrode. Accordingly, such a region may be called either a gate electrode or a gate wire.

In addition, a region which is formed with the same material as the gate electrode and connected to the gate electrode may be called a gate electrode. Similarly, a region which is formed with the same material as the gate wire and connected to the gate wire may be called a gate wire. In the strict sense, such a region may not overlap the channel region or may not have a function of connecting to another gate electrode. However, there is a case where this region is formed with same material as the gate electrode or the gate wire and connected to the gate electrode or the gate wire in order to provide a sufficient manufacturing margin. Accordingly, such a region may also be called a gate electrode or a gate wire.

In the case of a multi-gate transistor, for example, a gate electrode of a transistor is connected to a gate electrode of another transistor with the use of a conductive film which is formed with the same material as the gate electrodes. Since this region is a region for connecting a gate electrode to another gate electrode, it may be called a gate wire, while it may also be called a gate electrode since the multi-gate transistor may be regarded as one transistor. That is, a region may be called a gate electrode or a gate wire as long as it is formed of the same material as gate electrodes or gate wires and connected thereto. In addition, a part of a conductive film which connects a gate electrode to a gate wire, for example, may also be called a gate electrode or a gate wire.

Note that a gate terminal means a part of a gate electrode or a part of a region electrically connected to a gate electrode.

Note that a source means a part or all of a source region, a source electrode, and a source wire (also called a source line, a source signal line, or the like). A source region is a semiconductor region containing a large amount of p-type impurities (e.g., boron or gallium) or n-type impurities (e.g., phosphorus or arsenic). Accordingly, it does not include a region containing a slight amount of p-type impurities or n-type impurities, that is a so-called LDD (Lightly Doped Drain) region. The source electrode is a conductive layer which is formed of a different material from the source region and electrically connected to the source region. Note that there is a case where a source electrode and a source region are collectively referred to as a source electrode. The source wire is a wire for connecting source electrodes of different pixels, or a wire for connecting a source electrode with another wire.

However, there exists a portion functioning as both a source electrode and a source wire. Such a region may be called either a source electrode or a source wire. That is, there is a region where a source electrode and a source wire cannot be clearly distinguished from each other. For example, in the case where a source region overlaps a source wire which is extended, the overlapped region functions as both a source wire and a source electrode. Accordingly, such a region may be called either a source electrode or a source wire.

In addition, a region which is formed with the same material as a source electrode and connected to the source electrode and a portion which connects a source electrode and another source electrode may each be called a source electrode. A portion which overlaps a source region may be called a source electrode as well. Similarly, a region which is formed with the same material as the source wire and connected to the source wire may be called a source wire as well. In the strict sense, such a region may not have a function of connecting to another source electrode. However, there is a case where this region is formed with same material as the source electrode or the source wire and connected to the source electrode or the source wire in order to provide a sufficient manufacturing margin. Accordingly, such a region may also be called a source electrode or a source wire.

In addition, a part of a conductive film which connects a source electrode to a source wire may be called either a source electrode or a source wire, for example.

Note that a source terminal means a part of a source region, a source electrode, or a part of a region electrically connected to a source electrode. Note also that a drain has a similar structure to the source.

In this specification, a display element, display device and a light emitting device can employ various modes and include various elements. As an example, there is a display medium whose contrast changes by an electromagnetic function, such as an EL element (e.g., an organic EL element, an inorganic EL element, or an EL element containing an organic material or an inorganic material), an electron-emissive element, a liquid crystal element, electronic ink, a grating light valve (GLV), a plasma display (PDP), a digital micromirror device (DMD), a piezoceramic display, or a carbon nanotube. In addition, a display device using an EL element includes an EL display; a display device using an electron-emissive element includes a field emission display (FED) or a surface-conduction electron-emitter display (SED); a display device using a liquid crystal element includes a liquid crystal display, a transmissive liquid crystal display, a semitransmissive liquid crystal display, or a reflective liquid crystal display; and a display device using electronic ink includes electronic paper. A display element may emit monochromatic light or light of a plurality of colors such as red (R), green (G), and blue (B). In order to extract light, either of electrodes is transparent.

In the present invention, the type of applicable transistor is not particularly limited, and a thin film transistor (TFT) using a non-single crystalline semiconductor film typified by amorphous silicon or polycrystalline silicon, a MOS transistor formed by using a semiconductor substrate or an SOI substrate, a junction type transistor, a bipolar transistor, a transistor using organic semiconductor or carbon nanotube, or other transistors can be used.

Note also that the structure of a transistor in the present invention is not limited to a certain type and various structures may be employed. For example, a multi-gate structure having two or more gate electrodes may be used. In the case of a multi-gate structure, since channel regions are connected in series, a structure in which a plurality of transistors is connected in series is obtained. By using the multi-gate structure, an off current can be reduced as well as a withstand voltage can be increased to improve reliability of the transistor, and even when a drain-source voltage fluctuates at the time when the transistor operates in the saturation region, flat characteristics can be provided without causing fluctuations of a drain-source current. In addition, such a structure may also be employed that gate electrodes are formed to sandwich a channel. By using such a structure that gate electrodes are formed to sandwich a channel, the area of the channel region can be enlarged to increase the value of current flowing therein, and a depletion layer can be easily formed to increase the S value. In the case of forming gate electrodes to sandwich a channel, a structure in which a plurality of transistors is connected in parallel is obtained. In addition, any of the following structures may be employed that: a gate electrode is formed over a channel; a gate electrode is formed below a channel; a staggered structure; an inversely staggered structure; a structure where a channel region is divided into a plurality of regions and connected in parallel; or a structure where a channel region is divided into a plurality of regions and connected in series. In addition, a channel (or a part of it) may overlap a source electrode or a drain electrode. By forming a structure where a channel (or a part of it) overlaps a source electrode or a drain electrode, unstable operation can be prevented, which would otherwise be caused in the case where charges gather in a part of the channel. In addition, an LDD region may be provided. By providing an LDD region, an off current can be reduced as well as a withstand voltage can be increased to improve reliability of the transistor, and even when a drain-source voltage fluctuates at the time when the transistor operates in the saturation region, flat characteristics can be provided without causing fluctuations of a drain-source current.

Note that a transistor in the invention may be formed over any type of substrate. Therefore, all circuits may be formed over a glass substrate, a plastic substrate, a single crystalline substrate, or an SOI substrate. Alternatively, such a structure may be employed that some circuits are formed over a substrate, while some other circuits are formed over another substrate. That is, not the whole circuits are required to be formed over one substrate. For example, some circuits may be formed over a glass substrate by using TFTs, while some other circuits may be formed over a single crystalline substrate, and then, the IC chip may be deposited onto the glass substrate by COG (Chip on Glass) bonding. Alternatively, the IC chip may be connected to the glass substrate by TAB (Tape Automated Bonding) or by using a printed board. In this manner, when some circuits are formed over the same substrate, cost can be reduced by reducing the number of components and reliability can be improved by reducing the number of connections with the components. Further, a portion with a high driving voltage or a high driving frequency which consumes more power is not preferably formed over the same substrate, thereby an increase in power consumption can be prevented.

In the present invention, one pixel corresponds to one element which can control brightness. Therefore, for example, one pixel expresses one color element by which brightness is expressed. Accordingly, in the case of a color display device formed of color elements of R (red), G (green), and B (blue), the smallest unit of an image is formed of three pixels of an R pixel, a G pixel, and a B pixel. It is to be noted that color elements are not limited to three kinds and may be more colors, and another color in addition to RGB may be used. RGBW (W is white) may be employed by adding white. One or more color such as yellow, cyan, magenta, for example, may be added to RGB. In addition, a similar color to at least one color in RGB may be added. For example, R, G, B1, and B2 may be used. B1 and B2 both exhibit blue colors but have different frequencies. By using such color elements, it is possible to perform display that is much similar to the real and to reduce power consumption. Further, as another example, when controlling the brightness of one color element by using a plurality of regions, one of the plurality of regions corresponds to one pixel. Therefore, for example, in the case of performing an area gray scale display, a plurality of regions are provided for one color element to control the brightness, which express gray scale as a whole. One of the regions to control the brightness corresponds to one pixel. Therefore, in that case, one color element is formed by a plurality of pixels. Moreover, in that case, regions which contribute to display differ in size depending on the pixel. In the plurality of regions to control the brightness provided for one color element, that is a plurality of pixels which form one color element, the viewing angle may be expanded by supplying each pixel with a slightly different signal. It is to be noted that the description “one pixel (for three colors)” means one pixel including three pixels of R, G, and B. The description “one pixel (for one color)” corresponds to the case where a plurality of pixels are provided for one color element, and are collectively considered as one pixel.

Note that in this specification, pixels may be provided (arranged) in matrix. Herein, when it is described that pixels are provided (arranged) in matrix, there may be a case where the pixels are provided linearly or not linearly in the longitudinal direction or the lateral direction. Accordingly, in the case of performing full color display with three color elements (e.g., RGB) for example, there may be a case where dots of three color elements are arranged in stripes or in delta pattern. Further, there may be a case where the color elements are provided in the Bayer arrangement. Color elements are not limited to three kinds and may be more kinds. For example, there is RGBW (W is white), or RGB plus at least one of yellow, cyan, magenta, emerald green, and vermilion. The area of a display region may differ between dots of the respective color elements. Accordingly, power consumption can be reduced, and a display element life can be extended.

Note that in this specification, the term “semiconductor device” means a device having a circuit including a semiconductor element (such as a transistor or a diode). In addition, it may also mean a device in general that can operate by utilizing semiconductor characteristics. The term “display device” means a device including a display element (such as a liquid crystal element or a light emitting element). Note that it may also mean a main body of a display panel in which a plurality of pixels each including a display element such as a liquid crystal element or an EL element or a peripheral driver circuit for driving the pixels are formed over a substrate. Moreover, it may include a device to which a flexible printed circuit (FPC) or a printed wiring board (PWB) is attached (such as an IC, a resistor, a capacitor, an inductor, or a transistor). Further, it may also include an optical sheet such as a polarizing plate or a retardation film. Furthermore, it may include a backlight (which may include a light conducting plate, a prism sheet, a diffusion sheet, a reflection sheet, or a light source (such as an LED or a cold cathode tube)). In addition, the term “light emitting device” means a display device particularly including a self-emission type display element such as an EL element or an element used in FED. The term “liquid crystal display device” means a display device including a liquid crystal element.

In this specification, a wire or electrode is formed by using one or a plurality of elements selected from a group including aluminum (Al), tantalum (Ta), titanium (Ti), molybdenum (Mo), tungsten (W), neodymium (Nd), chromium (Cr), nickel (Ni), platinum (Pt), gold (Au), silver (Ag), copper (Cu), magnesium (Mg), scandium (Sc), cobalt (Co), zinc (Zn), niobium (Nb), silicon (Si), phosphorus (P), boron (B), arsenic (As), gallium (Ga), indium (In), tin (Sn), and oxygen (O); a compound or an alloy material containing one or a plurality of elements selected from the above-described group as its component (e.g., indium tin oxide (ITO), indium zinc oxide (IZO), indium tin oxide to which silicon oxide is added (ITSO), zinic oxide (ZnO), aluminum-neodymium (Al—Nd), or magnesium-silver (Mg—Ag)); a material obtained by combining the above-described compounds; or the like. Alternatively, it is formed by using a compound of the above-described compound and silicon (silicide) (e.g., aluminum silicon, molybdenum silicon, or nickel silicide), or a compound of the above-described compound and nitrogen (e.g., titanium nitride, tantalum nitride, or molybdenum nitride).

Note that in the silicon (Si), a large amount of n-type impurity (e.g., phosphorus) or p-type impurity (e.g., boron) may be contained. When such an impurity is contained, silicon is easily used for a wire or an electrode since the conductivity of silicon is increased and silicon acts as a normal conductor. Note also that silicon may be single crystalline silicon, polycrystalline silicon (polysilicon), or amorphous silicon. When single crystalline silicon or polycrystalline silicon is used, resistance can be reduced. When amorphous silicon is used, a wire or an electrode can be formed by a simplified manufacturing process.

Aluminum and silver can reduce signal delay since the conductivity thereof is high, and can be easily etched so that processing (patterning) thereof can be easily conducted and microfabrication can be performed. Copper can reduce signal delay since the conductivity thereof is high. Molybdenum is desirable because it can be formed without causing a problem such as a defect of a material even if it contacts with an oxide semiconductor such as ITO or IZO or silicon, patterning or etching thereof can be easily performed, and the heat resistance is high. Titanium is desirable because it can be formed without causing a problem such as a defect of a material even if it contacts with an oxide semiconductor such as ITO or IZO or silicon, and the heat resistance is high. Tungsten is desirable because of its high heat resistance. Neodymium is desirable because of its high heat resistance. In particular, an aluminum-neodymium alloy is desirable since the heat resistance increases and the formation of hillocks in aluminum can be suppressed. Silicon is desirable because it can be formed simultaneously with a semiconductor layer of a transistor and the heat resistance is high. Indium tin oxide (ITO), indium zinc oxide (IZO), indium tin oxide added with silicon oxide (ITSO), zinc oxide (ZnO), and silicon (Si) are desirable since they transmit light and thus can be used in a portion through which light passes; for example, and they can be used as a pixel electrode or a common electrode.

These materials may have a single layer structure or a multilayer structure to form the wire or the electrode. When a single layer structure is adopted, the manufacturing process can be simplified and the number of manufacturing days can be reduced, leading to cost savings. On the other hand, when a multilayer structure is adopted, the advantages of respective materials can be utilized and the disadvantages thereof can be reduced, thereby forming a high-performance wire or electrode. For example, by including a low resistance material (e.g., aluminum) in a multilayer structure, the resistance of a wire can be reduced. Further, by including a high heat resistance material, for example, when adopting a stacked structure in which a material that does not have a high heat resistance but has other advantages is interposed between the high heat resistance materials, the heat resistance of the wire or the electrode can be increased as a whole. For example, it is desirable to use a stacked structure in which a layer containing aluminum is interposed between layers each containing molybdenum or titanium. In addition, if the wire or the electrode partially contacts directly with another wire or electrode made of a different material, these wires or electrodes may adversely affect each other. For example, a material of one wire or electrode may enter a material of the other wire or electrode to change the property thereof, so that the intended purpose is prevented from being fulfilled, or problems occur in manufacturing and manufacturing steps cannot be completed normally. In such a case, the problem can be solved by interposing or covering a layer with another layer. For example, in the case where indium tin oxide (ITO) is to contact with aluminum, titanium or molybdenum is desirably interposed therebetween. In the case where silicon is to contact with aluminum, titanium or molybdenum is desirably interposed therebetween.

In the invention, when it is described that an object is formed on another object, it does not necessarily mean that the object is in direct contact with the another object, and also includes the case where the above two objects are not in direct contact with each other, in other words, still another object may be sandwiched therebetween. Accordingly, when it is described that a layer B is formed on a layer A, it means either a case where the layer B is formed in direct contact with the layer A, or a case where another layer (e.g., a layer C or a layer D) is formed in direct contact with the layer A, and then the layer B is formed in direct contact with the layer C or D. Similarly, when it is described that an object is formed over or above another object, it does not necessarily mean that the object is in direct contact with the another object, and still another object may be sandwiched therebetween. Accordingly, when it is described that a layer B is formed over or above a layer A, it means either a case where the layer B is formed in direct contact with the layer A, or a case where another layer (e.g., a layer C or a layer D) is formed in direct contact with the layer A, and then the layer B is formed in direct contact with the layer C or D. Similarly, when it is described that an object is formed below or under another object, it means either case where the objects are in direct contact with each other or not in direct contact with each other.

When an average luminance of an entire screen is low and a high gray scale is displayed in a portion, a peak luminance in the portion can be increased, and a display device capable of performing sharp image display with high contrast can be provided.

### BRIEF DESCRIPTION OF DRAWINGS

In the accompanying drawings:

FIG. 1 shows a display device having a pixel configuration of the present invention;

FIGS. 2A and 2B show a signal line driver circuit of a line sequential method according to the present invention;

FIGS. 3A and 3B show a signal line driver circuit of a dot sequential method according to the present invention;

FIG. 4 shows a pixel configuration of the present invention;

FIG. 5 shows a pixel configuration of the present invention;

FIG. 6 shows a pixel configuration of the present invention;

FIG. 7 is a timing chart of a display device having a pixel configuration of the present invention;

FIG. 8 is a timing chart of a display device having a pixel configuration of the present invention;

FIG. 9 shows a pixel configuration of the present invention;

FIG. 10 shows a pixel configuration of the present invention;

FIG. 11 shows a pixel configuration of the present invention;

FIG. 12 is a top view of a pixel configuration of the present invention;

FIG. 13 shows a configuration of one pixel of the present invention;

FIG. 14 is a top view of a pixel portion having a pixel configuration of the present invention;

FIG. 15 is a timing chart of a display device having a pixel configuration of the present invention;

FIGS. 16A and 16B are timing charts of a display device having a pixel configuration of the present invention;

FIG. 17 shows a pixel configuration of the present invention;

FIG. 18 shows a driving voltage waveform of a pixel circuit of the present invention;

FIG. 19 shows a driving voltage waveform of a pixel circuit of the present invention;

FIGS. 20A to 20F show driving voltage waveforms of a pixel circuit of the present invention;

FIGS. 21A to 21G show driving voltage waveforms of a pixel circuit of the present invention;

FIGS. 22A and 22B are timing charts of a display device having a pixel configuration of the present invention;

FIGS. 23A and 23B are timing charts of a display device having a pixel configuration of the present invention;

FIG. 24 is a block diagram showing a main structure of the present invention;

FIG. 25 is a block diagram showing a main structure of the present invention;

FIG. 26 is a block diagram showing a main structure of the present invention;

FIGS. 27A and 27B show structures of display panels to which the present invention is applied;

FIG. 28 shows a structure of a display panel to which the present invention is applied;

FIG. 29 shows an example of a light emitting element which can be applied to a display device having a pixel configuration of the present invention;

FIG. 30 shows an example of a light emitting element which can be applied to a display device having a pixel configuration of the present invention;

FIGS. 31A to 31C show emission structures of light emitting elements;

FIGS. 32A to 32H show electronic devices to which the present invention is applied;

FIGS. 33A and 33B show a structure of a semiconductor device of the present invention;

FIGS. 34A and 34B show a structure of a semiconductor device of the present invention;

FIGS. 35A and 35B show a structure of a semiconductor device of the present invention;

FIGS. 36A and 36B show TFT structures included in a display device of the present invention;

FIGS. 37A and 37B show TFT structures included in a display device of the present invention;

FIGS. 38A and 38B show TFT structures included in a display device of the present invention; and

FIG. 39 shows a conventional pixel configuration.

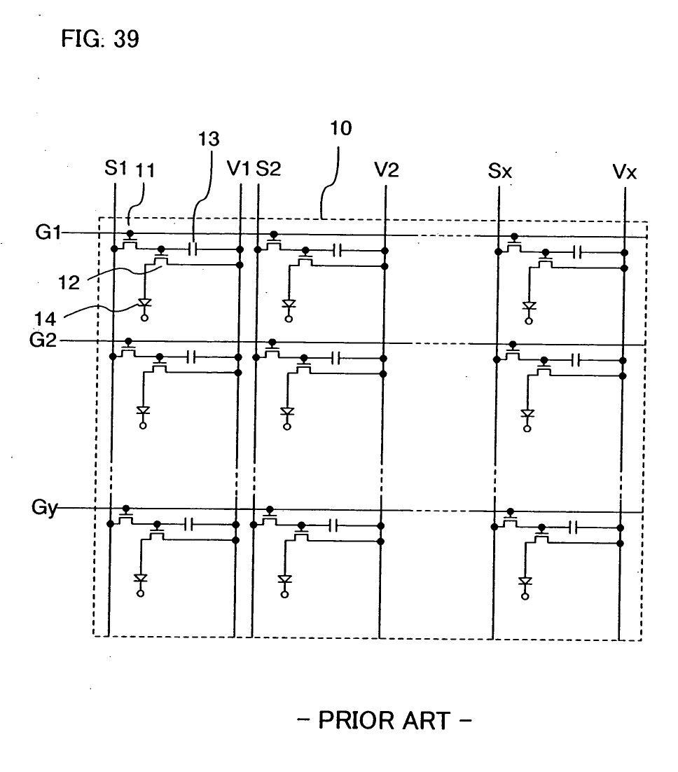

### DETAILED DESCRIPTION OF THE INVENTION

Embodiment modes and embodiments of the present invention will be described with reference to the drawings. Note that it is easily understood by those skilled in the art that the present invention can be carried out in various modes, and various changes may be made in forms and details without departing from the spirit and the scope of the invention. Therefore, the present invention should not be limited to descriptions of the embodiment modes and the embodiments below.

### Embodiment Mode 1

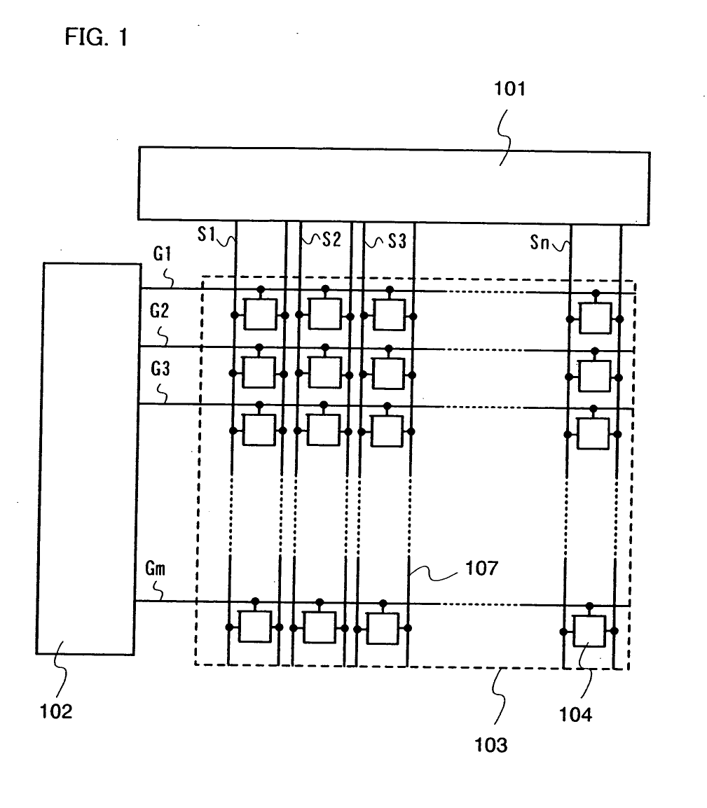

FIG. 1 shows a basic pixel matrix circuit of a display device of the present invention. This pixel matrix circuit includes a signal line driver circuit 101, a scanning line driver circuit 102, and a pixel portion 103 which is provided with a plurality of pixels 104. In addition, corresponding to scanning lines (G1 to Gm) disposed in rows, signal lines (S1 to Sn) disposed in columns, and power supply lines 107, pixels 104 are disposed in matrix.

The signal line driver circuit 101 outputs a video signal to the signal lines S1 to Sn. The scanning line driver circuit 102 outputs a signal for selecting the pixels 104 disposed in rows, to the scanning lines G1 to Gm. Then, the video signal from the signal line driver circuit 101 is written in each pixel 104 of a pixel row selected by the signal that is output from the scanning line driver circuit 102. Note that the signal input to the signal lines S1 to Sn from the signal line driver circuit 101 is not limited to a video signal. For example, a signal forcing pixels of all columns to be in a non-lighting state (erasing signal) may be input to the pixels.

Next, the operation of the display device is described.

At the time of signal writing operation to the pixels 104, a pixel row to which a signal is to be written is selected by the scanning line driver circuit 102. Then, the signal is written to the pixels 104 of each column in the selected pixel row from the signal line driver circuit 101 through the signal lines S1 to Sn. When the signal is written to the pixels 104, the pixels store the signal written thereto.

In a similar manner, the pixels 104 are sequentially selected, and the signal is written to the pixels 104. When the signal is written to all the pixels 104 in the pixel portion 103, a writing period to the pixels 104 is completed.

The pixels 104 hold the signal written thereto for a certain period. Therefore, at the time of light emitting operation of the pixels, the state of each pixel (lighting or non-lighting) in response to the signal written thereto can be maintained.

A moving image can be displayed by repeating the writing operation and the light emitting operation.

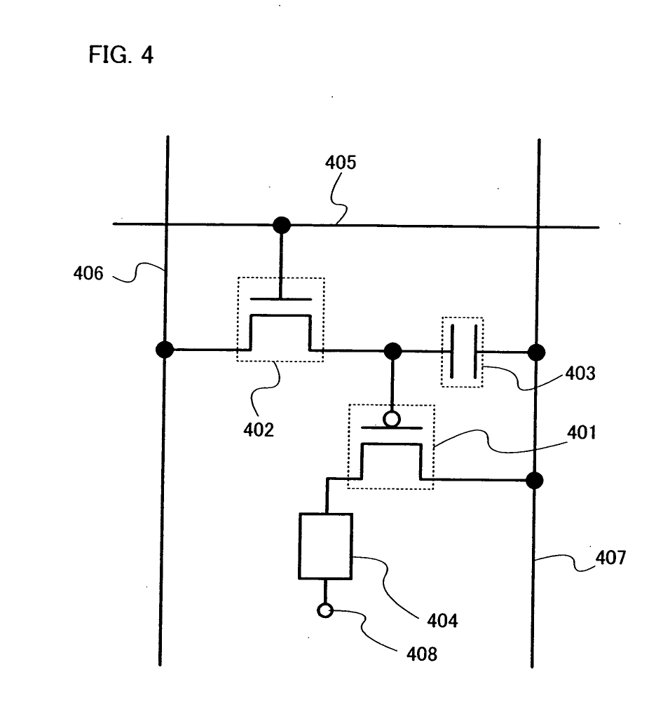

Next, a circuit configuration of one pixel of the pixel matrix circuit shown in FIG. 1 will be described with reference to FIG. 4. One pixel includes a driving TFT 401, a switching TFT (also referred to as a TFT for switching or a SWT) 402, a capacitor 403, a light emitting element 404, a scanning line 405, a signal line 406, a power supply line 407 and an opposite electrode 408.

A gate electrode of the switching TFT 402 is connected to the scanning line 405. One of a source region and a drain region of the switching TFT 402 is connected to the signal line 406, and the other is connected to a gate electrode of the driving TFT 401 and the capacitor 403.

One of electrodes which are opposed to each other in the capacitor 403 is connected to the power supply line 407, and the other electrode is connected to the source region or drain region of the switching TFT 402, and the gate electrode of the driving TFT 401. The capacitor 403 is provided in order to hold a gate potential of the driving TFT 401 when the switching TFT 402 is not selected (off state). Accordingly, as long as the capacitor 403 is provided to be able to hold the gate potential of the driving TFT 401, the layout is not limited to the layout shown in FIG. 4. Note that in the case where the gate potential of the driving TFT 401 can be held using, for example, gate capacitance of the driving TFT 401, the capacitor 403 may be omitted.

One of electrodes connected to a source region or a drain region of the driving TFT 401 is connected to the power supply line 407, and the other electrode is connected to the light emitting element 404.

The light emitting element 404 includes an anode, a cathode, and an organic compound layer provided between the anode and the cathode. In the light emitting element 404, an electrode connected to the source region or drain region of the driving TFT 401 is called a pixel electrode, and the other electrode of the light emitting element 404 is called an opposite electrode. The anode and the cathode of the light emitting element 404 are determined by a potential that is input to the opposite electrode 408 and the power supply line 407. The electrode having a higher potential serves as an anode, and the electrode having a lower potential serves as a cathode. Here, the opposite electrode 408 of the light emitting element 404 is set at a low power supply potential. The low power supply potential is a potential which satisfies the relation: low power supply potential<high power supply potential, with a high power supply potential set at the power supply line 407 as a reference. As the low power supply potential, for example, GND, 0 V, or the like may be set.

Next, an operation method of a pixel is described with reference to FIG. 4. The scanning line 405 is selected to turn on the switching TFT 402, and a signal from the signal line 406 is input to the gate of the driving TFT 401. The driving TFT 401 turns on or off in response to the input signal, and when the driving TFT 401 is on, a current flows into the light emitting element 404 from the power supply line 407. At this time, a potential which corresponds to the signal input from the signal line 406 is held with the capacitor 403.

To make the light emitting element 404 emit light, a potential difference between the high power supply potential set at the power supply line 407 and the low power supply potential set at the opposite electrode 408 of the light emitting element 404 is applied to the light emitting element 404 to feed a current to the light emitting element 404. At this time, potentials of the high power supply potential and the low power supply potential are set so that a potential difference between them becomes equal to or higher than a forward threshold voltage of the light emitting element 404.

In the present invention, when an entire screen has a low average luminance and a high gray scale is displayed in some pixels, the high power supply potential at the supply line 407 is set to be even higher. As a result, the potential difference applied to the light emitting element 404 increases, and the amount of the current to the light emitting element 404 increases, which can increase a peak luminance of the pixels where a high gray scale is displayed. Alternatively, the potential difference applied to the light emitting element 404 may be increased by setting the low power supply potential at the opposite electrode 408 of the light emitting element 404 to be lower, without changing the high power supply potential at the power supply line 407. Further alternatively, the potential difference applied to the light emitting element 404 may be increased by setting the potential at the power supply line 407 to be higher and setting the potential at the opposite electrode of the light emitting element 404 to be lower.

Next, the relation between the signal input to the signal line 406 and the potential at the power supply line 407 is described. In the case where an H level signal is input to the signal line 406, a potential at an H level is set to be higher than a potential calculated by subtracting the absolute value of the threshold potential of the driving TFT 401 from the potential input to the power supply line 407. Then, the driving TFT 401 turns off, and a current does not flow to the light emitting element 404. If this is expressed with a formula and the threshold voltage of the driving TFT 401 is Vₜₕ, the potential of the power supply line 407 is V_{dd}, and the signal making the driving TFT 401 turn off (making the light emitting element emit no light) is V_{hd}, V_{hd} can be expressed as a potential which satisfies V_{hd}>V_{dd}−|Vₜₕ51 . When V_{hd} is set too high, power consumption is increased. Accordingly, V_{hd} is preferably set at a potential higher than V_{dd} by about 1 to 3 V, for example.

In addition, in the case where an L level (Low Level) signal is input to the signal line 406, a potential at an L level is set to be lower than a potential calculated by subtracting the absolute value of the threshold potential of the driving TFT 401 from the potential input to the power supply line 407. Then, the driving TFT 401 turns on, and a current flows to the light emitting element 404. Preferably, a signal which makes either of two states of sufficiently turning on or turning off the driving TFT 401 is input to the gate of the driving TFT 401. Accordingly, the potential of the signal at an L level which is input to the gate of the driving TFT 401 is a potential by which the driving TFT 401 is operated in a linear region. Since the driving TFT 401 operates in the linear region, it is ideal that the potential input to the power supply line 407 is directly applied to the electrode of the light emitting element 404.

Here, the relation between the signal that is input to the scanning line 405 and the signal that is input to the signal line 406 is described. When the scanning line 405 is on (selected), the signal at an H level that is input to the scanning line 405 (referred to as V_{hsw}) is set at a potential higher than the signal at an H level which is input to the signal line 406 and which turns off the driving TFT 401 (referred to as V_{hd}), by the threshold voltage of the switching TFT 402 (referred to as Vₜₕ) or more. If V_{hd}>V_{hsw}−Vₜₕ, the signal input to the gate of the driving TFT 401 is V_{hsw}−Vₜₕ, and the signal at an H level which completely turns off the driving TFT 401 cannot be input to the gate of the driving TFT 401. Accordingly, the driving TFT 401 cannot be completely turned off, and as a result, there is a possibility that the light emitting element 404 emits light. On the other hand, when the potential of the signal at an H level that is input to the scanning line 405 is too high, power consumption is increased. Accordingly, the signal at an H level that is input to the scanning line 405 is preferably set to be higher than the signal at an H level that is input to the signal line 406 by about 1 to 3 V.

In addition, when the scanning line 405 is off (not selected), the signal at an L level that is input to the scanning line 405 (referred to as V_{LSW}) is preferably set at a potential lower than the signal at an L level that is input to the signal line 406. As the reason, the case where the signal at an L level which is input to the scanning line 405 has the same potential as that of the signal at an L level which is input to the signal line 406 will be described. For example, when the n-channel type switching TFT 402 is of a depletion type (normally on), the threshold voltage of the switching TFT 402 is a negative value. Therefore, when the signal at an L level which is input to the scanning line 405 has the same potential as that of the signal at an L level which is input to the signal line 406, the switching TFT 402 turns on. As a result, the signal at an L level which is input to the signal line 406 for writing in pixels in other rows is input to the gate of the driving TFT 401 of a pixel where signal writing has already been completed, which causes the driving TFT 401 to operate.

In FIG. 4, the switching TFT 402 and the driving TFT 401 each have a single gate structure; however, the invention is not limited to this structure, and a multi-gate structure such as a dual gate structure or a triple (tri) gate structure may be employed. In a single gate structure, one TFT has one gate electrode. In a multi-gate structure, one TFT has a plurality of gates, two or more TFTs are connected in series, and gate electrodes of each TFT are connected. By employing a multi-gate structure, an off current can be reduced compared to the case of employing a single gate structure.

In addition, the switching TFT 402 uses an n-channel TFT, and the driving TFT 401 uses a p-channel TFT; however, the present invention is not limited to this structure and either an n-channel TFT or a p-channel TFT can be used. For example, in the case of using an n-channel TFT as a driving TFT, the driving TFT turns on when a signal at an H level is input to the signal line, and the driving TFT turns off when a signal at an L level is input to the signal line.

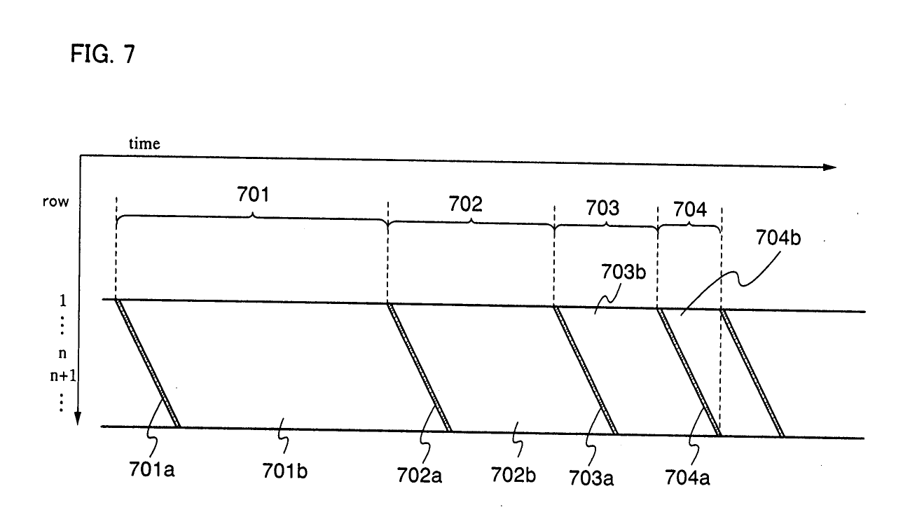

Next, expression of gray scale by selection of sub-frames for one frame period is described with reference to a timing chart of FIG. 7. In FIG. 7, the horizontal direction indicates the passage of time, while the vertical direction indicates the number of scanning stages of a scanning line.

When an image is displayed with a display device of the invention, rewriting (address) operations and displaying (sustain) operations of a screen are carried out repeatedly in the display period. There is no particular limitation on the number of rewriting operations; however, the rewriting operations are preferably performed about 60 times or more in a second so that a person who watches a displayed image does not sense a flicker in the image. Here, a period of the rewriting and displaying operations for one screen (one frame) is referred to as one frame period. A sustain (lighting) period is a period during which a light emitting element emits light in response to a signal written in a pixel to the address period. When expressing an n-bit gray scale, the length ratio of n sustain periods is set to 2⁰:2¹: . . . 2ⁿ⁻²:2ⁿ⁻¹. Depending on in which sustain period a light emitting element emits light, the length of the period during which each pixel emits light in one frame period is determined, and thus a gray scale is expressed.

FIG. 7 is a timing chart showing the case of displaying a 4-bit gray scale. One frame period is time-divided into four sub-frames 701, 702, 703, and 704 including address periods 701a, 702a, 703a, and 704a and sustain periods 701b, 702b, 703b, and 704b, respectively. The light emitting element to which a signal for light emission is applied is in a light emitting state during the sustain periods. The length ratio of the sustain periods of the sub-frames, the first sub-frame 701: the second sub-frame 702: the third sub-frame 703: the fourth sub-frame 704, satisfies 2³:2²:2¹:2⁰=8:4:2:1. This allows the light emitting element to display a 4-bit gray scale. The number of bits and the gray scales are not limited to those shown in this embodiment mode. For example, one frame period may include eight sub-frames so as to display a 8-bit gray scale.

The operation of one frame period will be described. First, in the sub-frame 701, the writing operation is performed sequentially from a first row to a last row. Therefore, the starting time of the writing period varies depending on the row. The sustain period 701b sequentially starts in the rows in which the address period 701a has been terminated. In the sustain period 701b, the light emitting element applied with a signal for light emission remains in a light emitting state. The sub-frame 701 is changed to the next sub-frame 702 sequentially in the rows in which the sustain period 701b has been terminated. In the sub-frame 702, a writing operation is performed sequentially from the first row to the last row, in the same manner as in the case of the sub-frame 701. The above-mentioned operations are carried out repeatedly up to the sustain period 704b of the sub-frame 704, and are then terminated. After terminating the operation of the sub-frame 704, an operation in the next frame is started. Accordingly, the sum of the light-emitting time in all the sub-frames corresponds to the light emitting time of each light emitting element in one frame period. By varying the light emitting time for each light emitting element and combining the light emitting elements in various ways within one pixel, various display colors with differing brightness and differing chromaticity can be formed.

Although the sub-frames 701 to 704 are arranged in order from the longest to the shortest length of the sustain period in this embodiment mode, they do not necessarily have to be arranged in this order. For example, the sub-frames may be arranged in order from the shortest length of the sustain period to the longest. Alternatively, the sub-frames may be arranged in random order regardless of the length of the sustain period. In addition, these sub-frames may further be divided into a plurality of sub-frames.

Next, description is made of an average luminance. The average luminance is a luminance calculated by adding the light emitting time of all the pixels in one frame period and dividing it by the number of pixels.

In this embodiment mode, when the average luminance is low in the entire screen, the potential applied to the power supply line 407 is increased. Alternatively, by decreasing the potential of the opposite electrode 408 of the light emitting element 404, voltage applied to both ends of the light emitting element 404 is increased. Further alternatively, the potentials of both the power supply line 407 and the opposite electrode 408 may be changed. As a result, when the entire screen becomes dark, and a bright image is displayed in one portion, a sharp image can be displayed with high contrast.

When the average luminance of the entire screen is high, the potential of the power supply line 407 is decreased. Alternatively, by increasing the potential of the opposite electrode 408 of the light emitting element 404, a voltage applied to both ends of the light emitting element 404 is decreased. Further alternatively, the potentials of both the power supply line 407 and the opposite electrode 408 may be changed. When a bright image is displayed in the entire screen in this manner, since a bright display can be maintained overall even if the average luminance is somewhat reduced, power consumption can be reduced.

Here, a method of writing a video signal to a pixel is described.

As a method of writing a video signal to a pixel, there is a line sequential method in which a signal is written in pixels in selected rows all at once, or a dot sequential method in which a signal is written in pixels one by one in selected rows.

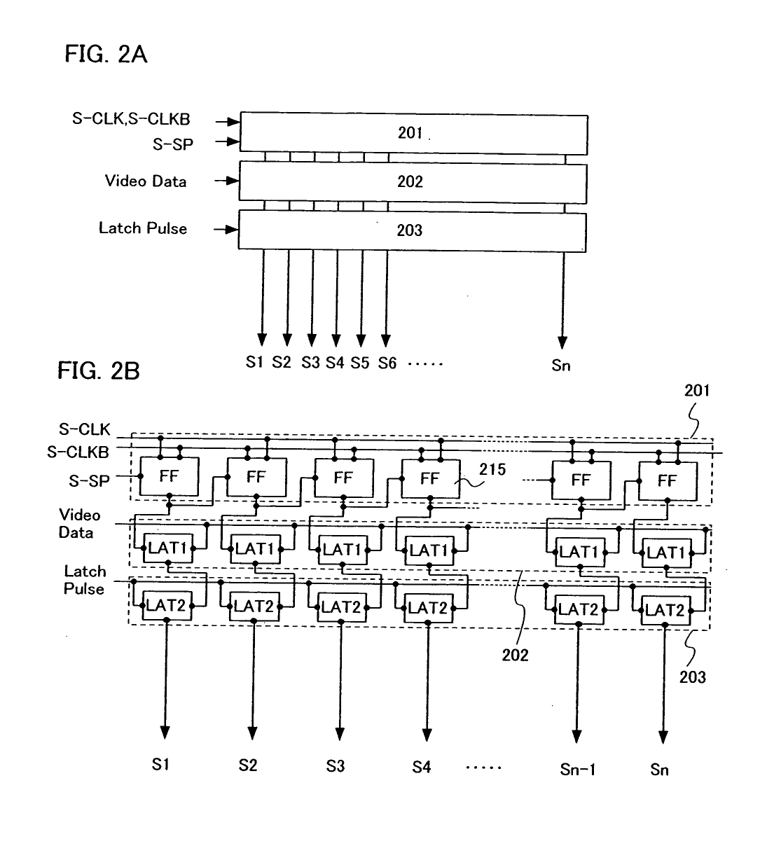

The signal line driver circuit 101 of FIG. 1 is described in more detail with reference to FIG. 2A and 2B. A signal line driver circuit shown in FIG. 2A includes a pulse output circuit 201, a first latch circuit 202, and a second latch circuit 203. Operation of the signal line driver circuit shown in FIG. 2A is described using a detailed structure shown in FIG. 2B.

The pulse output circuit 201 includes a plurality of stages of flip-flop circuits (FF) 215 or the like, into which a clock signal (S-CLK), a clock inverted signal (S-CLKB), and a start pulse signal (S-SP) are input. A sampling pulse is output sequentially in accordance with the timing of these signals.

The sampling pulse output from the pulse output circuit 201 is input into the first latch circuit 202. A video signal (video data) is input into the first latch circuit 202, and stored in each stage in accordance with the timing that the sampling pulse is input. Latch circuits of each stage in the first latch circuit 202 are operated by the sampling pulse.

When the first latch circuit 202 finishes storing the digital video signal up to the last stage, a latch pulse is input into the second latch circuit 203 in a horizontal retrace period, and the digital video signals held in the first latch circuit 202 are transmitted to the second latch circuit 203 all at once. After that, the digital video signals for one row held in the second latch circuit 203 are output to signal lines S1 to Sn simultaneously.

While writing to the pixels is conducted by the digital video signals held in the second latch circuit 203, the pulse output circuit 201 again outputs a sampling pulse. The above-described operation is repeated to process video signals for one frame period.

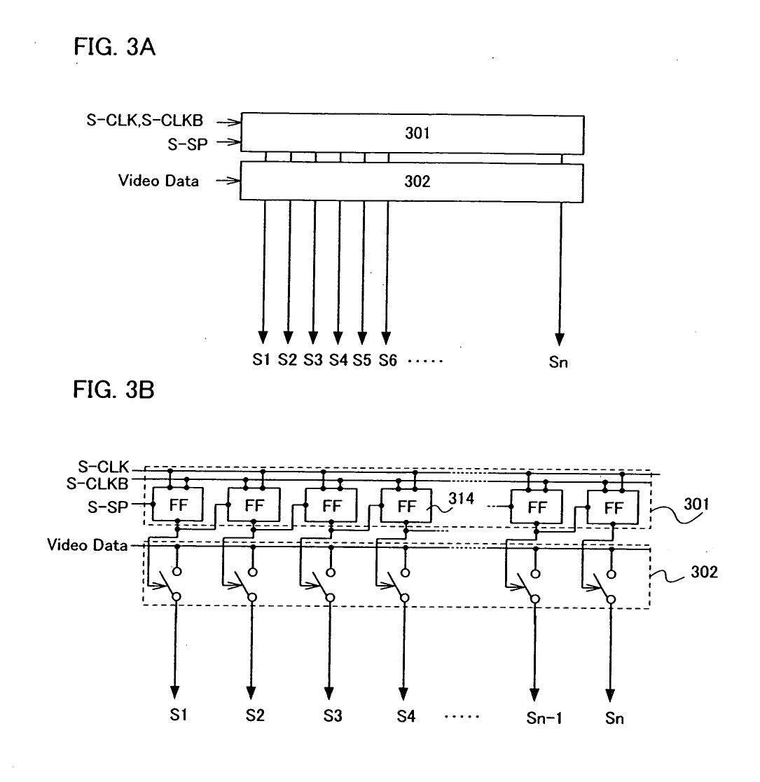

A signal line driver circuit employing a dot sequential method is described with reference to FIGS. 3A and 3B. A signal line driver circuit shown in FIG. 3A includes a pulse output circuit 301 and a switch group 302. The switch group 302 includes a plurality of stages of switches. The plurality of stages of switches correspond to each signal line. Operation of the signal line driver circuit shown in FIG. 3A is described using a detailed structure shown in FIG. 3B.

A switch of each stage in the switch group 302 has one terminal connected to a wire into which a video signal is input and the other terminal connected to a corresponding signal line.

The pulse output circuit 301 includes a plurality of stages of flip-flop circuits (FF) 314 or the like, into which a clock signal (S-CLK), a clock inverted signal (S-CLKB), and a start pulse signal (S-SP) are input. A sampling pulse is output sequentially in accordance with the timing of these signals.

The sampling pulse output from the pulse output circuit 301 is input into the switch group 302. A video signal is input into the switch group 302, and each switch in the switch group 302 is turned on in accordance with the timing that the sampling pulse is input; accordingly, the video signal is input to a signal line.

This embodiment mode is described using the case of a pixel circuit configuration having an n-channel switching TFT and a p-channel driving TFT.

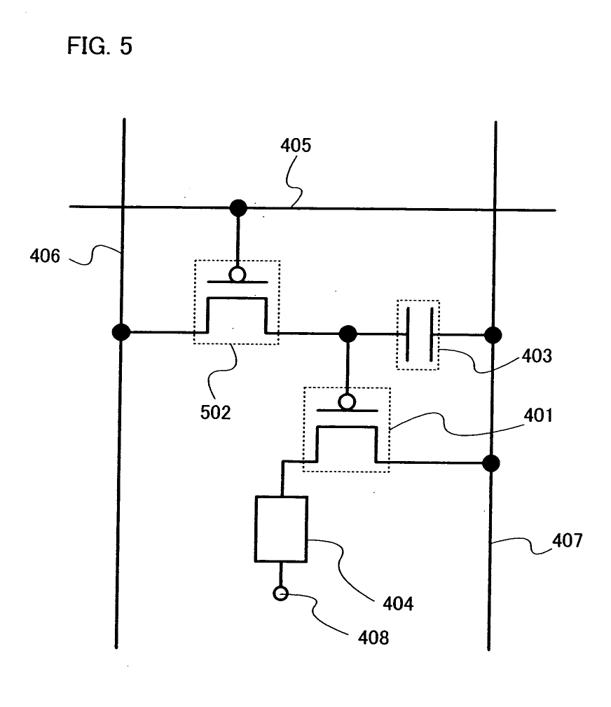

Next, the case where both the switching TFT and the driving TFT are of a p-channel type is described with reference to FIG. 5.

The same reference numerals are given to components having the same structure as that of components in FIG. 4. As a switching TFT, a p-channel switching TFT 502 is used instead of using the n-channel switching TFT 402 shown in FIG. 4. For the relation of connections, the description in FIG. 4 may be referred to.

A driving method will be described below.

A relation between the scanning line 405 and the signal line 406 is described. A signal at an L level which makes the switching TFT 502 turn on or a signal at an H level which makes the switching TFT 502 turn off is input to the scanning line 405. Meanwhile, a signal at an L level which makes the driving TFT 401 turn on or a signal at an H level which makes the driving TFT 401 turn off is input to the signal line 406.

Here, it is desirable that the signal at an L level input to the scanning line 405 has a lower potential than that of the signal at an L level input to the signal line 406. Regarding the reason for this, the relation between the signal line 406 and the scanning line 405 in FIG. 4 may be referred to. For example, assume that the signal at an L level input to the scanning line 405 and the signal at an L level input to the signal line 406 have the same potential. Then, in the case of the p-channel switching TFT 502 being an enhancement type (normally off), a potential higher than that of the signal at an L level input to the signal line 406 might be input to the gate of the driving TFT 401.

In addition, the signal at an H level input to the scanning line 405 desirably has a higher potential than that of the signal at an H level input to the signal line 406. Regarding the reason, in the same way as the above, the relation between the signal line 406 and the scanning line 405 in FIG. 4 may be referred to. For example, assume that the signal at an H level input to the scanning line 405 and the signal at an H level input to the signal line 406 have the same potential. Then, in the case of the p-channel switching TFT 502 being a depletion type (normally on), since the threshold voltage Vₜₕ is a positive value, the switching TFT 502 turns on, and a potential of the signal at an H level that is input to the signal line 406 is input to the gate of the driving TFT 401. On the other hand, when a potential of the signal input to the scanning line 405 is set too high, power consumption increases. Therefore, a potential higher than that of the signal at an H level that is input to the signal line 406 by about 1 to 3 V, for example, is preferable.

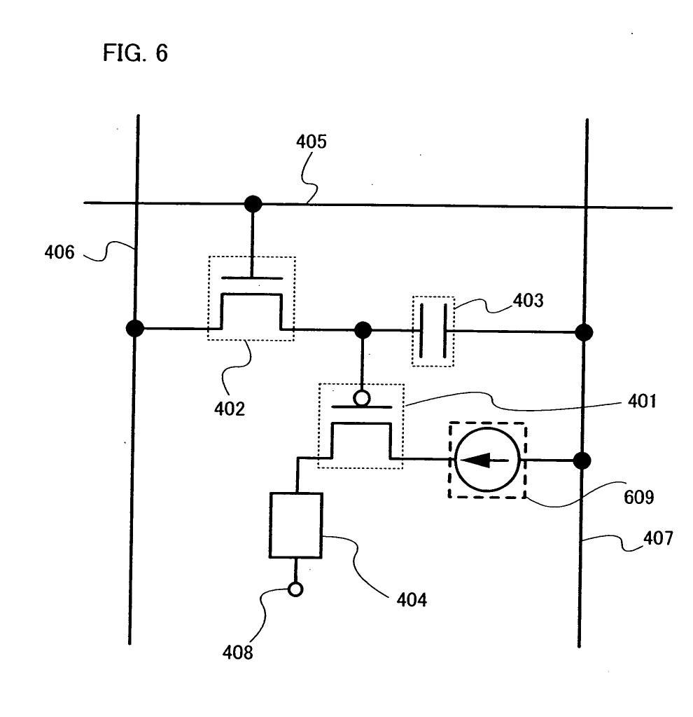

In FIGS. 4 and 5, the voltage input voltage drive method is shown. Alternatively, a pixel circuit configuration having a voltage input current drive method shown in FIG. 6 may be employed.

In the pixel circuit configuration of FIG. 6, the same reference numerals as in FIG. 4 are commonly given to components having the same structure as that of components in FIG. 4. The first terminal of the driving TFT 401 is connected to the light emitting element 404, and the second terminal of the driving TFT 401 is connected to an output terminal of a current generator 609. An input terminal of the current generator 609 is electrically connected to the power supply line 407. The second terminal of the light emitting element 404 is connected to the opposite electrode 408.

The operation of the driving TFT 401 and the current generator 609 will be described. The signal at an L level which makes the driving TFT 401 turn on is input to the gate of the driving TFT 401 from the signal line 406. Then, a certain amount of current flows into the opposite electrode 408 of the light emitting element 404 from the current generator 609, which produces light emission of the light emitting element 404.

### Embodiment Mode 2

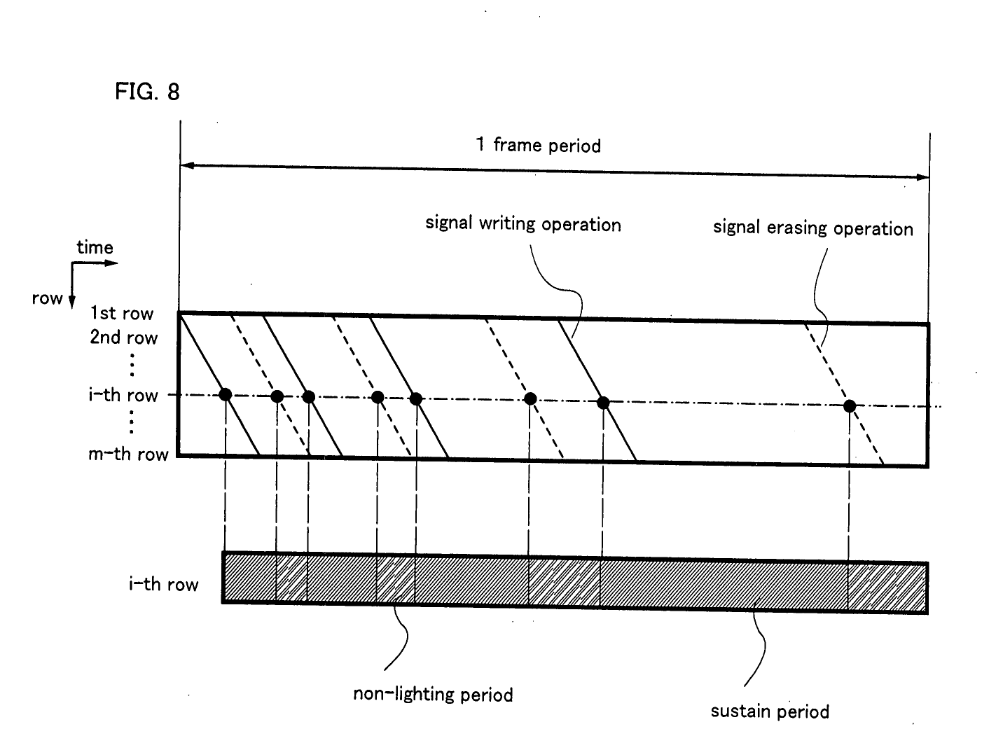

An operation method of Embodiment Mode 2 will be described with reference to a timing chart of FIG. 8 where a 4-bit gray scale is expressed. The signal writing operation is performed from a first row to an m-th row. Then, a sustain period starts in the row in which the writing operation has been terminated. The next sub-frame starts sequentially in the row in which the sustain period has been terminated, and the signal writing operation is carried out again from the first row. Here, a signal erasing operation is carried out between one signal writing operation and the next signal writing operation, so as to provide a non-lighting period. By providing the signal erasing operation as described above, a sustain period is controlled.

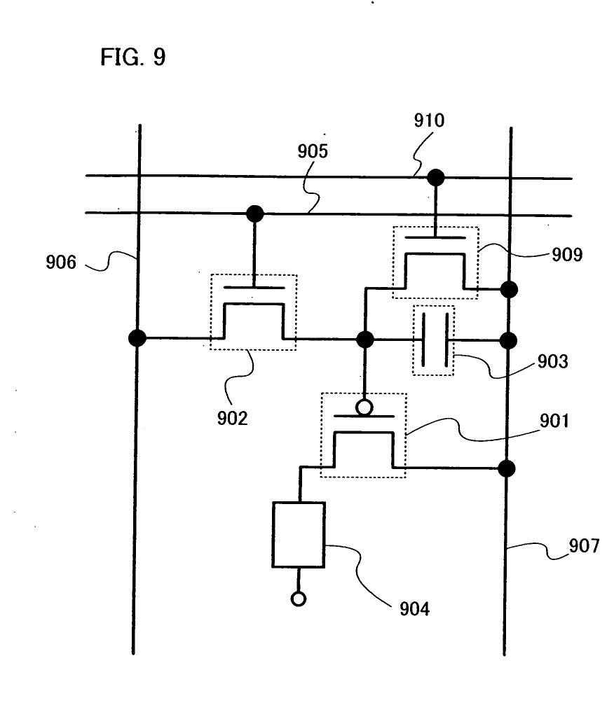

A circuit configuration of a pixel which is operated in the above-described manner is shown in FIG. 9. A driving TFT 901, a switching TFT 902, a capacitor 903, a light emitting element 904, a first scanning line 905, a signal line 906, a power supply line 907, an opposite electrode 908, an erasing TFT 909, and a second scanning line 910 are included.

A gate electrode of the switching TFT 902 is connected to the first scanning line 905. One of a source region and a drain region of the switching TFT 902 is connected to the signal line 906, and the other is connected to a gate electrode of the driving TFT 901, the capacitor 903, and a source region or drain region of the erasing TFT 909.

One side of the capacitor 903 is connected to the power supply line 907, and the other side is connected to the source region or the drain region of the switching TFT 902, the gate electrode of the driving TFT 901, and the source region or the drain region of the erasing TFT 909. The capacitor 903 is provided so as to hold a gate potential of the driving TFT 901 when the switching TFT 902 is in a non-selected state (off state).

One of electrodes connected to a source region or a drain region of the driving TFT 901 is connected to the power supply line 907, and the other electrode is connected to the light emitting element 904.

The light emitting element 904 includes an anode, a cathode, and an organic compound layer provided between the anode and the cathode. In the light emitting element 904, an electrode connected to the source region or the drain region of the driving TFT 901 is called a pixel electrode, and the other electrode of the light emitting element 904 is called an opposite electrode. The anode and the cathode of the light emitting element 904 are determined by potentials of the opposite electrode and the power supply line 907. The electrode having a higher potential serves as an anode, and the electrode having a lower potential serves as a cathode.

Of the source region and the drain region of the erasing TFT 909, one which is not connected to the gate electrode of the driving TFT 901 is connected to the power supply line 907. A gate electrode of the erasing TFT 909 is connected to the second scanning line for erasing 910.

Subsequently, the operation of the circuit of FIG. 9 is described. At first, the first scanning line 905 is selected to turn on the switching TFT 902, and a signal is input to the capacitor 903 from the signal line 906. Then, a current of the driving TFT 901 is controlled in response to the signal, and a current flows into the opposite electrode of the light emitting element 904, from the power supply line 907 through the light emitting element 904.

When the signal is to be erased, the second scanning line 910 is selected to turn on the erasing TFT 909, and a potential of the power supply line 907 is input to the gate of the driving TFT 901. As a result, the driving TFT 901 is turned off. Then, a current does not flow to the light emitting element 904. Accordingly, a non-lighting period can be provided and the length of a sustain period can be freely controlled.

In FIG. 9, each of the switching TFT 902 and the erasing TFT 909 is an n-channel TFT, and the driving TFT 901 is a p-channel TFT; however, the present invention is not limited to this structure. Each of them may be either an n-channel type or a p-channel type, and any combination may be used. However, in the case where the source region or the drain region of the driving TFT 901 is connected to the anode of the light emitting element 904, the driving TFT 901 is desirably a p-channel TFT. In addition, in the case where the source region or the drain region of the driving TFT 901 is connected to the cathode of the light emitting element 904, the driving TFT 901 is desirably an n-channel TFT.

Further, the switching TFT 902, the driving TFT 901, and the erasing TFT 909 may employ a multi-gate structure such as a dual gate structure or a triple gate structure as well as a single gate structure.

As long as the capacitor 903 is provided to be able to hold a gate potential of the driving TFT 901, the layout is not limited to the layout shown in FIG. 9. Note that in the case where the gate potential of the driving TFT 901 can be held using gate capacitance of the driving TFT 901 or the like, the capacitor 903 may be omitted.

In the above-described manner, a signal is written in each row, and the signal of a pixel is erased before the next signal writing operation is started. In this way, the length of the sustain period is controlled.

In the case where an average luminance of an entire screen is high, the timing of all erasing operations is set ahead; in other words, the erasing operations are performed in periods which do not overlap with writing periods. Accordingly, sustain periods in each sub-frame are shortened, which reduces the average luminance of the entire screen. As a result, power consumption can be reduced with few changes in brightness of screen display. Meanwhile, in the case of a low average luminance, a duty ratio can be increased by setting back the timing of all erasing operations, which increases the average luminance of the entire screen. Accordingly, sharp screen display with high contrast becomes possible.

### Embodiment Mode 3

In Embodiment Mode 3, the case where a signal erasing operation of a pixel is performed with a pixel configuration different from that in Embodiment Mode 2 will be described.

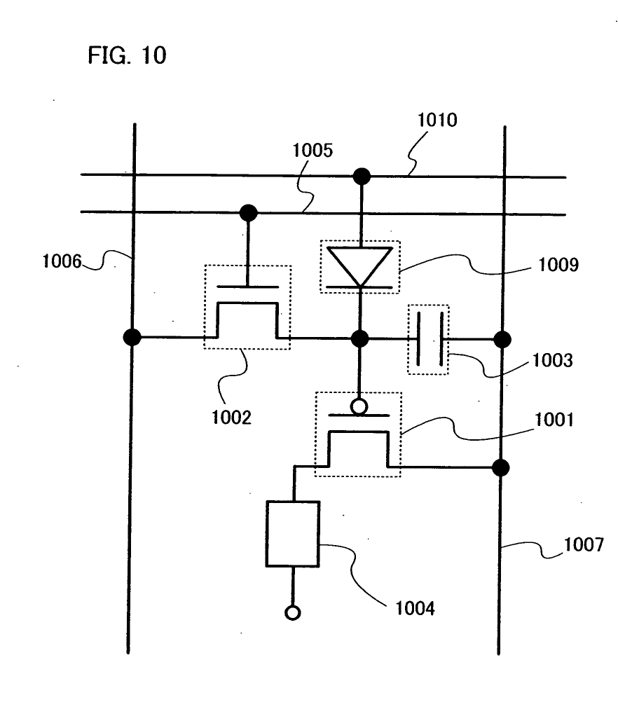

FIG. 10 shows one example of a pixel configuration in the case the driving TFT is forcibly turned off. A switching TFT 1002, a driving TFT 1001, an erasing diode 1009, and a light emitting element 1004 are provided. One of a source region and a drain region of the switching TFT 1002 is connected to a signal line 1006, and the other is connected to a gate electrode of the driving TFT 1001, the capacitor 1003, and the erasing diode 1009. A gate electrode of the switching TFT 1002 is connected to a first scanning line 1005. One of a source region and a drain region of the driving TFT 1001 is connected to a power supply line 1007, and the other is connected to the light emitting element 1004. An input terminal of the erasing diode 1009 is connected to a second scanning line 1010, and an output terminal of the erasing diode 1009 is connected to the gate electrode of the driving TFT 1001, the capacitor 1003, and the source region or the drain region of the switching TFT 1002.

One of electrodes, which face to each other, of the capacitor 1003 is connected to the power supply line 1007, and the other electrode is connected to the source region or the drain region of the switching TFT 1002, the gate electrode of the driving TFT 1001, and the output terminal of the erasing diode 1009. The capacitor 1003 serves to hold a gate potential of the driving TFT 1001. The capacitor 1003 is provided between the gate electrode of the driving TFT 1001 and the power supply line 1007 here; however, the present invention is not limited to this. The capacitor 1003 may be provided anywhere as long as the capacitor 1003 can hold the gate potential of the driving TFT 1001. In the case where the gate potential of the driving TFT 1001 can be held by using gate capacitance of the driving TFT 1001 or the like, the capacitor 1003 may be omitted.

One of electrodes connected to the source region or the drain region of the driving TFT 1001 is connected to the power supply line 1007, and the other electrode is connected to the light emitting element 1004.

As an operation method, the first scanning line 1005 is selected to turn on the switching TFT 1002, and a signal is input to the capacitor 1003 from the signal line 1006. Then, the driving TFT 1001 is controlled to turn on or off in response to the signal, and a current flows into the light emitting element 1004 from the power supply line 1007.

When the signal is to be erased, the second scanning line 1010 is selected (here, applied with a high potential). Then, the erasing diode 1009 is turned on so that a current flows into the gate of the driving TFT 1001 from the second scanning line 1010. As a result, the driving TFT 1001 is turned off. Then, a current does not flow to the light emitting element 1004 from the power supply line 1007. Accordingly, a non-lighting period can be provided and the length of a lighting period can be freely controlled.

At this time, if a potential of the second scanning line 1010 is set sufficiently high, even in the case of a depletion type as well as an enhancement type, the driving TFT 1001 can be normally turned off. For example, the potential of the second scanning line 1010 is preferably set higher than a potential of a video signal at an H level which makes the driving TFT 1001 turn off, by the threshold potential of the erasing diode 1009.

When the signal is to be held, the second scanning line 1010 is not selected (here, provided with a potential equal to or lower than that of a signal L of the video signal). Accordingly, the erasing diode 1009 is turned off, and the gate potential of the driving TFT 1001 is held.

Note that the erasing diode 1009 may be any element having a rectifying property, and may be a PN junction diode, a PIN junction diode, a Schottky barrier diode, or a Zener diode.

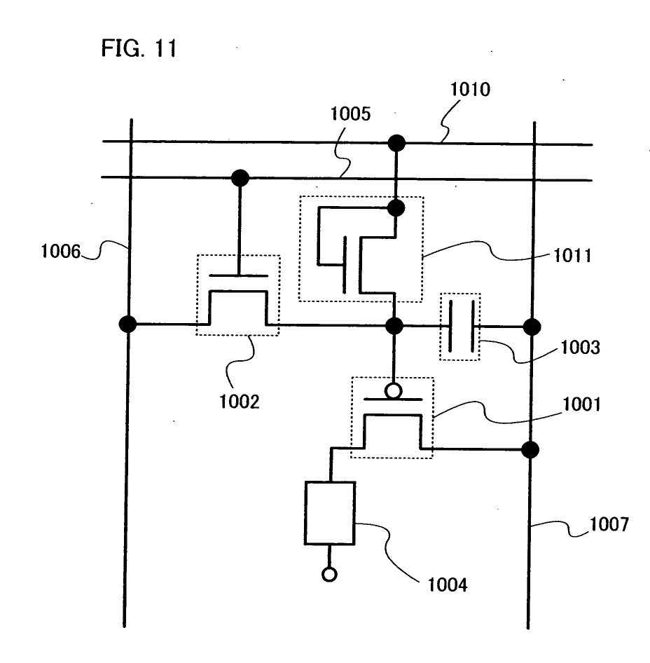

In addition, as a diode, a diode connection (connection of a gate and a drain) using a TFT may also be employed. A circuit diagram in that case is shown in FIG. 11. As an erasing diode 1011, a TFT with a diode connection is used. Here, an n-channel TFT is used; however, the invention is not limited to this. A p-channel TFT may also be used.

In this manner, in the case of providing a non-lighting period, a current is not supplied to the light emitting element so that a non-lighting state is forcibly made. Accordingly, a switch may be disposed somewhere in a current path from the power supply line 1007 to the light emitting element 1004, so that a non-lighting period is made by controlling on and off of the switch. Alternatively, a gate-source voltage of the driving TFT 1001 may be controlled so that the driving TFT 1001 is forcibly turned off.

Note that the appearing order of sub-frames may be changed depending on time. For example, the arranging order of sub-frames may be changed between the first frame and the second frame. Further, the appearing order of sub-frames may be changed depending on place. For example, the arranging order of sub-frames may be changed between a pixel A and a pixel B. Further, combining the above, the appearing order of sub-frames may be changed depending on both time and place. In addition, the appearing order of sub-frames may be either in order or in random order.

Although a sustain period, an address period, and a non-lighting period are provided in one frame period in this embodiment mode, the invention is not limited to this. Another operation period may also be provided. For example, a period in which a voltage having a reverse polarity to the normal polarity is applied to a light emitting element, namely is a reverse bias period may be provided. By providing a reverse bias period, reliability of a display element may be improved.

In the above-described manner, a signal is written in each row, and the signal of a pixel is erased before the next signal writing operation is started. In this way, the length of the sustain period is controlled.

In the case where an average luminance of an entire screen is high, the timing of all erasing operations is set ahead. Accordingly, sustain periods in respective sub-frames are shortened, which reduces the average luminance of the entire screen. As a result, power consumption can be reduced with few changes in brightness of screen display. Meanwhile, in the case of a low average luminance, a duty ratio is increased by setting back the timing of all erasing operations, which increases the average luminance of the entire screen. Accordingly, sharp screen display with high contrast becomes possible.

### Embodiment Mode 4

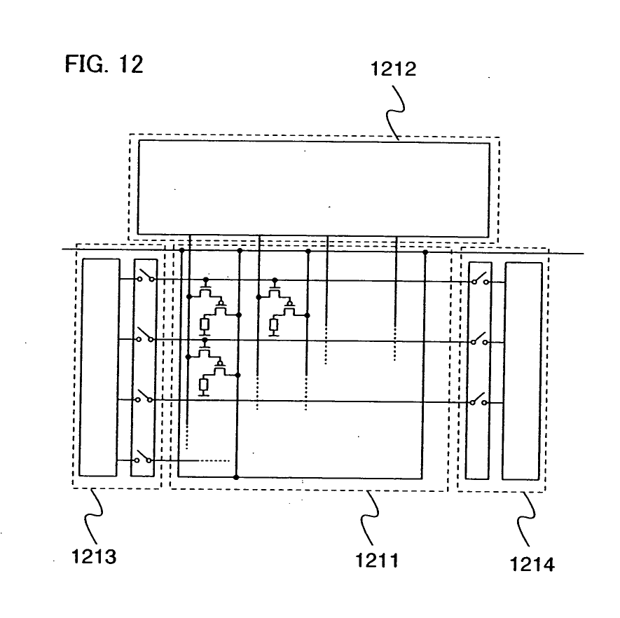

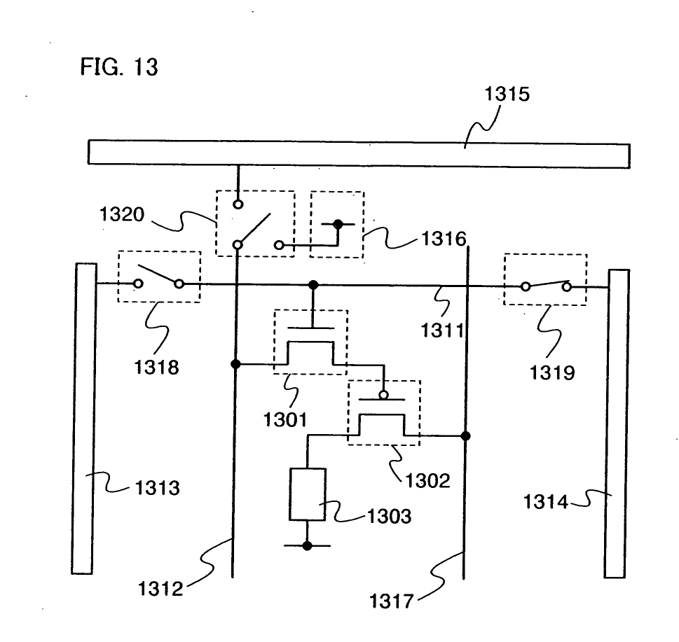

In Embodiment Mode 4, the case where a signal erasing operation of a pixel is performed with a pixel configuration different from those in Embodiment Mode 2 and 3 will be described with reference to FIG. 12 and FIG. 13.

FIG. 12 is a top view of the pixel configuration. A pixel portion 1211, a signal line driver circuit 1212, a scanning line driver circuit for writing 1213, and a scanning line driver circuit for erasing 1214 are provided. In the pixel portion 1211, a plurality of signal lines and power supply lines are arranged in columns. In addition, a plurality of scanning lines are arranged in rows in the pixel portion 1211. In the pixel portion 1211, a plurality of circuits each including a light emitting element is arranged.

FIG. 13 is a diagram showing a configuration of one pixel. The circuit shown in FIG. 13 includes a first transistor 1301, a second transistor 1302, and a light emitting element 1303.

Each of the first transistor 1301 and the second transistor 1302 is a three-terminal element including a gate electrode, a drain region, and a source region. A channel region is interposed between the drain region and the source region. Since a region serving as the source region and a region serving as the drain region are changed depending on a structure of a transistor, an operational condition, and the like, it is difficult to determine which region is the source region or the drain region. Therefore, regions serving as the source or the drain are denoted as a first electrode of a transistor and a second electrode of the transistor, respectively in this embodiment mode.

A scanning line 1311 and a scanning line driver circuit for writing 1313 are provided to be electrically connected or disconnected to each other by a switch 1318. The scanning line 1311 and a scanning line driver circuit for erasing 1314 are provided to be electrically connected or disconnected to each other by a switch 1319. A signal line 1312 is provided to be electrically connected to either a signal line driver circuit 1315 or a power source 1316 by a switch 1320. A gate of the first transistor 1301 is electrically connected to the scanning line 1311. The first electrode of the first transistor 1301 is electrically connected to the signal line 1312 while the second electrode of the first transistor 1301 is electrically connected to a gate electrode of the second transistor 1302. The first electrode of the second transistor 1302 is electrically connected to a power supply line 1317 while the second electrode of the second transistor 1302 is electrically connected to one electrode included in the light emitting element 1303. Further, the switch 1318 may be included in the scanning line driver circuit for writing 1313. The switch 1319 may also be included in the scanning line driver circuit for erasing 1314. In addition, the switch 1320 may be included in the signal line driver circuit 1315. A capacitor may be provided between the gate of the second transistor 1302 and the power supply line 1317.

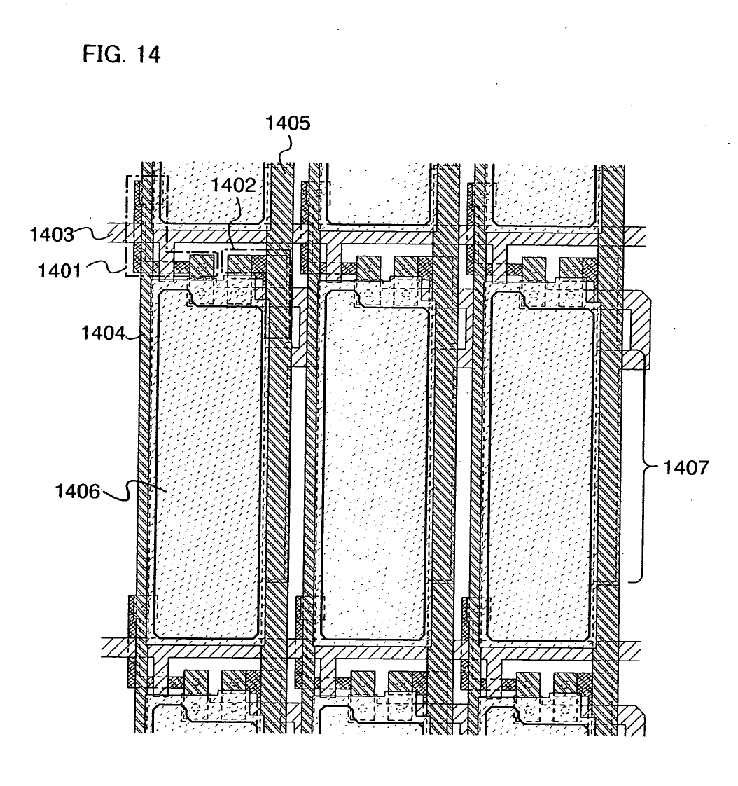

The arrangement of transistors, light emitting elements, and the like in the pixel is not particularly limited. For example, the arrangement as shown in a top view of FIG. 14 can be employed. In FIG. 14, a first electrode of a first transistor 1401 is connected to a signal line 1404 while a second electrode of the first transistor 1401 is connected to a gate electrode of a second transistor 1402. A first electrode of the second transistor 1402 is connected to a power supply line 1405 while a second electrode of the second transistor 1402 is connected to an electrode 1406 of a light emitting element. A part of a scanning line 1403 functions as a gate electrode of the first transistor 1401. A region 1407 where a gate wire of the second transistor 1402 overlaps with the power supply line 1405 functions as a capacitor.

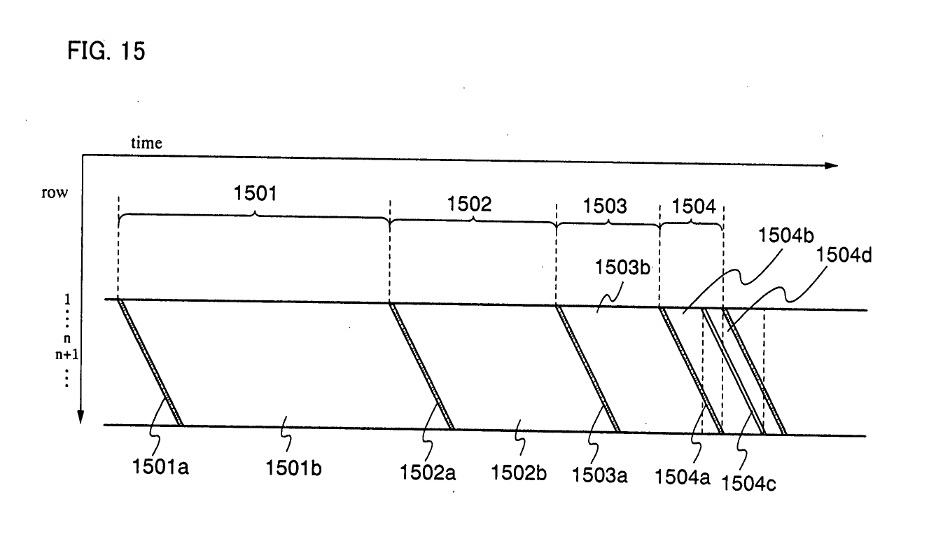

Next, a driving method is described. FIG. 15 shows the operation of one frame period in accordance with time passage. In FIG. 15, the horizontal direction indicates time passage, while the vertical direction indicates the number of scanning stages of a scanning line.

One frame period is, as shown in FIG. 15, divided into four sub-frames 1501, 1502, 1503, and 1504 including address periods 1501a, 1502a, 1503a, and 1504a and sustain periods 1501b, 1502b, 1503b, and 1504b, respectively. The light emitting element to which a signal for light emission is applied is in a light emitting state during the sustain periods. The length ratio of the sustain periods of the first sub-frame 1501: the second sub-frame 1502: the third sub-frame 1503: the fourth sub-frame 1504 satisfies 2³:2²:2¹:2⁰=8:4:2:1. This allows the light emitting element to display a 4-bit gray scale. The number of bits and the gray scale level are not limited to those described in this embodiment mode. For example, one frame period may include 16 sub-frames so as to express a 16-bit gray scale.

The operation of one frame period may be referred to the description of FIG. 7 in Embodiment Mode 1.

When a sustain period is intended to be forcibly terminated in the row in which he writing operation has already been terminated and the sustain period has started, prior to terminating the writing operation up to the last row as in the sub-frame 1504, an erasing period 1504c is preferably provided after the sustain period 1504b so as to stop light emission forcibly. The row where light emission is forcibly stopped does not emit light for a certain period (this period is referred to as a non-light emitting period 1504d). Right after terminating the address period in the last row, an address period of a next sub-frame (or a next frame) starts sequentially from the first row. This can prevent the address period in the sub-frame 1504 from overlapping with the address period in the next sub-frame.

Although the sub-frames 1501 to 1504 are arranged in order from the longest to the shortest length of the sustain period in this embodiment mode, they do not necessarily have to be arranged in this order. For example, the sub-frames may be arranged in order from the shortest length of the sustain period to the longest. Alternatively, the sub-frames may be arranged in random order regardless of the length of the sustain period. In addition, these sub-frames may further be divided into a plurality of sub-frames. In other words, scanning of scanning lines may be performed a plurality of times during a period of supplying the same video signal.

Here, the operations in the address period and the erasing period of the circuit shown in FIG. 13 will be described.

First, the operation in the address period is described. In the writing period, the scanning line 1311 in the n-th row (n is a natural number) is electrically connected to the scanning line driver circuit for writing 1313 via the switch 1318, and is not connected to the scanning line driver circuit for erasing 1314. The signal line 1312 is electrically connected to the signal line driver circuit 1315 via the switch 1320. In this case, a selecting signal is input to the gate of the first transistor 1301 connected to the scanning line 1311 in the n-th row (n is a natural number), thereby turning the first transistor 1301 on. At this time, video signals are simultaneously input to the signal lines in the first to the last columns. Further, the video signals input from each signal line 1312 are independent in columns from one another. The video signal input from the signal line 1312 is input to the gate electrode of the second transistor 1302 via the first transistor 1301 connected to each signal line. At this time, it is determined whether the light emitting element 1303 emits light or not depending on the signal that is input to the second transistor 1302. For instance, when the second transistor 1302 is a p-channel type, the light emitting element 1303 emits light by inputting a low level signal to the gate electrode of the second transistor 1302. On the other hand, when the second transistor 1302 is an n-channel type, the light emitting element 1303 emits light by inputting a high level signal to the gate electrode of the second transistor 1302.

Next, the operation in the erasing period will be described. In the erasing period, the scanning line 1311 in the n-th row (n is a natural number) is electrically connected to the scanning line driver circuit for erasing 1314 via the switch 1319, and is not connected to the scanning line driver circuit for writing 1313. The signal line 1312 is electrically connected to the power source 1316 via the switch 1320. In this case, by inputting a selecting signal to the gate of the first transistor 1301 connected to the scanning line 1311 in the n-th row, the first transistor 1301 is turned on. At this time, erasing signals are simultaneously input to the signal lines in the first to the last columns. The erasing signal input from the signal line 1312 is input to the gate electrode of the second transistor 1302 via the first transistor 1301 connected to the signal line. At this time, the supply of a current flowing from the power supply line 1317 to the light emitting element 1303 is stopped by the signal input to the second transistor 1302. This forcibly makes the light emitting element 1303 emit no light. For example, when the second transistor 1302 is a p-channel type, the light emitting element 1303 emits no light by inputting a high level signal to the gate electrode of the second transistor 1302. On the other hand, when the second transistor 1302 is an n-channel type, the light emitting element 1303 emits no light by inputting a low level signal to the gate electrode of the second transistor 1302.

Further, in the erasing period, a signal for erasing is input to the n-th row (n is a natural number) by the above-mentioned operation. However, as mentioned above, the n-th row sometimes remains in the erasing period while another row (referred to as an m-th row (m is a natural number)) is in the writing period. In this case, since a signal for erasing is necessary to be input to the n-th row and a signal for writing is necessary to be input to the m-th row by utilizing the signal line in the same column, the operation mentioned below is preferably carried out.

Right after the light emitting element 1303 in the n-th row stops emitting light by the above-described operation in the erasing period, the scanning line 1311 and the scanning line driver circuit for erasing 1314 are disconnected from each other, while the signal line 1312 is connected to the signal line driver circuit 1315 by switching the switch 1320. As well as the signal line 1312 and the signal line driver circuit 1315 are connected to each other, the scanning line 1311 and the scanning line driver circuit for writing 1313 are connected to each other. Then, a selecting signal is input to the scanning line in the m-th row from the scanning line driver circuit for writing 1313, and the first transistor 1301 is turned on. Meanwhile, video signals are input to the signal lines 1312 in the first to the last columns from the signal line driver circuit 1315. The light emitting element in the m-th row emits light or no light depending on the video signal.

After terminating the address period in the m-th row as mentioned above, the erasing period immediately starts in the (n+1)-th row. Therefore, the scanning line 1311 and the scanning line driver circuit for writing 1313 are disconnected from each other, and the signal line 1312 is connected to the power source 1316 by switching the switch 1320. In addition, the scanning line 1311 and the scanning line driver circuit for writing 1313 are disconnected from each other, while the scanning line 1311 is connected to the scanning line driver circuit for erasing 1314. Then, a selecting signal is input to the scanning line in the (n+1)-th row from the scanning line driver circuit for erasing 1314 to turn on the first transistor 1301, while an erasing signal is input from the power source 1316. After terminating the erasing period of the (n+1)-th row in this manner, the address period immediately starts in the (m+1)-th row. Similarly, an erasing period and an address period are repeated alternately up to the erasing period of the last row.

Although the address period of the m-th row is provided between the erasing period of the n-th row and the erasing period of the (n+1)-th row in this embodiment mode, the present invention is not limited thereto. The address period of the m-th row may be provided between the erasing period of the (n−1)-th row and the erasing period of the n-th row.

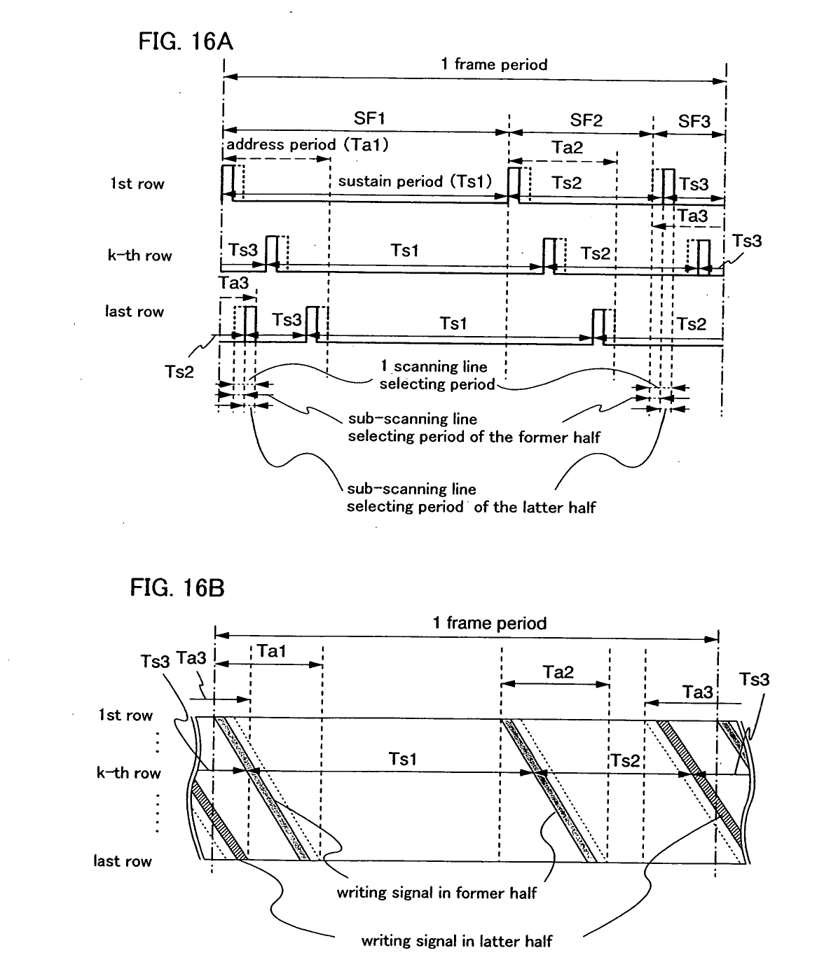

Next, the timing of the address period and the erasing period will be described with reference to timing charts of FIGS. 16A and 16B. Here, for simplicity, the case of expressing a 3-bit gray scale (8 gray scales) will be described.

As shown in FIGS. 16A and 16B, one frame period is divided into three subframe periods SF1 to SF3. The length of the subframe periods SF1 to SF3 is determined by the power of 2. Namely, in this case, SF1:SF2:SF3=4:2:1 (2²:2¹:2⁰ ) is set.

First, a signal is input to pixels row by row in a first subframe period. In this case, however, a scanning line is actually selected only in a sub-scanning line selecting period of the first half. In a sub-scanning line selecting period of the latter half, no scanning line is selected, and no signal is input to a pixel. This operation is repeatedly performed from the first row to the last row. Here, an address period is a period from the selection of the scanning line at the first row to the selection of the scanning line at the last row. Accordingly, the length of the address period is the same in any subframe period.

Subsequently, a second subframe period is started. A signal is similarly input to pixels row by row. In this case also, it is performed only in the sub-scanning line selecting period of the first half This operation is repeatedly performed from the first row to the last row.

At this time, a constant voltage is applied to a cathode wire of each pixel. Accordingly, a sustain period of a pixel in a certain subframe period is defined as a period from the writing of a signal into the pixel in a certain subframe period to the start of writing of the signal to the pixel in the next subframe period. Accordingly, the timing of the sustain period is different among rows, but the length of the sustain period is equal among the rows.

Subsequently, a third subframe period will be explained. Considered first is the case where, similar to the first and second subframe periods, the scanning line is selected in the sub-scanning line selecting period of the first half and a signal is written into a pixel. In this case, when a signal begins to be written into a pixel near the last row, a writing period of the signal into the pixel at the first row in the next frame period, i.e., the address period is already started. As a result, writing of the signal into the pixel near the last row in the third subframe period is overlapped with writing of the signal to a certain pixel in the first subframe period of the next frame period. It is impossible to concurrently write different signals of two rows normally into pixels of two different rows. Therefore, in the third subframe period, the scanning line is selected in the sub-scanning line selecting period of the latter half Accordingly, in the first subframe period (this subframe period belongs to the next frame period), the scanning line is selected in the sub-scanning line selecting period of the first half so that concurrent writing of signals into pixels of two different rows can be avoided.

As described above, when an address period in a certain subframe period is overlapped with an address period in another subframe period, an address period is allocated by utilizing a plurality of sub-scanning line selecting periods. Thus, it is possible to prevent timings of selecting the scanning lines from being actually overlapped, and a signal can be normally written into a pixel. As a result, at the same moment when a certain row is in an address period, lighting of an EL element can be conducted in another row, regardless of the number of bits of gray scale. Accordingly, the length of a sustain period can be freely controlled.

In the case where an average luminance of an entire screen is high, the timing of all erasing operations is set ahead. Accordingly, sustain periods in respective sub-frames are shortened, which reduces the average luminance of the entire screen. As a result, power consumption can be reduced with few changes in brightness of screen display. In addition, in the case of a low average luminance, a duty ratio can be increased by setting back the timing of all erasing operations, which increases the average luminance of the entire screen. Accordingly, sharp screen display with high contrast becomes possible.

### Embodiment Mode 5

Next, a method of controlling a sustain period in one frame period of an EL display device by changing an angle of a triangular wave will be described.

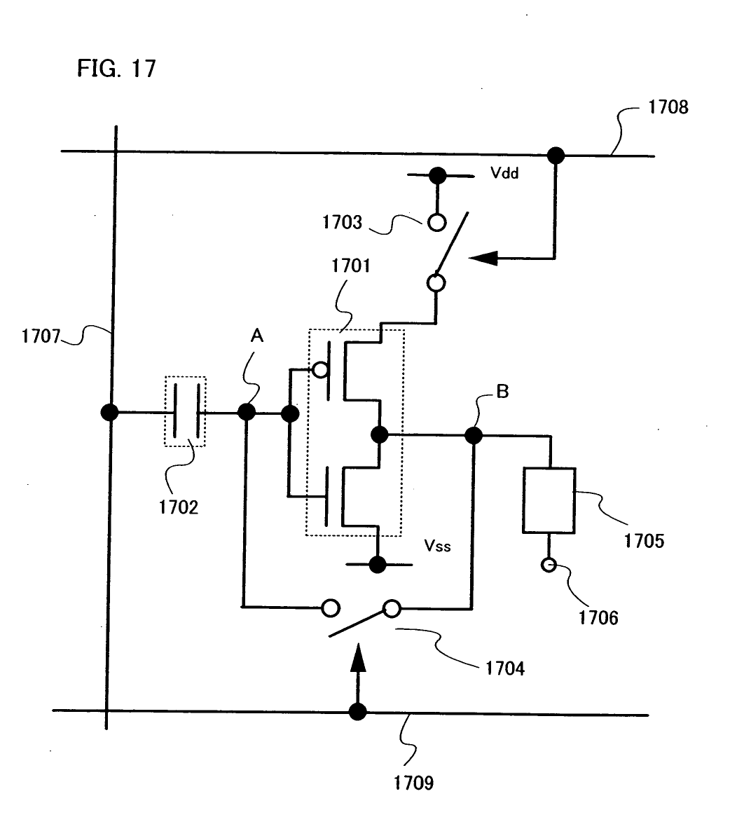

First, a pixel configuration of the display device of the present invention is described with reference to FIG. 17. The pixel includes an inverter 1701, a capacitor 1702, a first switch 1703, a second switch 1704, a light emitting element 1705, a signal line 1707, a first scanning line 1708, and a second scanning line 1709. The inverter 1701 is a CMOS inverter including two transistors of an n-type transistor and a p-type transistor.

One electrode of the capacitor 1702 is connected to the signal line 1707, and the other electrode is connected to one terminal of the second switch 1704 and gate electrodes of the n-type and the p-type transistors included in the inverter 1701. The light emitting element 1705 is connected to the other terminal of the second switch 1704 and a source region or a drain region of each of the n-type transistor and the p-type transistor. The first switch 1703 is provided between a high potential side power source Vdd and the source region or the drain region of the p-type transistor included in the inverter 1701. The first switch 1703 is controlled by the first scanning line 1708, and the second switch 1704 is controlled by the second scanning line 1709. A low potential side power source Vss is connected to the source region or the drain region of the n-type transistor included in the inverter 1701. The high potential side power source Vdd is set higher than the low potential side power source Vss.

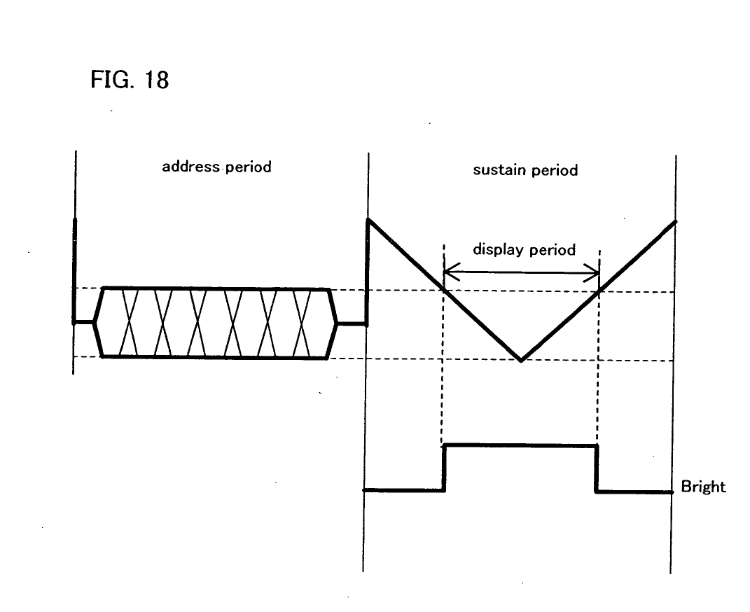

In FIG. 18, a timing chart of the pixel of FIG. 17 is described. In an address period, the first switch 1703 and the second switch 1704 shown in FIG. 17 are in an on state when a row including the pixel is selected. Then, an analog video signal Vs is input from the signal line 1707. Since the second switch 1704 is on, an input side and an output side of the inverter 1701 are connected. At this time, the potential of a point A is Vk. Accordingly, a charge for the voltage (Vk−Vs) is stored in the capacitor 1702. Here, Vk denotes a potential when input and output potentials of the inverter 1701 (referred to as a “logic threshold potential”) are equal. When another row is selected, the first switch 1703 and the second switch 1704 are off so that a current does not flow to the light emitting element 1705.

In a sustain period, the first switch 1703 is on and the second switch 1704 is off. Then, a triangular wave potential is input from the signal line 1707. At this time, since the capacitor 1702 holds a potential difference between an analog video signal and a logic threshold potential, on and off of the light emitting element 1705 are controlled by the triangular wave. For example, when the potential at the point A is higher than Vk, a potential Vss is input to the output side of the inverter 1701. At this time, the light emitting element 1705 emits no light. On the contrary, when the potential at the point A is lower than Vk, a potential Vdd is input to the output side of the inverter 1701. At this time, the light emitting element 1705 emits light.

In this manner, display period can be controlled by a potential difference between the video signal input to the signal line 1707 in the address period and the triangular wave input to the signal line 1707 in the sustain period. An opposite potential 1706 of the light emitting element 1705 which is opposite to the side connected to the inverter 1701 is preferably set to have a potential substantially equal to or higher than the logic threshold potential in the address period, so that a current does not flow to the light emitting element 1705.

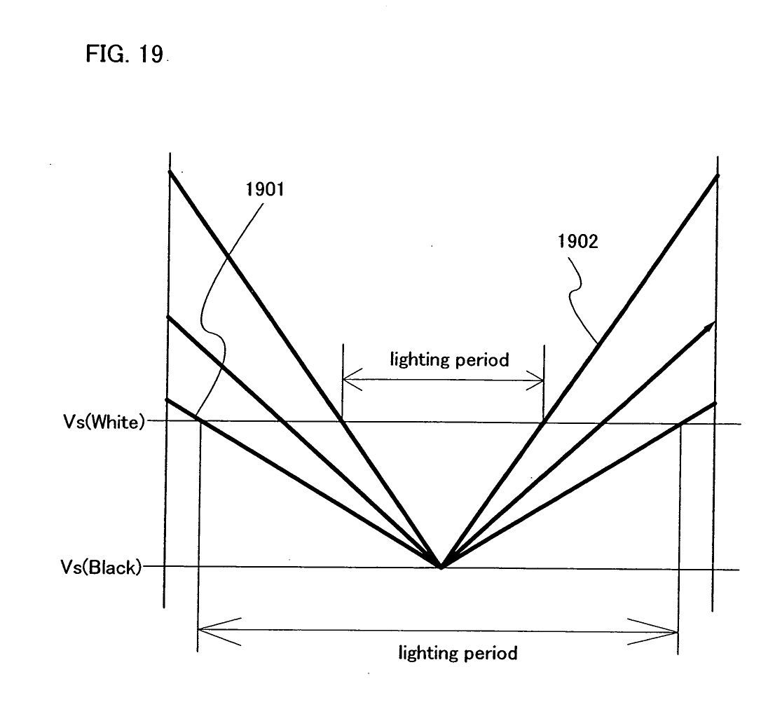

FIG. 19 shows waveforms of a triangular wave potential which is input to the pixel circuit in a sustain period. Here, a triangular wave potential means a potential having a waveform in which a potential linearly decreases from high potential to low potential and linearly increases from low potential to high potential. It is obvious that a triangular wave potential which linearly increases from low potential to high potential and decreases from high potential to low potential may be set. When an average luminance of an entire screen is low and only a part of the screen is displayed brightly, the angle of a triangular wave is increased so as to lengthen a lighting period of white display as a triangular wave 1901. On the other hand, when the average luminance of the entire screen is high, the angle of the triangular wave is reduced so as to shorten the lighting period of white display as a triangular wave 1902. In this way, the intensity of the maximum luminance is controlled by changing the angle of the triangular wave, and sharp image display with high contrast can be performed. In addition, when the average luminance is high, a display luminance corresponding to an input video signal can be reduced. Accordingly, a long-lived organic EL element can be realized with maintained visual quality.

In an organic EL element, since the material characteristic and the deteriorating condition varies depending on each color, even when the same amount of voltage is applied to a light emitting element, the luminance which can be obtained from the light emitting element varies in some cases, depending on each color. Therefore, in a display device including pixels having different color elements, different potentials may be applied to the pixels depending on each color. Further, the slope or the waveform of the triangular wave may be changed.

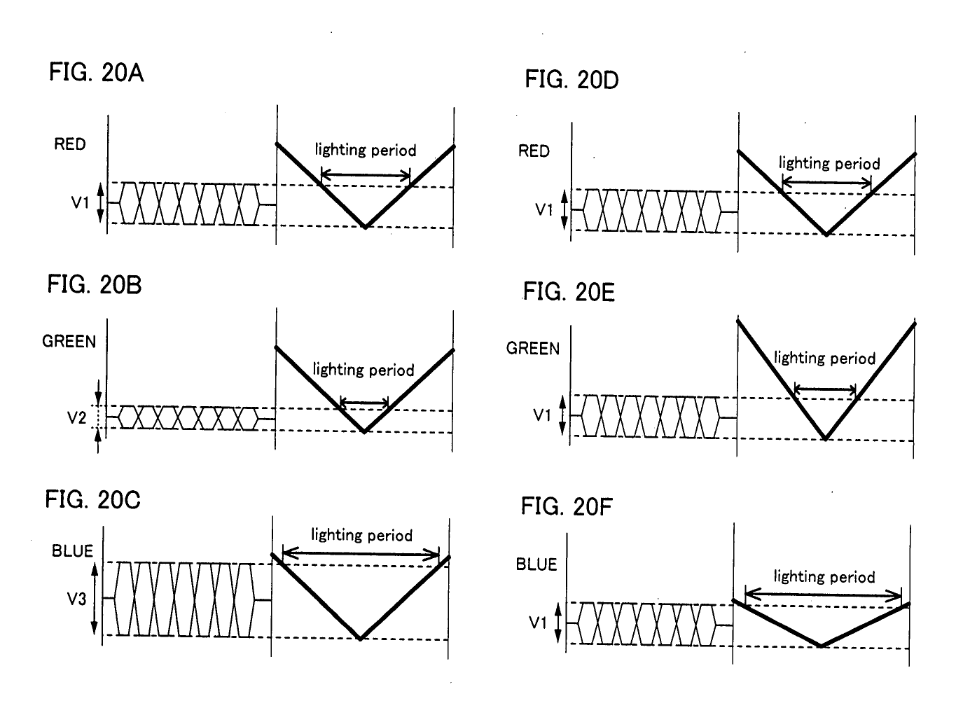

For example, the case where the potential width of a video signal is changed for each color element of R (Red), G (Green), and B (Blue) is shown in FIGS. 20A to 20C. When a pixel for a color element R is regarded as a reference and the luminance obtained from the light emitting element of a pixel for a color element G is high, the potential corresponding to a gray scale level of a video signal for G is decreased. When the luminance obtained from the light emitting element of a pixel for a color element B is low, the potential corresponding to a gray scale level of a video signal for B is increased. In this manner, lighting time can be changed for a pixel for each color element when the same gray scale is expressed.

Next, the case where the angle of a triangular wave is changed depending on each color element of RGB is shown in FIGS. 20D to 20F. When a luminance obtained from a light emitting element in a pixel for a color element R is regarded as a reference and the luminance obtained from the light emitting element of a pixel for a color element G is high, a triangular wave potential input to the signal line of G is set steeper than a triangular wave potential input to the signal line of R. In other words, the amplitude of the triangular wave potential is increased. When the luminance obtained from the light emitting element of a pixel for a color element B is low, a triangular wave potential input to the signal line of G is set less steeper than a triangular wave potential input to the signal line of R. In other words, the amplitude of the triangular wave potential is decreased. In this manner, lighting time can be changed for a pixel for each color element when the same gray scale is displayed. Other than the combination of three colors of RGB, emerald green may be added so that the angle of the triangular wave may be changed depending on each color element of four colors. Instead of using emerald green, vermilion may be added. In addition, a pixel including an EL element which emits white light may be combined. By increasing the number of color elements in this manner, image quality and color reproductivity can also be improved. A fourth color element which is added to the three colors of RGB is not limited to the above-described color, and other complementary colors may be obviously used.

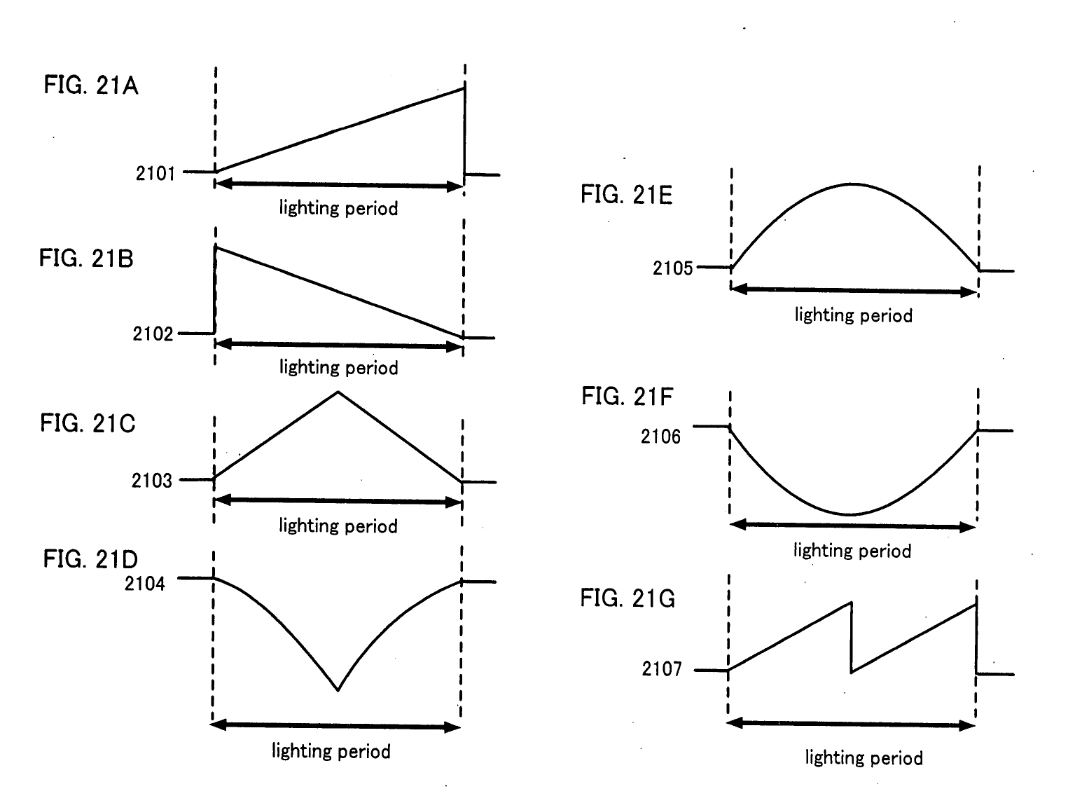

This embodiment mode is described with the waveform of a triangular wave voltage; however, the invention is not limited to this waveform. For example, as a waveform 2101 shown in FIG. 21A, a potential which linearly increases may be set.

In addition, a potential which changes from high potential to low potential in an analog manner may be set. For example, a potential which linearly decreases as a waveform 2102 may be set (FIG. 21B).

A triangular wave potential which linearly increases from low potential to high potential and decreases from high potential to low potential like a waveform 2103 may be set (FIG. 21C).

The waveform does not necessarily change linearly. Like a waveform 2104, a potential which curvilinearly decreases from high potential to low potential and curvilinearly increases from low potential to high potential may be set (FIG. 21D). Like a waveform 2105, a potential having a waveform corresponding to one cycle of an output waveform of a full-wave rectifying circuit may be set (FIG. 21E). A waveform 2106 which is made by reversing the top and the bottom of the waveform 2105 may be set (FIG. 21F).

By setting such a waveform, light emitting time with respect to a video signal can be freely set. Accordingly, gamma correction or the like can be applied. Gamma correction herein refers to such a correction that the lighting period is increased nonlinearly in accordance with increase of the gray scale level. When a luminance increases linearly, it is difficult for human eyes to proportionally perceive that the brightness has become higher. It is even more difficult for human eyes to perceive the difference in brightness as the luminance becomes higher. Therefore, in order that the human eyes can perceive the difference in brightness, a lighting period is required to be lengthened in accordance with the increase of the gray scale level, that is, gamma correction is required to be performed.

In addition, in a lighting period of a pixel, a plurality of pulses of the above-described waveforms 2101 to 2106 may be set successively. For example, as shown by a waveform 2107, the pulse of the waveform 2101 may be successively set twice in a lighting period of a pixel (FIG. 21G).

In this way, lighting time can be separated in one frame period. As a result, frame frequency is visually improved, and a flicker of a screen can be prevented.

As described above, by controlling a sustain period by changing the angle of a triangular wave in an analog time gray scale method, sharp image display with high contrast becomes possible.

In FIG. 17, voltage to be applied to the light emitting element 1705 may be changed so as to display a sharp image. For example, a potential on the cathode side of the light emitting element is lowered, while a voltage to be applied between both electrodes of the light emitting element is increased. Alternatively, a potential on the anode side of the light emitting element is increased, while a voltage to be applied between both electrodes of the light emitting element is increased. Still alternatively, a potential on the cathode side of the light emitting element is lowered and a potential on the anode side is increased, while a voltage to be applied between both electrodes of the light emitting element is increased. Further, both a voltage to be applied between both electrodes of the light emitting element and the angle of a triangular wave may be changed. As a result, sharp image display with high contrast becomes possible.

### Embodiment Mode 6

In Embodiment Mode 6, a method of changing a maximum luminance by increasing and decreasing the number of sub-frames or bit number in accordance with an average luminance will be described. Here, the cases of 5 bits and 3 bits are described; however, the invention is not limited to these bit numbers.

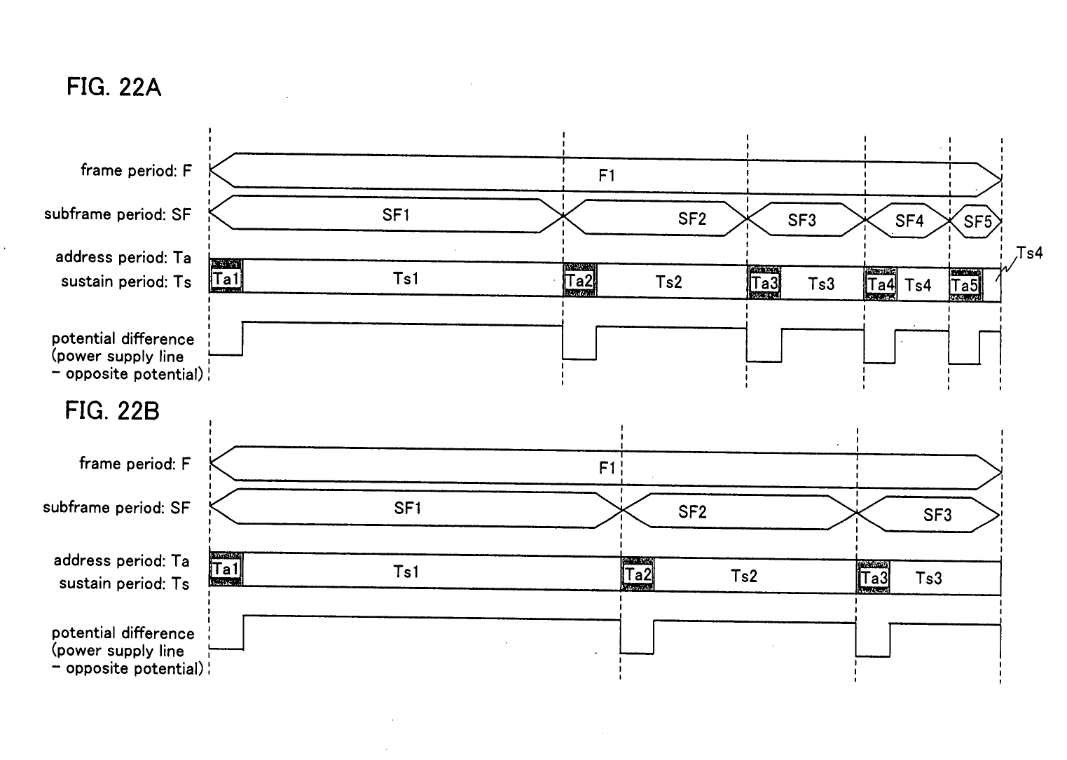

Timing charts showing a driving method of the display device of the present invention are shown in FIGS. 22A and 22B. FIG. 22A shows the case where a 5-bit signal is input to express 2⁵ gray scales.

In subframe periods SF1 to SF5 included in one frame period F1, lighting states (sustain periods) Ts1 to Ts5 or non-lighting states (address periods) Ta1 to Ta5 are selected for each pixel. Here, as shown in FIG. 4, the opposite potential of the light emitting element 404 is set almost equal to the potential of the power supply line 407 in an address period, so that a current does not flow to the light emitting element 404. In a sustain period, the opposite potential of the light emitting element 404 is changed so that a potential difference, which causes light emission of the light emitting element 404, arises between the power supply potential and the opposite potential of the light emitting element 404.

In FIG. 22B, a timing chart in the case of expressing gray scale with a 3-bit signal is shown. Each sub-frame includes an address period and a sustain period. Since the address period is a non-lighting period which does not contributes to light emission, a sustain period is substantially a period calculated by subtracting the address period from one frame period. In order to improve a luminance by increasing a sustain period, this address period may be reduced. Accordingly, when an image, such as fireworks, which partially includes a white object in a dark entire screen is displayed, a sustain period may be increased by reducing the bit number from 5 bit to 3 bit, for example. By increasing and decreasing the bit number in accordance with the average luminance of an image in this way so as to change the maximum luminance, sharp image display with high contrast becomes possible in an EL display device.

Next, the case where the number of sub-frames is increased or decreased with the same bit number will be described. Even with the same bit number, a higher-order bit is, in some cases, divided for the purpose of suppressing a pseudo contour or the like. For example, higher-order 2 bits of 8 bits are each divided into two sub-frames. Accordingly, the length ratio of subframe periods becomes 64:64:32:32:32:16:8:4:2:1, in sequence from a higher-order bit, and thus can be divided into 10 sub-frames. Note that they are not necessarily arranged from a higher-order bit.

Since each subframe period includes an address period and a sustain period, in the case where the sustain period is to be lengthened, the number of sub-frames is reduced so that the number of addressing is reduced. Therefore, when an average luminance of a display screen is low and a part thereof is expressed brightly, for example in the case of 8 bits, the number of sub-frames is reduced from 10 to 8; accordingly, a sustain period is increased; in other words, a duty ratio is increased. Accordingly, the average luminance of an entire display screen is increased. As a result, sharp image display with high contrast becomes possible.

### Embodiment Mode 7

In Embodiment Mode 7, a method in which a binary code digital time gray scale method and an overlapped time gray scale method are combined will be described.

Here, the overlapped time gray scale method is a method in which gray scale is expressed by sequentially adding lighting periods included in respective sub-frames. That is, the number of sub-frames for lighting is increased as the gray scale level is increased. Accordingly, a sub-frame for lighting at a small gray scale level is also used for lighting at a large gray scale level. As a result, the overlapped time gray scale method does not use a discrete sub-frame; accordingly, generation of a pseudo contour can be suppressed theoretically.

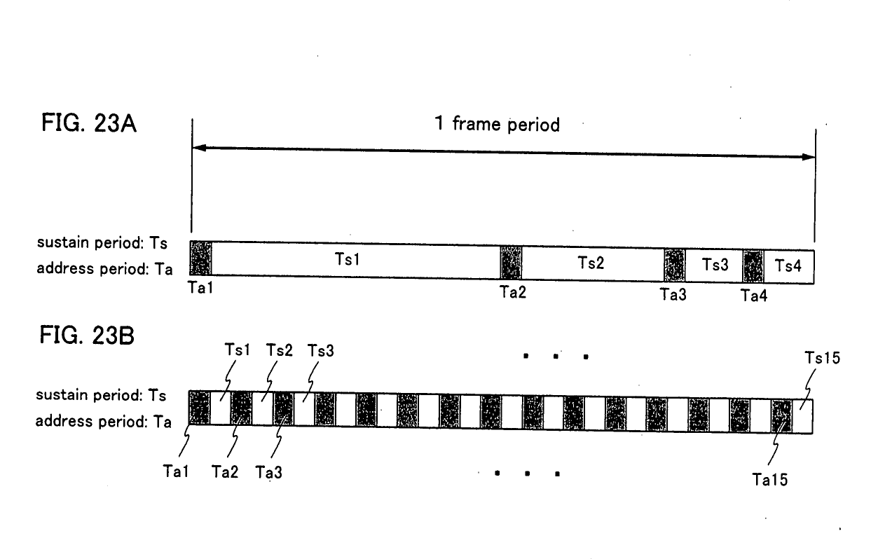

FIGS. 23A and 23B show timing charts of a binary code digital time gray scale method and an overlapped time gray scale method, respectively. One frame period includes a sustain period and an address period. For example, in the case of expressing 16 gray scales, in the binary code digital time gray scale method of FIG. 23A, sub-frames are weighted to be power of 2, and the luminance ratio of sub-frames is set to be 8:4:2:1. In the overlapped time gray scale method of FIG. 23B, the luminance is set by equally weighting all sub-frames. In the overlapped time gray scale method, gamma correction may be performed. In that case, weighting of sub-frames is conducted in accordance with the visibility, and gray scale can be smoothly displayed in all luminous regions by providing a luminance difference between gray scale levels, in accordance with the visibility.

In this embodiment mode, an overlapped time gray scale method is used as a normal method. In the case of conducting gamma correction, since weighting is conducted in accordance with the visibility, smooth gradation from low gray scale level to high gray scale level can be realized. In the case where an average luminance of an entire display screen is low and a part thereof is displayed brightly, the overlapped time gray scale method is switched to a binary code digital time gray scale method. In the case of displaying the same gray scale level, the number of addressing can be reduced more in the binary code digital time gray scale method than in the overlapped time gray scale method. For example, in the case of the overlapped time gray scale method as shown in FIG. 23B, 15 times of addressing are required to display 16 gray scales. On the other hand, in the case of the binary code digital time gray scale method as shown in FIG. 23A, only 4 times addressing are required. Therefore, in the case where an average luminance of an entire display screen is low and a part thereof is displayed brightly, the overlapped time gray scale method is switched to the binary code digital time gray scale method; accordingly, brighter display can be performed in the region displayed brightly and sharp image display with high contrast becomes possible. In addition, since the number of addressing is reduced, power consumption can be reduced.

### Embodiment Mode 8

Embodiment Mode 8 describes, when an average luminance is low and a part thereof is displayed brightly, a structure which enables sharp display with high contrast by changing both a potential and the number of sub-frames.

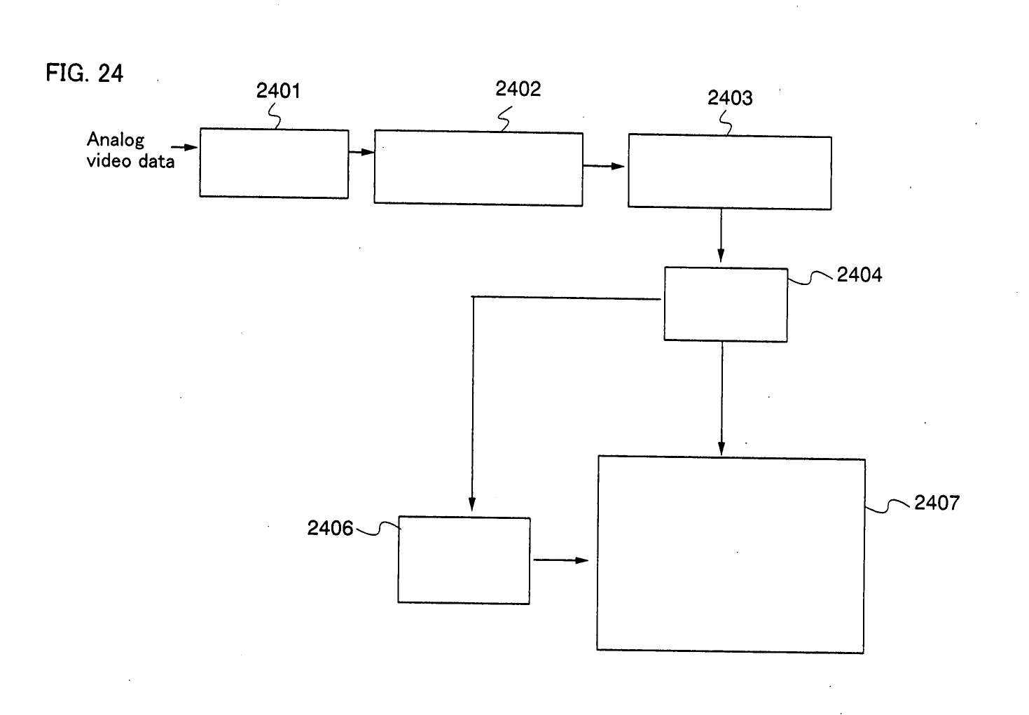

FIG. 24 is a block diagram of the present invention, which includes: an analog-digital converter circuit 2401 which converts an analog video signal to a digital video signal; an average gray scale calculation circuit 2402 which calculates an average gray scale level of a frame period by using the digital video signal; a sub-frame-number control circuit 2403 which controls the number of sub-frames depending on the average gray scale level; a display controller 2404 which converts the signal output from the sub-frame-number control circuit.2403 into an input specification for a driver circuit; a display 2407 which displays an image by using a signal output from the display controller 2404; and a potential control circuit 2406 which changes a potential depending on the level of the average luminance from a potential of the signal output from the display controller 2404.

When the average gray scale level calculated in the average gray scale calculation circuit 2402 is lower than an arbitrary level, the number of sub-frames is reduced by the sub-frame-number control circuit 2403, and the potential control circuit 2406 changes a potential so that a potential difference between an anode and a cathode in a display becomes larger. When the number of sub-frames is reduced, an address period is reduced as described in Embodiment Mode 6; accordingly, display period can be lengthened correspondingly. Therefore, in the case where the average luminance is low and a part of an image display is displayed brightly, the luminance of the brightly displayed portion can be increased. Further, since a voltage is set higher by the potential control circuit 2406, brighter light emission can be performed in the bright region.

The present invention is not limited to the above-described structure, and the potential control circuit 2406 may be incorporated in the display controller 2404.

Further, in this embodiment mode, when the average luminance is high and bright display is performed in an entire screen, the timing of an erasing operation in each sub-frame is set ahead as described in Embodiment Mode 2; accordingly, display period in each sub-frame is shortened and the average luminance in the entire screen is reduced. As a result, power consumption can be reduced without few changes in the brightness of the screen display. In addition, by shortening a voltage stress period of a light emitting element in the display 2407, deterioration of the light emitting element can be softened.

With the above-described structure, when an image of a momentary twinkle of, for example, fireworks, an edged tool, or the like is displayed, sharp display with high contrast becomes possible.

### Embodiment Mode 9

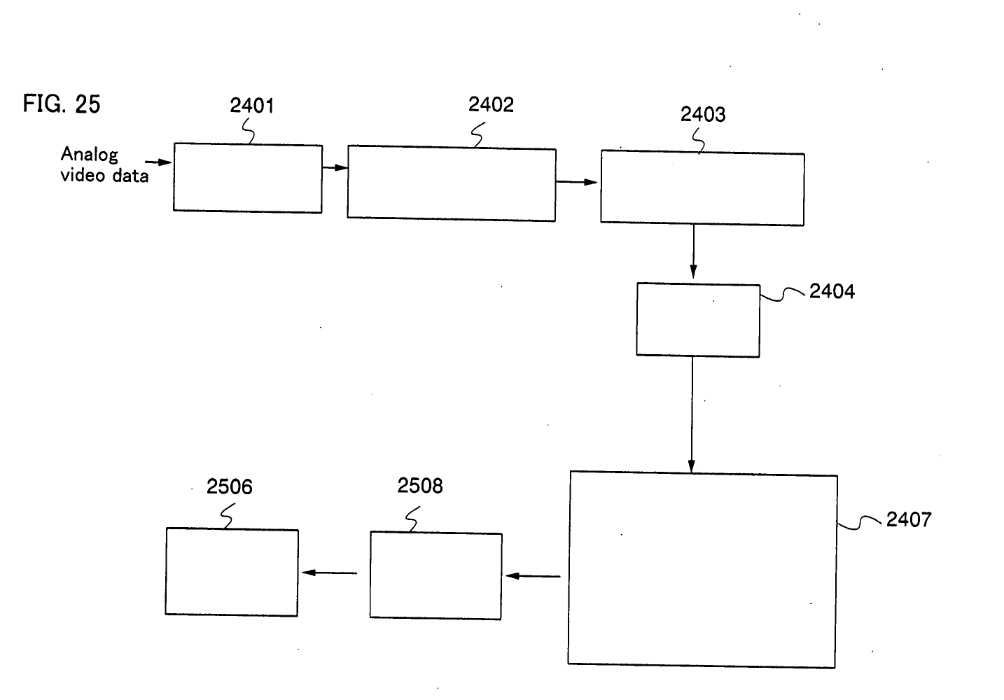

A structure different from that of Embodiment Mode 8 is shown in FIG. 25.

The followings have the same structures as those in FIG. 24: an analog-digital converter circuit 2401 which converts an analog video signal to a digital video signal; an average gray scale calculation circuit 2402 which calculates an average gray scale level over the entire screen of a frame period by averaging a gray scale level of the digital video signal of each pixel; a sub-frame-number control circuit 2403 which controls the number of sub-frames depending on the average gray scale level; a display controller 2404 which converts the signal output from the sub-frame-number control circuit 2403 into an input specification for a driver circuit; and a display 2407 which displays an image by using a signal output from the display controller 2404. In this embodiment mode, instead of using the potential control circuit 2406, a current measuring circuit 2508 which measures an average luminance of a screen of the display 2407 and a voltage control circuit 2506 which controls a luminance in accordance with a measurement result of the current measuring circuit 2508 are used.

For example, a current flowing from the opposite electrode of the light emitting element 404 in FIG. 4 is measured by the current measuring circuit 2508, and information about an average luminance of the display 2407 is obtained from the current value. The voltage control circuit 2506 is controlled based on the information about the average luminance and a potential difference between the opposite electrode of the light emitting element 404 and the power supply line 407, and a potential of the opposite electrode of the light emitting element 404 in FIG. 4 is fluctuated.

When the average gray scale level calculated by the average gray scale calculation circuit 2402 is lower than an arbitrary level, the number of sub-frames is reduced by the sub-frame-number control circuit 2403, and the voltage control circuit 2506 changes a potential so that a potential difference between an anode and a cathode in a display becomes larger. When the number of sub-frames is reduced, an address period is reduced as described in Embodiment Mode 6; accordingly, display period can be lengthened correspondingly. Therefore, in the case where the average luminance is low and a part of an image display is displayed brightly, the luminance of the brightly displayed portion can be increased. Further, since a voltage between the anode and the cathode in the display is set higher by the voltage control circuit 2506, brighter light emission can be performed in the bright region.

The present invention is not limited to the above-described structure, and the voltage control circuit 2506 and the current measuring circuit 2508 may be incorporated in the display controller 2404.

Further, in this embodiment mode, when the average luminance is high and bright display is performed in an entire screen, the timing of an erasing operation in each sub-frame is set ahead as described in Embodiment Mode 2; accordingly, display period in each sub-frame is shortened and the average luminance in the entire screen is reduced. As a result, power consumption can be reduced without few changes in the brightness of the screen display. In addition, since a voltage stress of a light emitting element in the display 2407 can be shortened, deterioration of the light emitting element can be softened.

With the above-described structure, when an image of a momentary twinkle of, for example, fireworks, an edged tool, or the like is displayed, sharp display with high contrast becomes possible.

### Embodiment Mode 10

Embodiment Mode 10 describes, when an average luminance is low and only a part is displayed brightly, a structure which enables sharp display with high contrast by changing both a potential and a time gray scale method.

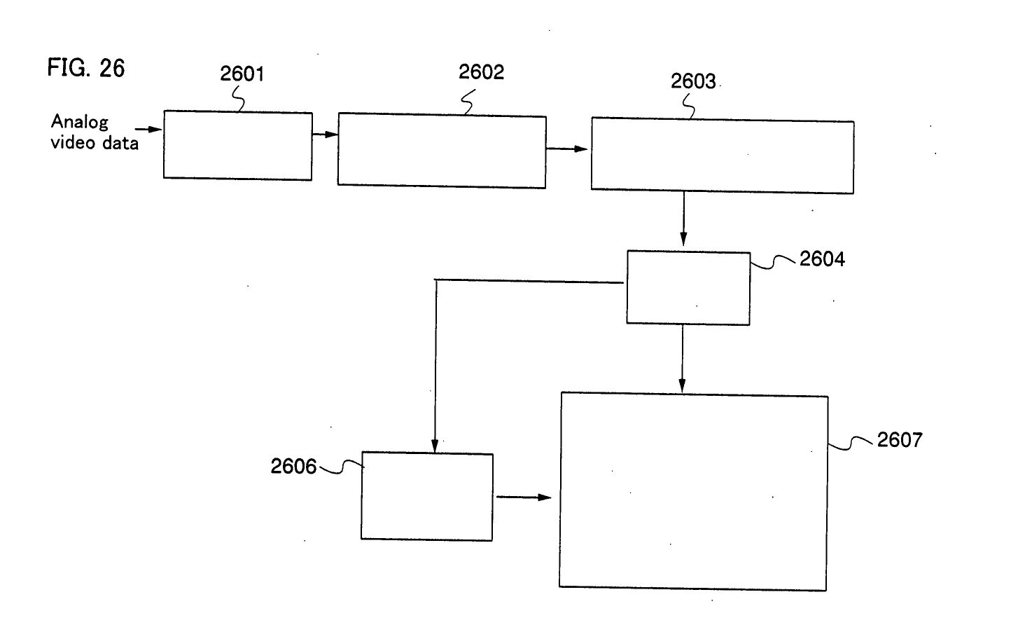

FIG. 26 is a block diagram of the present invention, which includes: an analog-digital converter circuit 2601 which converts an analog video signal to a digital video signal; an average gray scale calculation circuit 2602 which calculates the average gray scale level over the entire screen of a frame period by averaging gray scale of the digital video signal of each pixel; a gray scale method selector circuit 2603 which changes from an overlapped time gray scale method to a binary code digital time gray scale method when the average gray scale level becomes a certain level or less; a display controller 2604 which converts the signal output from the gray scale method selector circuit 2603 into an input specification for a driver circuit; a display 2607 which displays an image by using a signal output from the display controller 2604; and a potential control circuit 2606 which measures a potential of the signal output from the display controller 2604 and changes a potential depending on the level of the average luminance are included.

The overlapped time gray scale method is used in normal display, and each sub-frame width is, as described in Embodiment Mode 7, set in accordance with the visibility. When an average gray scale level calculated by the average gray scale calculation circuit 2602 is lower than an arbitrary level (in the case where the average luminance is low, an entire screen is dark, and only a part is displayed brightly), the overlapped time gray scale method is changed to the binary code digital time gray scale method by the gray scale method selector circuit 2603. In this manner, when the average gray scale level is higher than the arbitrary level, since the overlapped time gray scale method is used, generation of a pseudo contour can be suppressed even when displaying a moving image, and high-definition image display is possible. When the average gray level is lower than the arbitrary level, since the binary code digital time gray scale method is used, an address period in a frame period can be reduced, and a pixel for high gray scale is made brighter.

When gray scale method is changed to the binary code digital time gray scale method, a voltage applied to a light emitting element in the display 2607 is increased by the potential control circuit. For example, a potential on a cathode side of the light emitting element is decreased to increase a voltage applied between both electrodes of the light emitting element. Alternatively, the potential on an anode side of the light emitting element is increased to increase the voltage applied between both electrodes of the light emitting element. Further alternatively, the potential on the cathode side of the light emitting element is decreased while the potential on the anode side is increased, to increase the voltage applied between both electrodes of the light emitting element. By controlling the potential in this way, light emission with a higher luminance can be performed in a pixel for high gray scale, and a peak luminance can be increased. By increasing the peak luminance, sharp screen display with high contrast becomes possible.

By changing the gray scale method and fluctuating the potential depending on the gray scale method in the above-described manner, a peak luminance can be further heightened, and sharp screen display with higher contrast becomes possible.

Further in this embodiment mode, when the average gray scale level is higher than the arbitrary level and bright display is performed in an entire screen, the timing of an erasing operation in each sub-frame may be set ahead as described in Embodiment Mode 2, so that display period in each sub-frame is shortened and the average luminance in the entire screen is reduced. As a result, power consumption can be reduced without few changes in the brightness of the screen display. In addition, since a voltage stress of a light emitting element in the display 2607 can be shortened, deterioration of the light emitting element can be softened.

### Embodiment Mode 11

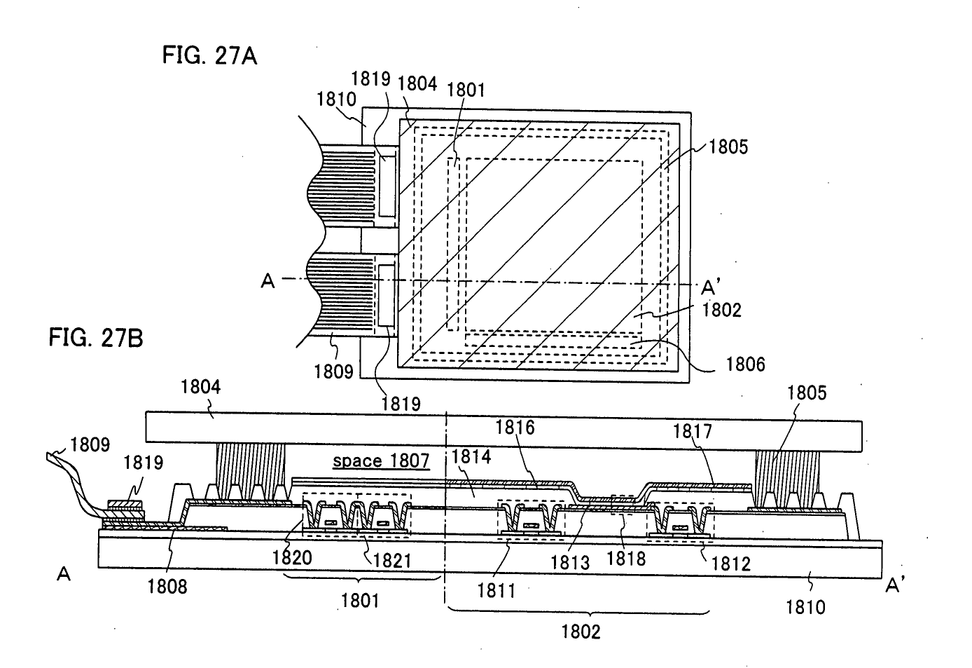

Embodiment Mode 11 will describe a structure of a display panel which is operated by the driving method shown in Embodiment Mode 1 to 10, with reference to FIGS. 27A and 27B.

FIG. 27A is a top view of the display panel, and FIG. 27B is a sectional view taken along line A-A′ of FIG. 27A. A signal line driver circuit 1801, a pixel portion 1802, and a scanning line driver circuit 1806, which are shown by dotted lines are provided. In addition, a sealing substrate 1804 and a sealant 1805 are provided. An inside surrounded by the sealant 1805 is a space 1807.

A wire 1808 is a wire for transmitting signals input into the scanning line driver circuit 1806 and the signal line driver circuit 1801. The wire 1808 receives a video signal, a clock signal, a start signal, or the like from an FPC (Flexible Printed Circuit) 1809 which is an external input terminal. Over a connecting portion between the FPC 1809 and the display panel, an IC chip (a semiconductor chip provided with a memory circuit, a buffer circuit, or the like) 1819 is mounted by COG (Chip On Glass) or the like. It is to be noted that although only the FPC is shown here, a printed wiring board (PWB) may be attached to the FPC.

A sectional structure thereof is described with reference to FIG. 27B. The pixel portion 1802 and peripheral driver circuits (the scanning line driver circuit 1806 and the signal line driver circuit 1801) are formed over the substrate 1810. The signal line driver circuit 1801 and the pixel portion 1802 are illustrated here.

The signal line driver circuit 1801 may have a CMOS structure including a p-channel TFT 1820 and an n-channel TFT 1821. Although the peripheral driver circuits are formed over the same substrate in the display panel in this embodiment mode, the invention is not limited to this and the whole or a part of the peripheral driver circuits may be formed on an IC chip or the like and then mounted by COG or the like.

The pixel portion 1802 has a plurality of circuits which form pixels each including a switching TFT 1811 and a driving TFT 1812. A source or drain electrode of the driving TFT 1812 is connected to a first electrode 1813. In addition, an insulator 1814 is formed so as to cover end portions of the first electrode 1813. Here, the insulator 1814 is formed using a positive photosensitive acrylic resin film.

In order to improve coverage of an electrode or a light emitting layer containing an organic compound to be formed later, the upper edge portion or the bottom edge portion of the insulator 1814 is formed to have a curved surface having curvature. For example, in the case where a positive photosensitive acrylic is used as a material for the insulator 1814, it is preferable that only the upper edge portion of the insulator 1814 be formed to have a curved surface having a curvature radius (0.2 μm to 3 μm). Either a negative type resin that is insoluble in an etchant due to light or a positive type resin that is dissoluble in an etchant due to light can be used as the insulator 1814.

On the first electrode 1813, a layer containing an organic compound (electroluminescent layer) 1816 and a second electrode 1817 are formed. The first electrode 1813 which functions as an anode is preferably formed using a material having a high work function. For example, a single-layer film such as an ITO (indium tin oxide) film, an indium zinc oxide (IZO) film, a titanium nitride film, a chromium film, a tungsten film, a Zn film, or a Pt film, a stacked layer of a titanium nitride film and a film mainly containing aluminum, or a three-layer structure of a titanium nitride film, a film mainly containing aluminum and a titanium nitride film can be used. It is to be noted that a stacked structure makes it possible to reduce the resistance as a wire and realize a good ohmic contact.

The layer containing an organic compound 1816 is formed by a vapor deposition method using an evaporation mask or an ink-jet method. For the layer containing an organic compound 1816, a metal complex in the fourth group of the periodic system is partially used, and either a low molecular material or a high molecular material may be used in combination with such a metal complex. Generally, an organic compound is used in a single layer or a stacked layer in many cases as a material for the layer containing an organic compound; however, the structure in which an inorganic compound is used partially in a film formed of an organic compound, is included in this embodiment mode. Moreover, a known triplet material can be used as well.

As a material for a second electrode (cathode) 1817 formed over the layer containing an organic compound 1816, a material having a low work function (Al, Ag, Li, Ca, or an alloy of these elements such as MgAg, Mgln, AlLi, CaF₂, or Ca₃N₂) can be used. In the case where light generated in the electroluminescent layer 1816 is emitted through the second electrode 1817, a stacked layer of a metal thin film and a transparent conductive film (e.g., ITO (an alloy of indium oxide and tin oxide), an alloy of indium oxide and zinc oxide (In₂O₃—ZnO), zinc oxide (ZnO), or the like) is preferably used as the second electrode (cathode) 1817.

Subsequently, the sealing substrate 1804 is attached to the substrate 1810 with the sealant 1805, so that a light emitting element 1818 is provided in the space 1807 surrounded by the substrate 1810, the sealing substrate 1804, and the sealant 1805. Instead of filling the space 1807 with an inert gas (nitrogen, argon, or the like), the space 1807 may be filled with the sealant 1805 as well.

Epoxy resin is preferably used for the sealant 1805. In addition, it is preferable that the material do not transmit moisture and oxygen as much as possible. As the sealing substrate 1804, a glass substrate, a quartz substrate, or a plastic substrate formed of FRP (Fiberglass-Reinforced Plastics), PVF (polyvinyl fluoride), mylar, polyester, acrylic, or the like can be used.

Accordingly, a display panel operated by a driving method of the present invention can be formed.

By forming the signal line driver circuit 1801, the pixel portion 1802, and the scanning line driver circuit 1806 over the same substrate as shown in FIGS. 27A and 27B, cost reduction of the display device can be realized. Moreover, by using amorphous silicon for semiconductor layers of the transistor used in the signal line driver circuit 1801, the pixel portion 1802, and the scanning line driver circuit 1806, further cost reduction can be realized.

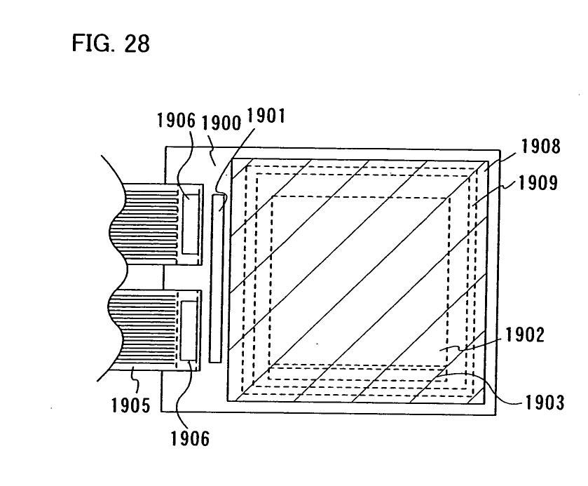

The structure of the display panel is not limited to the structure shown in FIG. 27A where the signal line driver circuit 1801, the pixel portion 1802, and the scanning line driver circuit 1806 are formed over the same substrate, and the structure where a signal line driver circuit 1901 shown in FIG. 28 corresponding to the signal line driver circuit 1801 is formed on an IC chip and mounted onto the display panel by COG, TAB or the like may be employed. A substrate 1900, a pixel portion 1902, a scanning line driver circuit 1903, an FPC 1905, an IC chip 1906, a sealing substrate 1908, and a sealant 1909 in FIG. 28 correspond to the substrate 1810, the pixel portion 1802, the scanning line driver circuit 1806, the FPC 1809, the IC chip 1819, the sealing substrate 1804, and the sealant 1805 in FIG. 27A, respectively.

That is, only a signal line driver circuit required to operate rapidly is formed by COG or the like on an IC chip. By using a semiconductor chip such as a silicon wafer as the IC chip, further high-speed operation and low power consumption can be achieved. Instead of using the signal line driver circuit, only a scanning line driver circuit may be formed on an IC chip and mounted onto the display panel.

Since the thus manufactured display panel employs a driving method of the present invention, in the case where an entire screen is dark and a part is displayed with brightness, for example, when an image of a momentary twinkle of fireworks, a edged tool, or the like is displayed, sharp display with high contrast becomes possible.

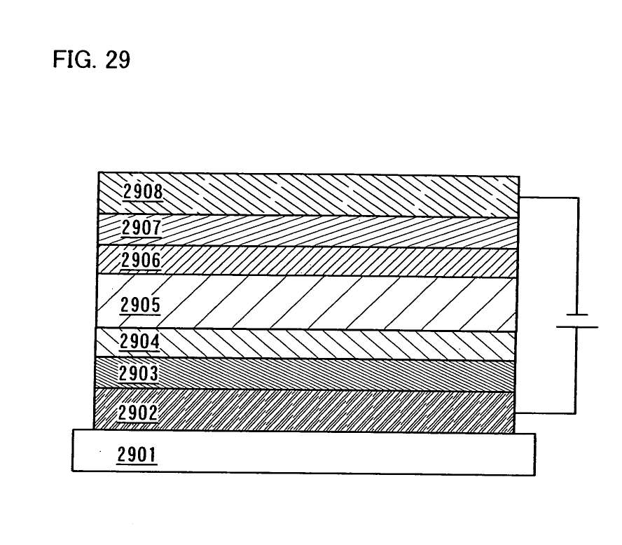

Further, an example of a light emitting element which is capable of being applied to the light emitting element 1818 is described in FIG. 29. In other words, a structure of a light emitting element capable of being applied to the pixel described in Embodiment Mode 1 to 10 will be described with reference to FIG. 29.

In an element structure, an anode 2902, a hole injecting layer 2903 formed of a hole injecting material, a hole transporting layer 2904 formed of a hole transporting material, a light emitting layer 2905, an electron transporting layer 2906 formed of an electron transporting material, an electron injecting layer 2907 formed of an electron injecting material, and a cathode 2908 are stacked over a substrate 2901 in this order. Here, the light emitting layer 2905 is sometimes formed of only one kind of a light emitting material, but may be formed of two or more materials. In addition, an element structure of the invention is not limited to this structure.

In addition to the stacked structure in which the functional layers are stacked as shown in FIG. 29, various elements can be applied such as an element using a high molecular compound or a high efficiency element in which a light emitting layer is formed using a triplet light emitting material which emits light from a triplet excited state. In addition, a white light emitting element realized by dividing a light emitting region into two regions by controlling a carrier recombination region by a hole blocking layer, or the like can be applied as well.

In a manufacturing method of the element of the present invention shown in FIG. 29, the hole injecting material, the hole transporting material, and the light emitting material are deposited in this order over the substrate 2901 provided with the anode (ITO) 2902, first. Then, the electron transporting material and the electron injecting material are deposited by vapor deposition, and the cathode 2908 is lastly formed by vapor deposition.

Described below are materials suitable for the hole injecting material, the hole transporting material, the electron transporting material, the electron injecting material, and the light emitting material.

As the hole injecting material, a porphyrin compound, phthalocyanine (hereinafter referred to as “H₂Pc”), copper phthalocyanine (hereinafter referred to as “CuPc”), or the like is efficient among organic compounds. In addition, a material that has a smaller value of an ionization potential than the hole transporting material to be used and has a hole transporting function can also be used as the hole injecting material. There is also a material of a conductive high molecular compound subjected to chemical doping, which is polyethylene dioxythiophene (hereinafter referred to as “PEDOT”) doped with polystyrene sulfonate (hereinafter referred to as “PSS”), polyaniline, or the like. In addition, an insulating high molecular compound is efficient in terms of planarization of an anode, and polyimide (hereinafter referred to as “PI”) is often used. Further, an inorganic compound is also used, which is an extra-thin film of aluminum oxide (hereinafter referred to as “alumina”) as well as a thin film of a metal such as gold or platinum.

As the hole transporting material, it is an aromatic amine-based compound (that is, a compound having a bond of benzene ring-nitrogen) that is most widely used. As the material that is widely used, there is 4,4′-bis(diphenylamino)-biphenyl (hereinafter referred to as “TAD”), derivatives thereof such as 4,4′-bis[N-(3-methylphenyl)-N-phenyl-amino]-biphenyl (hereinafter referred to as “TPD”) or 4,4′-bis[N-(1-naphthyl)-N-phenylamino]biphenyl (hereinafter referred to as “a-NPD”). Besides, a star burst aromatic amine compound such as 4,4′,4″-tris(N,N-diphenylamino)triphenylamine (hereinafter referred to as “TDATA”) or 4,4′,4″-tris[N-(3-methylphenyl)-N-phenylamino]triphenylamine (hereinafter referred to as “MTDATA”) can be used.

As the electron transporting material, a metal complex is often used, which is a metal complex having a quinoline skeleton or a benzoquinoline skeleton such as Alq, BAlq, tris(4-methyl-8-quinolinolato)aluminum (hereinafter referred to as “Almq”), or bis(10-hydroxybenzo[h]-quinolinato)beryllium (hereinafter referred to as “Bebq”). Besides, a metal complex having an oxazole-based or a thiazole-based ligand such as bis[2-(2-hydroxyphenyl)benzoxazolato]zinc (hereinafter referred to as “Zn(BOX)₂”) or bis[2-(2-hydroxyphenyl)benzothiazolato]zinc (hereinafter referred to as “Zn(BTZ)₂”) can be used. Further, other than the metal complex, an oxadiazole derivative such as 2-(4-biphenylyl)-5-(4-tert-butylphenyl)-1,3,4-oxadiazole (hereinafter referred to as “PBD”) or OXD-7, a triazole derivative such as TAZ or 3-(4-tert-butylphenyl)-4-(4-ethylphenyl)-5-(4-biphenylyl)-1,2,4-triazole (hereinafter referred to as “p-EtTAZ”), or a phenanthroline derivative such as bathophenanthroline (hereinafter referred to as “BPhen”) or BCP has an electron transporting property.

As the electron injecting material, the above-described electron transporting material can be used. In addition, an extra-thin film of an insulator of metal halide such as calcium fluoride, lithium fluoride, or cesium fluoride, or alkali metal oxide such as lithium oxide, is often used. Further, an alkali-metal complex such as lithium acetyl acetonate (hereinafter referred to as “li(acac)”) or 8-quinolinolato-lithium (hereinafter referred to as “Liq”) is also efficient.

As the light emitting material, as well as the above-described metal complex such as Alq, Almq, BeBq, BAlq, Zn(BOX)₂, or Zn(BTZ)₂, various fluorescent pigments are efficient. As the fluorescent pigments, there are 4,4′-bis(2,2-diphenyl-vinyl)-biphenyl which is blue, 4-(dicyanomethylene)-2-methyl-6-(p-dimethylaminostyryl)-4H-pyran which is red-orange, and the like. A triplet light emitting material is available, which is mainly a complex with platinum or iridium as a central metal. As the triplet light emitting material, tris(2-phenylpyridine)iridium, bis(2-(4′-tryl)pyridinato-N,C²′)acetylacetonatoiridium (hereinafter referred to as “acaclr(tpy)₂”), 2,3,7,8,12,13,17,18,-octaethyl-21H,23Hporphyrin-platinum, or the like is known.

By combining the above-described materials that have the respective functions, a light emitting element with high reliability can be manufactured.

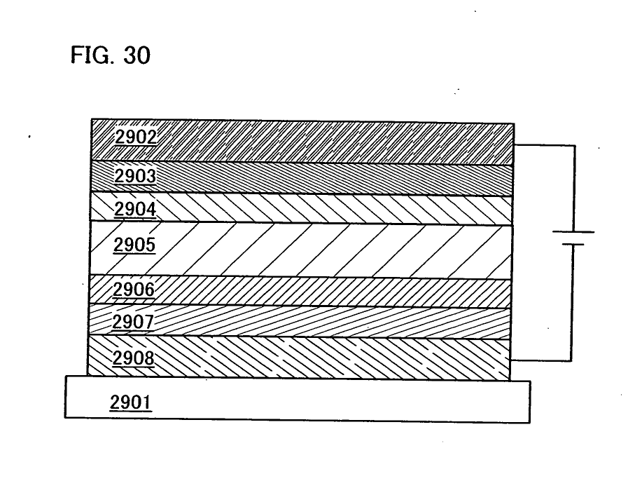

In addition, a light emitting element as shown in FIG. 30 having the layers stacked over the substrate in a reverse order of that in FIG. 29 can be employed. That is, in an element structure, the cathode 2908, the electron injecting layer 2907 formed of the electron injecting material, the electron transporting layer 2906 formed of the electron transporting material, the light emitting layer 2905, the hole transporting layer 2904 formed of the hole transporting material, the hole injecting layer 2903 formed of the hole injecting material, and the anode 2902 are stacked over the substrate 2901 in this order.

In addition, in order to take out light emission of the light emitting element, at least one of the anode and the cathode is required to be transparent. A TFT and a light emitting element are formed over a substrate. There are light emitting elements having a top emission structure in which light emission is taken out through a surface opposite to the substrate, having a bottom emission structure in which light emission is taken out through a surface on the substrate side, and having a dual emission structure in which light emission is taken out through a surface on the substrate side and a surface opposite to the substrate. The pixel configuration of the present invention can be applied to the light emitting element having any emission structure thereof.

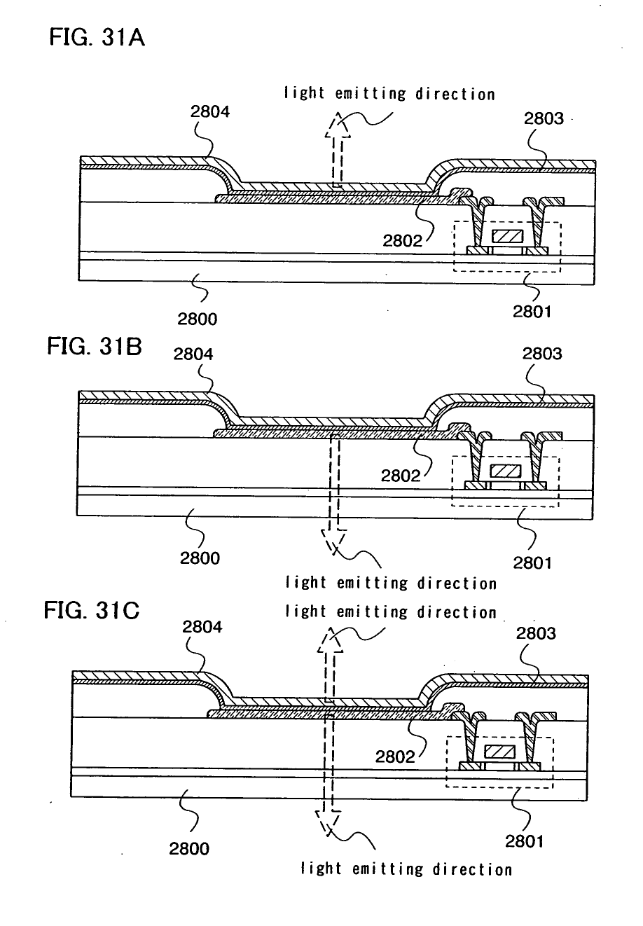

A light emitting element having a top emission structure is described with reference to FIG. 31A.

On a substrate 2800, a driver TFT 2801 is formed, and a first electrode 2802 is formed so as to contact a source electrode of the driver TFT 2801. A layer containing an organic compound 2803 and a second electrode 2804 are formed thereover.

The first electrode 2802 is an anode of a light emitting element while the second electrode 2804 is a cathode of the light emitting element. That is, the light emitting element is formed in a region where the layer containing an organic compound 2803 is sandwiched between the first electrode 2802 and the second electrode 2804.

The first electrode 2802 which functions as an anode is preferably formed using a material having a high work function. For example, a single-layer film such as a titanium nitride film, a chromium film, a tungsten film, a Zn film, or a Pt film, a stacked layer of a titanium nitride film and a film mainly containing aluminum, or a three-layered structure of a titanium nitride film, a film mainly containing aluminum and a titanium nitride film can be used. A stacked structure makes it possible to reduce the resistance as a wire and realize a good ohmic contact, and the first electrode 2802 can function as an anode. By using a light-reflective metal film, an anode which does not transmit light can be formed.

The second electrode 2804 which functions as a cathode is preferably formed using a stacked layer of a metal thin film formed of a material having a low work function (Al, Ag, Li, Ca, an alloy thereof such as MgAg, MgIn, AlLi, CaF₂, or Ca₃N₂) and a transparent conductive film (indium tin oxide (ITO), indium zinc oxide (IZO), zinc oxide (ZnO), or the like). By using the thin metal film and the transparent conductive film in this manner, a cathode which can transmit light can be formed.

Accordingly, light of the light emitting element can be taken out from a top surface as shown by an arrow in FIG. 31A That is, in the case where the light emitting element is applied in the display panel shown in FIGS. 27A and 27B, light is emitted toward the sealing substrate 1804 side. Therefore, when a light emitting element having a top emission structure is used in the display device, a substrate which transmits light is used as the sealing substrate 1804.

In addition, in the case of providing an optical film, the optical film may be provided on the sealing substrate 1804.

In addition, in the case of the pixel configuration shown in FIG. 4, the first electrode 2802 may be formed using a metal film formed of a material having a low work function such as MgAg, MgIn, or AlLi so that the first electrode 2802 can function as a cathode. In addition, the second electrode 2804 may be formed using a transparent conductive film such as an ITO (indium tin oxide) film or an indium zinc oxide (IZO) film. With this structure, the transmissivity of the top emission can be improved.

A light emitting element having a bottom emission structure is described with reference to FIG. 31B. The same reference numerals as FIG. 31A are used since a structure except for its emission structure is identical.

The first electrode 2802 which functions as an anode is preferably formed using a material having a high work function. For example, a transparent conductive film such as an ITO (indium tin oxide) film or an indium zinc oxide (IZO) film can be used. By using a transparent conductive film, an anode which can transmit light can be formed.

The second electrode 2804 which functions as a cathode is preferably formed using a metal film formed of a material having a low work function (Al, Ag, Li, Ca, an alloy thereof such as MgAg, MgIn, AlLi, CaF₂, or CaN). By using a light-reflective metal film in this manner, a cathode which does not transmit light can be formed.

Accordingly, light of the light emitting element can be taken out from a bottom surface as shown by an arrow in FIG. 31B. That is, in the case where the light emitting element is applied in the display panel shown in FIGS. 27A and 27B, light is emitted toward the substrate 1810 side. Therefore, when a light emitting element having a bottom emission structure is used in the display device, a substrate which transmits light is used as the substrate 1810.

In addition, in the case of providing an optical film, the optical film may be provided over the substrate 1810.

A light emitting element having a dual emission structure is described with reference to FIG. 31C. The same reference numerals as FIG. 31A are used since a structure except for its emission structure is identical.

The first electrode 2802 which functions as an anode is preferably formed using a material having a high work function. For example, a transparent conductive film such as an ITO (indium tin oxide) film or an indium zinc oxide (IZO) film can be used. By using a transparent conductive film, an anode which can transmit light can be formed.

The second electrode 2804 which functions as a cathode is preferably formed using a stacked layer of a metal thin film formed of a material having a low work function (Al, Ag, Li, Ca, an alloy thereof such as MgAg, Mgln, AlLi, CaF₂, or Ca₃N₂) and a transparent conductive film (indium tin oxide (ITO), an alloy of indium oxide and zinc oxide (In₂O₃—ZnO), zinc oxide (ZnO), or the like). By using the thin metal film and the transparent conductive film in this manner, a cathode which can transmit light can be formed.

Accordingly, light of the light emitting element can be taken out from both surfaces as shown by arrows in FIG. 31C. That is, in the case where the light emitting element is applied in the display panel shown in FIGS. 27A and 27B, light is emitted toward the substrate 1810 side and the sealing substrate 1804 side. Therefore, when a light emitting element having a dual emission structure is used in the display device, substrates which transmit light are used as the substrate 1810 and the sealing substrate 1804.

In addition, in the case of providing an optical film, the optical films may be provided over the substrate 1810 and the sealing substrate 1804.

Since the thus manufactured display panel employs a driving method of the present invention, in the case where an entire screen is dark and a part is displayed with brightness, for example, when an image of a momentary twinkle of fireworks, an edged tool, or the like is displayed, sharp display with high contrast becomes possible.

### Embodiment Mode 12

The present invention can be applied to various electronic devices. Specifically, the present invention can be applied to display portions of electronic devices. As examples of such electronic devices, there are a video camera, a digital camera, a goggle display (head mounted display), a navigation system, an audio reproducing device (e.g., a car audio or audio component set), a computer, a game machine, a portable information terminal (e.g., a mobile computer, a mobile phone, a portable game machines, or an electronic book), an image reproducing device provided with a recording medium (specifically, a device for reproducing a recording medium such as a digital versatile disc (DVD) and having a display for displaying the reproduced image), and the like.

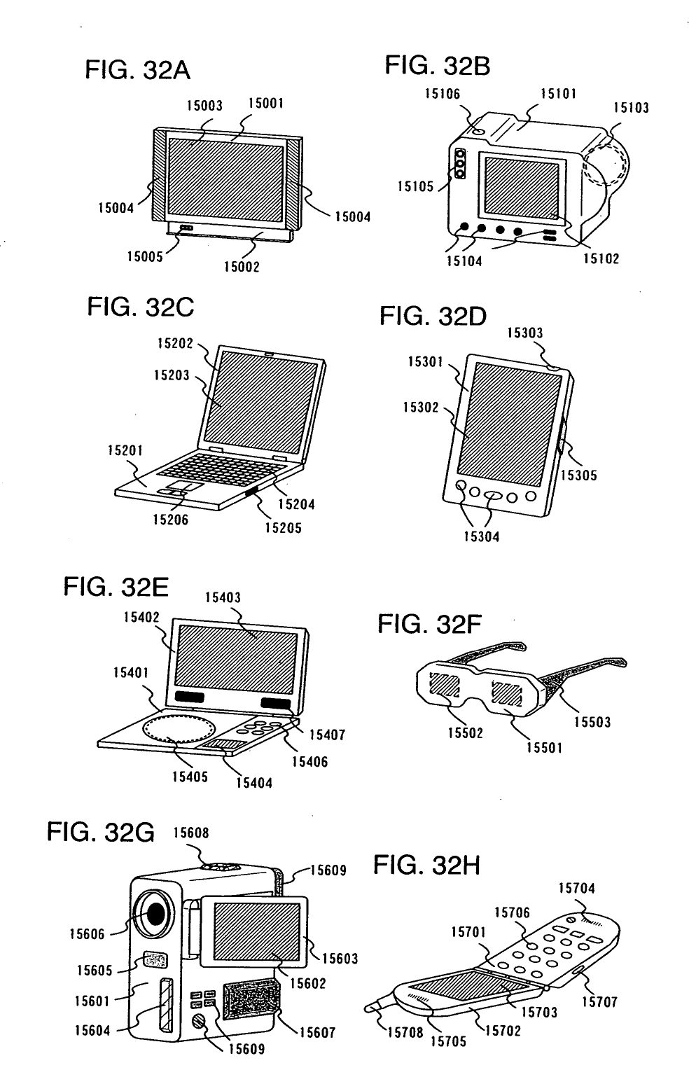

FIG. 32A shows a display apparatus which includes a housing 15001, a supporting base 15002, a display portion 15003, speaker portions 15004, a video input terminal 15005, and the like. When a display apparatus using the present invention in the display portion 15003 has a low average luminance and a high gray scale is displayed in a portion, the display apparatus can increase a peak luminance in the portion so that sharp image display with high contrast can be performed. Note that the display apparatus includes all display devices for information display, such as display devices for a personal computer, television broadcast reception, or advertisement display.

FIG. 32B shows a camera which includes a main body 15101, a display portion 15102, an image receiving portion 15103, operating keys 15104, an external connecting port 15105, a shutter button 15106, and the like. When a camera using the present invention in the display portion 15102 has a low average luminance and a high gray scale is displayed in a portion, the camera can increase a peak luminance in the portion so that sharp image display with high contrast can be performed.

FIG. 32C shows a computer which includes a main body 15201, a housing 15202, a display portion 15203, a keyboard 15204, an external connecting port 15205, a pointing mouse 15206, and the like. When a computer using the present invention in the display portion 15203 has a low average luminance and a high gray scale is displayed in a portion, the computer can increase a peak luminance in the portion so that sharp image display with high contrast can be performed.

FIG. 32D shows a mobile computer which includes a main body 15301, a display portion 15302, a switch 15303, operating keys 15304, an infrared port 15305, and the like. When a mobile computer using the present invention in the display portion 15302 has a low average luminance and a high gray scale is displayed in a portion, the mobile computer can increase a peak luminance in the portion so that sharp image display with high contrast can be performed.

FIG. 32E shows a portable image reproducing device provided with a recording medium (specifically, a DVD player) which includes a main body 15401, a housing 15402, a display portion A 15403, a display portion B 15404, a recording medium (e.g., DVD) reading portion 15405, an operating key 15406, a speaker portion 15407, and the like. The display portion A 15403 can mainly display images, while the display portion B 15404 can mainly display characters. When a portable image reproducing device using the present invention in the display portion A 15403 and the display portion B 15404 has a low average luminance and a high gray scale is displayed in a portion, the portable image reproducing device can increase a peak luminance in the portion so that sharp image display with high contrast can be performed.

FIG. 32F shows a goggle type display which includes a main body 15501, a display portion 15502, and an arm portion 15503. When a goggle type display using the present invention in the display portion 15502 has a low average luminance and a high gray scale is displayed in a portion, the goggle type display can increase a peak luminance in the portion so that sharp image display with high contrast can be performed.

FIG. 32G shows a video camera which includes a main body 15601, a display portion 15602, a housing 15603, an external connecting port 15604, a remote controller receiving portion 15605, an image receiving portion 15606, a battery 15607, an audio input portion 15608, operating keys 15609 and the like. When a video camera using the present invention in the display portion 15602 has a low average luminance and a high gray scale is displayed in a portion, the video camera can increase a peak luminance in the portion so that sharp image display with high contrast can be performed.

FIG. 32H shows a mobile phone which includes a main body 15701, a housing 15702, a display portion 15703, an audio input portion 15704, an audio output portion 15705, an operating key 15706, an external connecting port 15707, an antenna 15708, and the like. When a mobile phone using the present invention in the display portion 15703 has a low average luminance and a high gray scale is displayed in a portion, the mobile phone can increase a peak luminance in the portion so that sharp image display with high contrast can be performed.

In this way, the present invention can be applied to various electronic devices.

### Embodiment 1

A manufacturing method of a display device using an EL driving method of the resent invention will be described with reference to the drawings. In this embodiment, an example in which a display portion formed by arranging pixels and a driver circuit for controlling a scanning signal and an image signal are formed by using a thin film transistor is described.

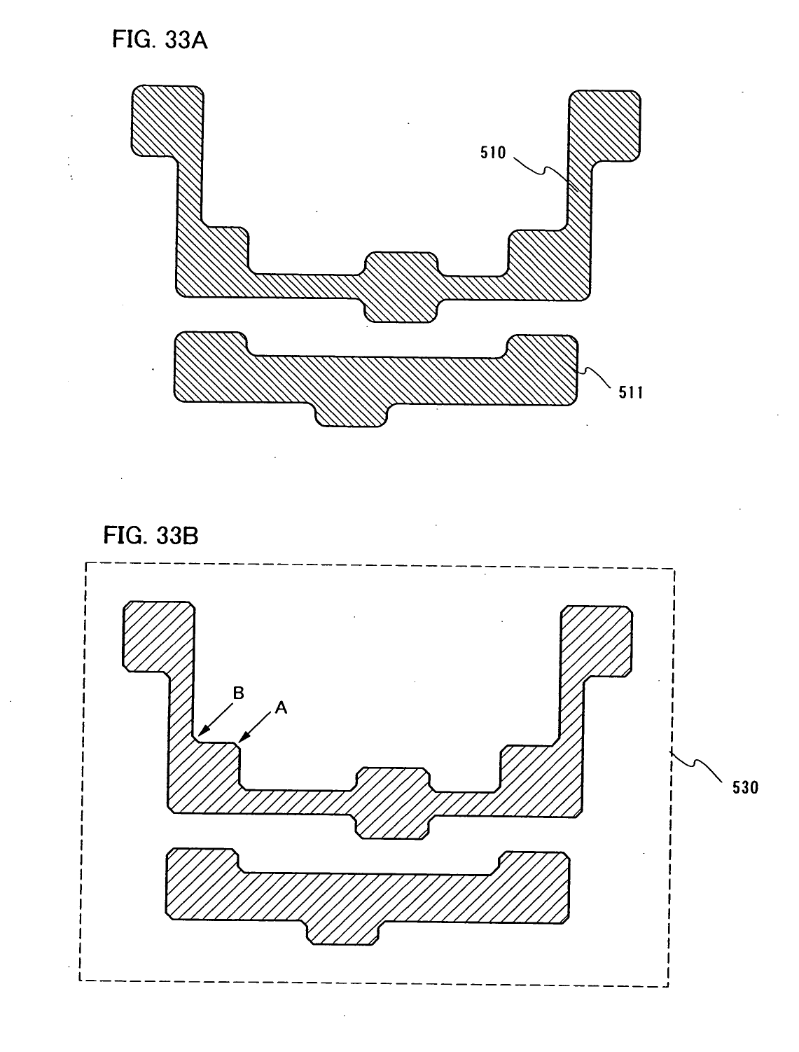

Semiconductor layers 510 and 511 shown in FIG. 33A are preferably formed with silicon or a crystalline semiconductor containing silicon. For example, single crystalline silicon, polycrystalline silicon obtained by crystallizing a silicon film by laser annealing or the like, or the like can be employed. Alternatively, a metal oxide semiconductor, amorphous silicon, or an organic semiconductor can be employed as long as it exhibits the semiconductor characteristics.

In any case, a semiconductor layer to be formed first is provided over an entire surface of a substrate having an insulating surface, or a part thereof (region having a larger area than the area which is defined as a semiconductor region of a transistor). Then, a mask pattern is formed over the semiconductor layer by a photolithography technique. By etching the semiconductor layer using the mask pattern, the semiconductor layers 510 and 511 each having a specific island shape and including source and drain regions and a channel formation region of a TFT are formed. The semiconductor layers 510 and 511 are appropriately determined in accordance with the layout design.

The photomask for forming the semiconductor layers 510 and 511 shown in FIG. 33A are provided with a mask pattern 530 shown in FIG. 33B. The shape of this ask pattern 530 differs depending on whether a resist used for the photolithography process is a positive type or negative type. In the case of using a positive resist, the mask pattern 530 shown in FIG. 33B is formed as a light-blocking portion. The mask pattern 530 has such a shape that a vertex A of a polygon is removed. In addition, a corner B has such a shape that a plurality of corners are provided so as not to form a right-angled corner. In the pattern of this photomask, corners are removed so that one side of each removed corner (right-angled triangle) has a length of 10 μm or less, for example.

The semiconductor layers 510 and 511 shown in FIG. 33A reflect the mask pattern 530 shown in FIG. 33B. In this case, the mask pattern 530 may be transferred in such a manner that a pattern similar to the original one is formed or corners of the transferred pattern are rounded more than those of the original one. That is, corner portions with a roundish and smoother shape may be provided, more than those of the mask pattern 530.

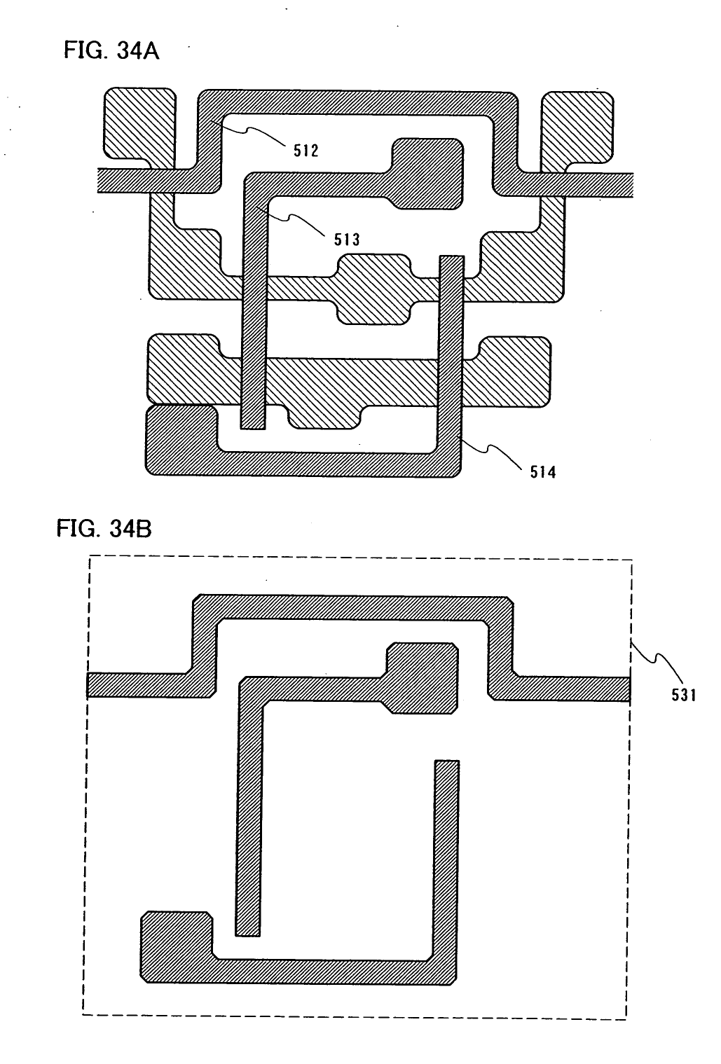

An insulating layer which partially contains at least silicon oxide or silicon nitride is formed over the semiconductor layers 510 and 511. One purpose of forming this insulating layer is to form a gate insulating layer. Then, gate wires 512, 513, and 514 are formed so as to partially overlap the semiconductor layers as shown in FIG. 34A. The gate wire 512 is formed corresponding to the semiconductor layer 510. The gate wire 513 is formed corresponding to the semiconductor layers 510 and 511. The gate wire 514 is formed corresponding to the semiconductor layers 510 and 511. The gate wires are formed by depositing a metal layer or a highly conductive semiconductor layer over the insulating layer and then printing a pattern onto the insulating layer by a photolithography technique.

The photomask for forming such gate wires is provided with a mask pattern 531 shown in FIG. 34B. Corners of this mask pattern 531 are removed in such a manner that each removed corner (right-angled triangle) has one side of 10 μm or less, or has one side of ⅕ to ½ of the wire width. The gate wires 512, 513, and 514 shown in FIG. 34A reflect the shape of the mask pattern 531 shown in FIG. 34B. In this case, the mask pattern 531 may be transferred in such a manner that a pattern similar to the original one is formed or corners of the transferred pattern are rounded more than those of the original one. That is, corner portions with a roundish and smoother shape may be provided, more than those of the mask pattern 531. Specifically, each corner of the gate wires 512, 513, and 514 is formed to be roundish by removing an edge so that the removed corner (right-angled triangle) has one side of ⅕ to ½ of the wire width. That is to say, the outer circumferences of the corners of the gate wires 512, 513 and 514 are curved when seen from the above. Specifically, in order to form the outer circumferences of the corners to be roundish, a part of the gate wires are removed, which correspond to right-angled isosceles triangles each having two first straight lines which make a right angle with each other to form an edge, and a second straight line which makes an angle of about 45 degrees with the two first straight lines. After removing the triangle, two obtuse angles are formed in each of the remaining gate wires. Thus, it is preferable to etch the gate wires by appropriately adjusting the mask design or etching conditions so as to form curved lines each in contact with the first straight line and the second straight line, in each of the obtuse angle portions. Note that each of the two sides of the right-angled isosceles triangle, which are equal to each other, has a length of ⅕ to ½ of the width of the wire. In addition, the inner circumferences of the corners are also made roundish along the outer circumferences of the corners. By forming a corner of a projecting portion to be roundish, generation of particles due to overdischarge can be suppressed in dry etching with plasma In addition, by forming a corner of a depressed portion to be roundish, such an effect can be obtained that, even when particles are generated in washing, they can be washed away without gathering in the corner. Thus, yields can be significantly improved.

An interlayer insulating layer is a layer to be formed after the gate wires 512, 513, and 514. The interlayer insulating layer is formed with an inorganic insulating material such as silicon oxide or an organic insulating material such as polyimide or an acrylic resin. Another insulating layer such as silicon nitride or silicon nitride oxide may be provided between the interlayer insulating layer and the gate wires 512, 513, and 514. Further, an insulating layer such as silicon nitride or silicon nitride oxide may be provided over the interlayer insulating layer as well. Such an insulating layer can prevent contamination of the semiconductor layer and the gate insulating layer from impurities which would adversely affect the TFT, such as extrinsic metal ions or moisture.

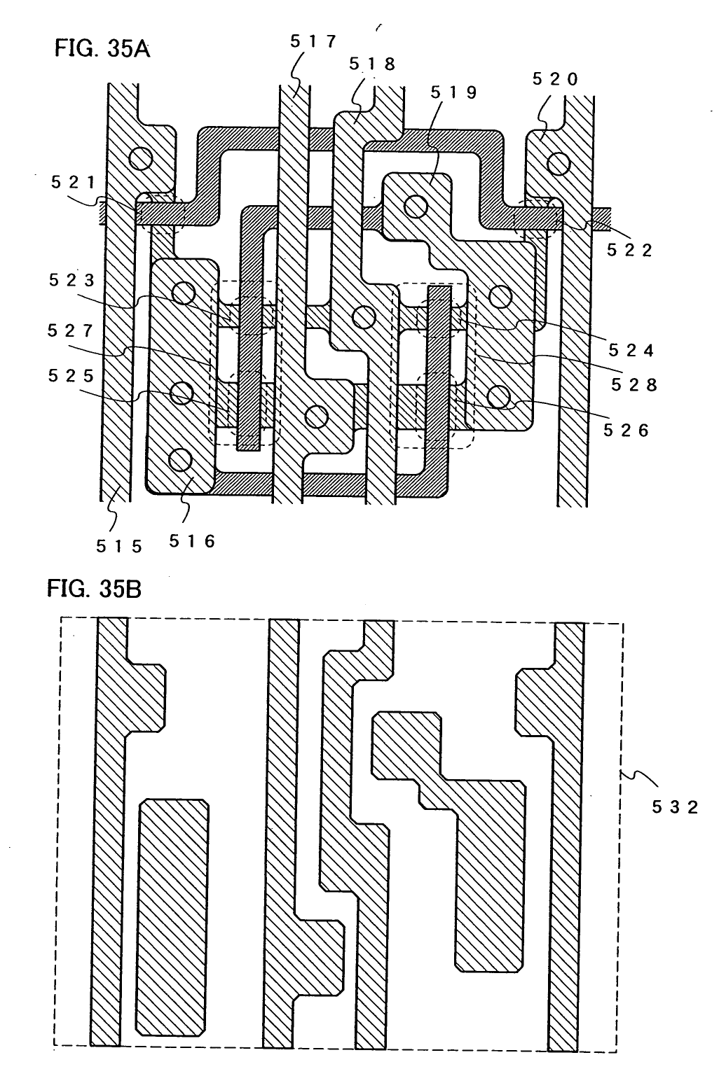

Openings are formed in predetermined positions of the interlayer insulating layer. For example, the openings are provided in corresponding positions to the gate wires and the semiconductor layers located below the interlayer insulating layer. A wire layer which has a single layer or a plurality of layers of metals or metal compounds is formed by a photolithography technique with the use of a mask pattern, and then etched into a desired pattern. Then, as shown in FIG. 35A, wires 515 to 520 are formed to partially overlap the semiconductor layers. A wire connects specific elements to each other, which means a wire connects specific elements not linearly but connects so as to include corners due to the restriction of a layout. In addition, the width of the wire varies in a contact portion or other portions. As for the contact portion, if the width of a contact hole is equal to or wider than the wire width, the wire in the contact portion is formed wider than the width of the other portions.

A photomask for forming the wires 515 to 520 has a mask pattern 532 shown in FIG. 35B. In this case also, each wire is formed to have such a pattern that a corner (right-angled triangle) at an L-shaped edge is removed with the condition that one side of the removed triangle is 10 μm or less, or has a length of ⅕ to ½ of the wire width, so that the corner is rounded. That is to say, the outer circumference of the corner of the wire is curved when seen from the above. Specifically, in order to form the outer circumference of the corner to be roundish, a part of the wire is removed, which corresponds to a right-angled isosceles triangle having two first straight lines which make a right angle with each other to form an edge, and a second straight line which makes an angle of about 45 degrees with the two first straight lines. After removing the triangle, two obtuse angles are formed in the remaining wire layer. Thus, it is preferable to etch the wire by appropriately adjusting the mask design or etching conditions so as to form curved lines each in contact with the first straight line and the second straight line, in each of the obtuse angle portions. Note that each of the two sides of the right-angled isosceles triangle, which are equal to each other, has a length of ⅕ to ½ of the width of the wire. In addition, the inner circumference of the corner is also made roundish along the outer circumference of the corner. By forming a corner of a projecting portion to be roundish, generation of particles due to overdischarge can be suppressed in dry etching with plasma. In addition, by forming a corner in a depressed portion to be roundish, such an effect can be obtained that, even when particles are generated in washing, they can be washed away without gathering in the corner. Thus, yields can be significantly improved. When corners of wires are formed to be roundish, electrical conduction can be expected to be maintained. Further, when a plurality of wires are formed in parallel, dust can be easily washed away. Further, In FIG. 35A, N-channel transistors 521 to 524, and P-channel transistors 525 and 526 are formed. The N-channel transistor 523 and the P-channel transistor 525, the N-channel transistor 524 and the P-channel transistor 526 constitute an inverter 527 and an inverter 528, respectively. Circuits including these six transistors form a SRAM. An insulating layer such as silicon nitride or silicon oxide may be formed in the upper layer of these transistors.

This embodiment can be implemented by being freely combined with any of the above-described embodiment modes.

### Embodiment 2

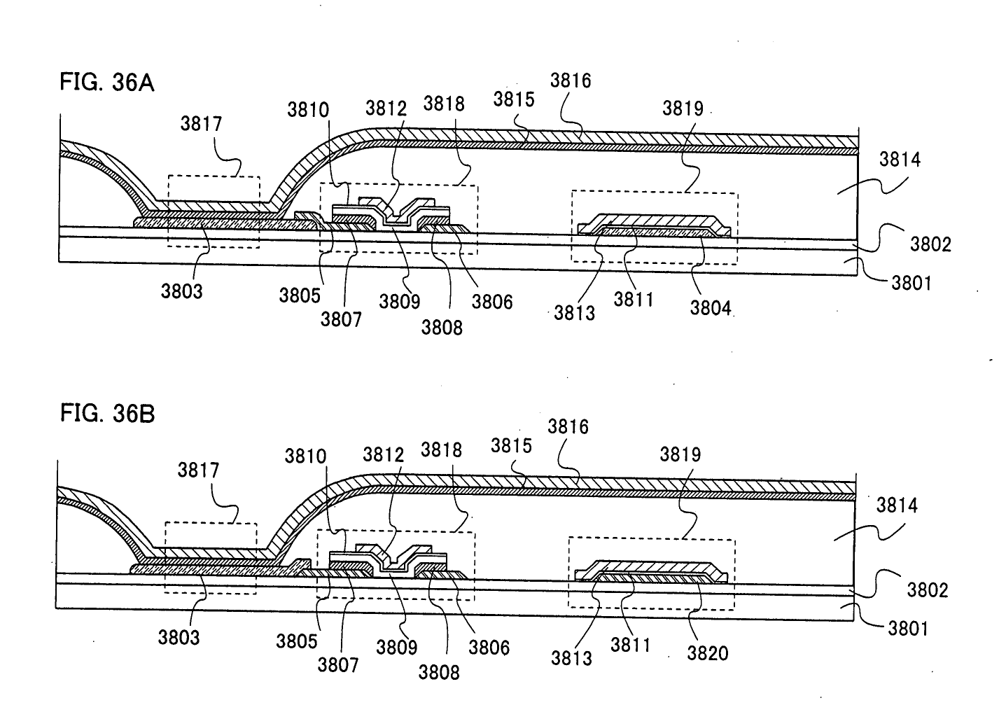

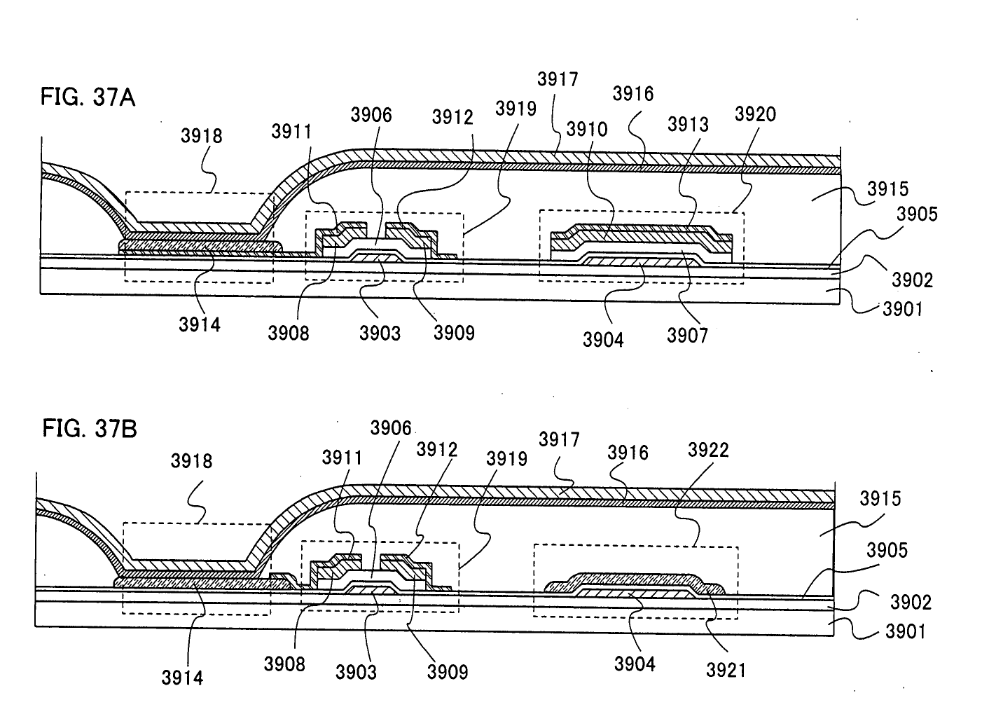

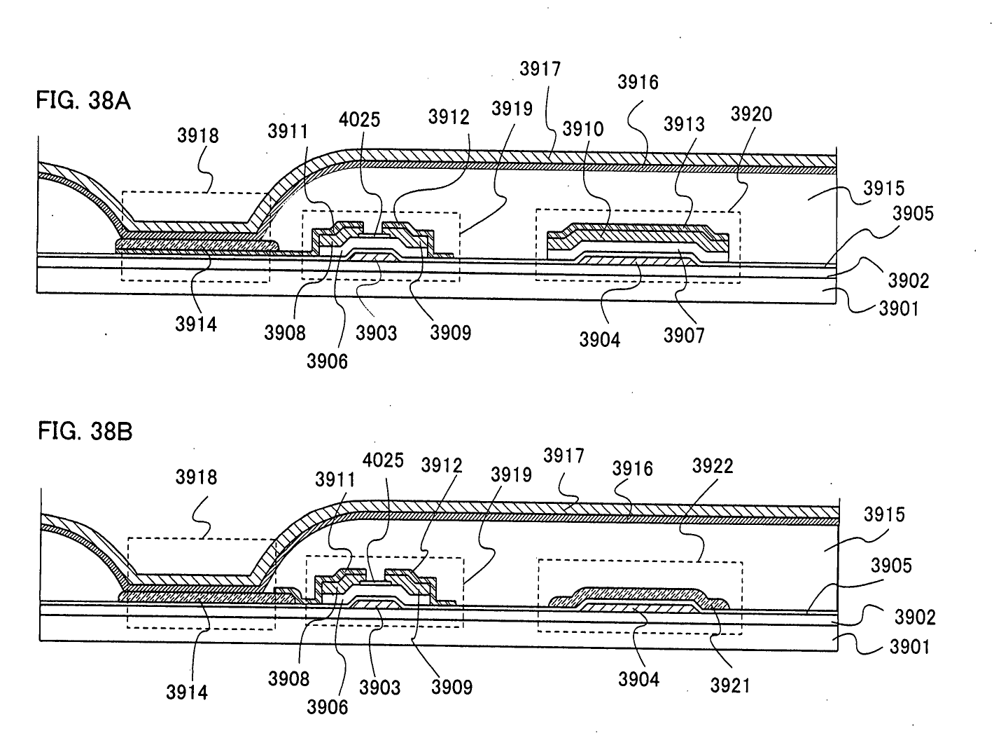

In Embodiment 2, a structure of a TFT included in a display device of the present invention will be described. The case of using an amorphous silicon (a-Si:H) film as a semiconductor layer of a TFT is described in this embodiment. FIGS. 36A and 36B show top gate TFT while FIGS. 37A to 38B show bottom gate TFTs.

FIG. 36A shows a cross section of a top gate TFT having a semiconductor layer formed of amorphous silicon. As shown in FIG. 36A, a base film 3802 is formed over a substrate 3801. Moreover, a pixel electrode 3803 is formed over the base film 3802. Moreover, a first electrode 3804 is formed in the same layer and of the same material as the pixel electrode 3803.

The substrate may be a glass substrate, a quartz substrate, a ceramic substrate, or the like. As the base film 3802, a single layer of aluminum nitride (AlN), silicon oxide (SiO₂), silicon oxynitride (SiOₓN_{y}), or the like or stacked layers thereof can be used.

Wires 3805 and 3806 are formed over the base film 3802, and an end portion of the pixel electrode 3803 is covered with the wire 3805. An n-channel semiconductor layer 3807 and an n-channel semiconductor layer 3808 which have n-type conductivity are formed over the wires 3805 and 3806. A semiconductor layer 3809 is formed over the base film 3802 between the wires 3805 and 3806. A portion of the semiconductor layer 3809 extends over the n-channel semiconductor layer 3807 and the n-channel semiconductor layer 3808. These semiconductor layers are formed of semiconductor films having non-crystallinity such as amorphous silicon (a-Si:H) or a microcrystalline semiconductor (82 -Si:H). A gate insulating film 3810 is formed over the semiconductor layer 3809. Moreover, an insulating film 3811 which is formed in the same layer and of the same material as the gate insulating film 3810 is formed over the first electrode 3804. It is to be noted that a silicon oxide film, a silicon nitride film, or the like is used as the gate insulating film 3810.

A gate electrode 3812 is formed over the gate insulating film 3810. Moreover, a second electrode 3813 formed in the same layer and of the same material as the gate electrode 3812 is formed over the first electrode 3804 with an insulating film 3811 interposed therebetween. The first electrode 3804 and the second electrode 3813 sandwiching the insulating film 3811 form a capacitor 3819. An interlayer insulating film 3814 is formed so as to cover an end portion of the pixel electrode 3803, a driving TFT 3818 and the capacitor 3819.

A layer containing an organic compound 3815 and an opposite electrode 3816 are formed over the interlayer insulating film 3814 and the pixel electrode 3803 provided at an opening of the interlayer insulating film 3814. A light emitting element 3817 is formed in a region where the layer containing an organic compound 3815 is sandwiched between the pixel electrode 3803 and the opposite electrode 3816.

Moreover, the first electrode 3804 shown in FIG. 36A may be formed of a first electrode 3820 as shown in FIG. 36B. The first electrode 3820 is formed in the same layer and of the same material as the wires 3805 and 3806.

FIGS. 37A and 37B show cross sections of portions of a panel in a display device which uses a bottom gate TFT having a semiconductor layer formed of amorphous silicon.

A base film 3902 is formed over a substrate 3901. Further, a gate electrode 3903 is formed over the base film 3902. A first electrode 3904 is formed in the same layer and of the same material as the gate electrode 3903. The gate electrode 3903 can be formed of polycrystalline silicon to which phosphorus is added. In addition to polycrystalline silicon, silicide which is a compound of a metal and silicon may also be used.

A gate insulating film 3905 is formed so as to cover the gate electrode 3903 and the first electrode 3904. As the gate insulating film 3905, a silicon oxide film, a silicon nitride film, or the like is used.

A semiconductor layer 3906 is formed over the gate insulating film 3905. Moreover, a semiconductor layer 3907 is formed in the same layer and of the same material as the semiconductor layer 3906.

The substrate may be a glass substrate, a quartz substrate, a ceramic substrate, or the like. As the base film 3902, a single layer of aluminum nitride (AlN), silicon oxide (SiO₂), silicon oxynitride (SiOₓN_{y}), or the like or stacked layers thereof can be used.

N-channel semiconductor layers 3908 and 3909 having n-type conductivity are formed over the semiconductor layer 3906, and an n-channel semiconductor layer 3910 is formed over the semiconductor layer 3907.

Wires 3911 and 3912 are formed over the n-channel semiconductor layers 3908 and 3909 respectively. A conductive layer 3913 formed in the same layer and of the same material as the wires 3911 and 3912 is formed over the n-channel semiconductor layer 3910.

A second electrode is formed of the semiconductor layer 3907, the n-channel semiconductor layer 3910, and the conductive layer 3913. It is to be noted that a capacitor 3920 is formed of a structure where the gate insulating film 3905 is sandwiched between the second electrode and the first electrode 3904.

One end portion of the wire 3911 extends, and the pixel electrode 3914 is formed in contact with a top portion of the extended wire 3911.

An interlayer insulating film 3915 is formed so as to cover the end portion of the pixel electrode 3914, the driving TFT 3919, and the capacitor 3920.

A layer containing an organic compound 3916 and an opposite electrode 3917 are formed over the pixel electrode 3914 and the interlayer insulating film 3915. A light emitting element 3918 is formed in a region where the layer containing an organic compound 3916 is sandwiched between the pixel electrode 3914 and the opposite electrode 3917.

The semiconductor layer 3907 and the n-channel semiconductor layer 3910 to be a portion of the second electrode of the capacitor are not always required to be provided. That is, in the capacitor, the conductive layer 3913 may function as the second electrode and the gate insulating film may be sandwiched between the first electrode 3904 and the conductive layer 3913.

In FIG. 37A, by forming the pixel electrode 3914 before forming the wire 3911, a capacitor 3922, as shown in FIG. 7B, with a structure where a second electrode 3921 formed of the same material as the pixel electrode 3914 and the first electrode 3904 sandwich the gate insulating film 3905 can be formed.

It is to be noted in FIGS. 37A and 37B that an inversely staggered channel etch type TFT is shown; however, it is needless to say that a channel protective type TFT may also be used. The case of using a channel protective type TFT is described with reference to FIGS. 38A and 38B.

A channel protective type TFT shown in FIG. 38A is different from the channel etch type driving TFT 3919 shown in FIG. 37A in that an insulator 4025 as a mask for etching is provided in a region where a channel of the semiconductor layer 3906 is formed. Other common portions are denoted by the same reference numerals.

Similarly, the channel protective type TFT shown in FIG. 38B is different from the channel etch type driving TFT 3919 shown in FIG. 37B in that the insulator 4025 as a mask for etching is provided in a region where a channel of the semiconductor layer 3906 is formed. Other common portions are denoted by the same reference numerals.

By using an amorphous semiconductor film for semiconductor layers (a channel forming region, a source region, a drain region, and the like) of TFT which form a pixel of the present invention, manufacturing cost can be reduced.

It is to be noted that the structures of a TFT and a capacitor which can be applied to a pixel configuration of the present invention are not limited to the aforementioned ones and various structures can be used for the transistor and the capacitor.

The case of using an amorphous silicon (a-Si:H) film as a semiconductor layer of a TFT is described in this embodiment as an example; however, the invention is not limited to this. A polysilicon (p-Si) film may be used as the semiconductor layer.

This embodiment can be implemented by being freely combined with any of Embodiment Modes 1 to 12 and Embodiment 1.

This application is based on Japanese Patent Application serial no. 2005-217957 filed in Japan Patent Office on Jul. 27, 2005, the entire contents of which are hereby incorporated by reference.

What is claimed is:

1. A display device comprising;
an analog-digital converter circuit which converts an analog video signal into a digital video signal;
an average gray scale calculation circuit which is connected to the analog-digital converter circuit and calculates an average gray scale level of a frame period;
a sub-frame-number control circuit which controls the number of sub-frames in accordance with the average gray scale level; and
a potential control circuit which changes a voltage applied between a pair of electrodes of a light emitting element in accordance with the average gray scale level.

2. The display device according to claim 1, wherein the number of sub-frames is decreased when the average gray scale level becomes lower than a predetermined value.

3. The display device according to claim 1, wherein the potential control circuit decreases the voltage applied between the pair of electrodes of the light emitting element when the average gray scale level becomes higher than a predetermined value.

4. The display device according to claim 1, wherein the potential control circuit increases the voltage applied between the pair of electrodes of the light emitting element when the average gray scale level becomes lower than a predetermined value.

5. An electronic device including the display device described in claim 1.

6. A display device comprising:
a display portion which includes a plurality of pixels each including a light emitting element, a driving thin film transistor which controls supply of a current to the light emitting element, and a switching thin film transistor;
a signal line driver circuit which outputs a video signal;
a scanning line driver circuit which selects a pixel to which the video signal is written;
a power supply line which supplies the current to the light emitting element;
an average gray scale calculation circuit which calculates an average gray scale level of a frame period;
a sub-frame-number control circuit which controls the number of sub-frames in the frame period in accordance with the average gray scale level; and
a potential control circuit which changes a voltage applied between a pair of electrodes of the light emitting element in accordance with the average gray scale level.

7. The display device according to claim 6, wherein the number of sub-frames is decreased when the average gray scale level becomes lower than a predetermined value.

8. The display device according to claim 6, wherein the potential control circuit decreases the voltage applied between the pair of electrodes of the light emitting element when the average gray scale level becomes higher than a predetermined value.

9. The display device according to claim 6, wherein the potential control circuit increases the voltage applied between the pair of electrodes of the light emitting element when the average gray scale level becomes lower than a predetermined value.

10. An electronic device including the display device described in claim 6.

11. A display device comprising:
an analog-digital converter circuit which converts an analog video signal into a digital video signal;
an average gray scale calculation circuit which is connected to the analog-digital converter circuit and calculates an average gray scale level of a frame period;
a gray scale method selector circuit which selects an overlapped time gray scale method or a binary code digital time gray scale method in accordance with the average gray scale level; and
a potential control circuit which changes a voltage applied between a pair of electrodes of a light emitting element in accordance with the average gray scale level.

12. The display device according to claim 11, wherein a gray scale method is changed from overlapped time gray scale method into the binary code digital time gray scale method when the average gray scale level becomes lower than a predetermined value.

13. The display device according to claim 11, wherein the potential control circuit decreases the voltage applied between the pair of electrodes of the light emitting element when the average gray scale level becomes higher than a predetermined value.

14. The display device according to claim 11, wherein the potential control circuit increases the voltage applied between the pair of electrodes of the light emitting element when the average gray scale level becomes lower than a predetermined value.

15. An electronic device including the display device described in claim 11.

16. A display device comprising:
a display portion which includes a plurality of pixels each including a light emitting element, a driving thin film transistor which controls supply of a current to the light emitting element, and a switching thin film transistor;
a signal line driver circuit which outputs a video signal;
a scanning line driver circuit which selects a pixel to which the video signal is written;
a power supply line which supplies the current to the light emitting element;
an average gray scale calculation circuit which calculates an average gray scale level of a frame period;
a gray scale method selector circuit which selects an overlapped time gray scale method or a binary code digital time gray scale method in accordance with the average gray scale level; and
a potential control circuit which changes a voltage applied between a pair of electrodes of the light emitting element in accordance with the average gray scale level.

17. The display device according to claim 16, wherein a gray scale method is changed from overlapped time gray scale method into the binary code digital time gray scale method when the average gray scale level becomes lower than a predetermined value.

18. The display device according to claim 16, wherein the potential control circuit decreases the voltage applied between the pair of electrodes of the light emitting element when the average gray scale level becomes higher than a predetermined value.

19. The display device according to claim 16, wherein the potential control circuit increases the voltage applied between the pair of electrodes of the light emitting element when the average gray scale level becomes lower than a predetermined value.

20. An electronic device including the display device described in claim 16.

21. A driving method of a display device, comprising the steps of:
converting an analog video signal input to the display device into a digital video signal;
calculating an average gray scale level of a frame period;
controlling the number of sub-frames in accordance with the average gray scale level; and
changing a voltage applied between a pair of electrodes of a light emitting element in accordance with the average gray scale level.

22. The driving method of a display device according to claim 21, wherein the number of sub-frames is decreased when the average gray scale level becomes lower than a predetermined value.

23. The driving method of a display device according to claim 21, wherein the number of sub-frames is increased when the average gray scale level becomes higher than a predetermined value.

24. The driving method of a display device according to claim 21, wherein the voltage applied between the pair of electrodes of the light emitting element is increased when the average gray scale level becomes lower than a predetermined value.

25. The driving method of a display device according to claim 21, wherein the voltage applied between the pair of electrodes of the light emitting element is decreased when the average gray scale level becomes higher than a predetermined value.

26. A driving method of a display device, comprising the steps of:
converting an analog video signal input to the display device into a digital video signal;
calculating an average gray scale level of a frame period;
selecting an overlapped time gray scale method or a binary code digital time gray scale method in accordance with the average gray scale level; and
changing a voltage applied between a pair of electrodes of a light emitting element in accordance with the average gray scale level.

27. The driving method of a display device according to claim 26, wherein a gray scale method is changed from the overlapped time gray scale method into the binary code digital time gray scale method when the average gray scale level becomes lower than a predetermined value.

28. The driving method of a display device according to claim 26, wherein a gray scale method is changed from the binary code digital time gray scale method into the overlapped time gray scale method when the average gray scale level becomes higher than a predetermined value.

29. The driving method of a display device according to claim 26, wherein the voltage applied between the pair of electrodes of the light emitting element is increased when the average gray scale level becomes lower than a predetermined value.

30. The driving method of a display device according to claim 26, wherein the voltage applied between the pair of electrodes of the light emitting element is decreased when the average gray scale level becomes higher than a predetermined value.
